(19) United States
(12) Patent Application Publication
(10) Pub. No.: US 2026/0369605 A1
(43) Pub. Date: Nov. 19, 2026

(54) ACRYLAMIDE COPOLYMERS AND METHODS THEREOF

(71) Applicant: Sila Nanotechnologies, Inc., Alameda, CA (US)

(72) Inventors: Igor A. LUZINOV, Seneca, SC (US); Viktor Z. KLEP, Liberty, SC (US); Liying WEI, Anderson, SC (US); Andrii Ruslanovych TIIARA, Seneca, SC (US); Samik Jhulki, Emeryville, CA (US); Ashwin SANKARA RAMAN, Atlanta, GA (US); Gleb Nikolayevich Yushin, Atlanta, GA (US)

(21) Appl. No.: 19/209,366

(22) Filed: May 15, 2025

Related U.S. Application Data
(60) Provisional application No. 63/648,028, filed on May 15, 2024.

(51) Int. Cl. H01M 4/62; C08F 220/56; C08K 3/04; C08K 9/02; C09D 5/24; C09D 7/61; C09D 133/26; H01M 4/04; H01M 4/133; H01M 4/1393; H01M 4/587

(52) U.S. Cl. CPC H01M 4/622; C08F 220/56; C09D 5/24; C09D 7/61; C09D 133/26; H01M 4/0404; H01M 4/133; H01M 4/1393; H01M 4/587; C08F 2800/20; C08K 3/04; C08K 9/02

(57) ABSTRACT

A method comprises the following: (A1) carrying out polymerization of a polymerizable composition dissolved in a solvent composition and in the presence of a free-radical initiator under reflux conditions to form a precipitate; (A2) obtaining a copolymer in acid form from the precipitate; and (A3) neutralizing the copolymer using a metal hydroxide to obtain the copolymer in neutralized form. In some implementations, the metal hydroxide is sodium hydroxide, potassium hydroxide, or calcium hydroxide; the polymerizable composition includes acrylamide and a (meth)acrylic acid; the solvent composition includes a water-miscible solvent; a polydispersity of the copolymer in acid form is in a range of about 1.0-5.0; a mass fraction of the acrylamide in the polymerizable composition is in a range of about 50-90 wt. %; and a mass fraction of the (meth)acrylic acid in the polymerizable composition is in a range of about 5-50 wt. %.

### BACKGROUND

### Field

Aspects of the present disclosure relate generally to energy storage devices and, more particularly, to battery technology and the like.

### Background

Owing in part to their relatively high energy densities, relatively high specific energy, light weight, and potential for long lifetimes, advanced rechargeable batteries are desirable for a wide range of consumer electronics, electric vehicles, grid storage and other important applications. However, despite the increasing commercial prevalence of batteries, further development of these batteries is needed, particularly for applications in low- or zero-emission, hybrid-electric or fully electric vehicles, consumer electronics, wearable devices, energy-efficient cargo ships and locomotives, drones, aerospace applications, and power grids. Further improvements are desired for various rechargeable batteries, such as rechargeable Li and Li-ion batteries, Na and Na-ion batteries, K and K-ion batteries, and dual ion batteries, to name a few.

In certain types of rechargeable batteries, at least some of the charge-storing active materials in either the anode or the cathode or both may be produced as high-capacity nanocomposite powders, which exhibit moderately high volume changes (e.g., about 8-240 vol. %) during the first charge-discharge cycle and moderate volume changes (e.g., about 4-50 vol. %) during the subsequent charge-discharge cycles. A subset of such charge-storing particles includes particles with an average size (e.g., diameter or thickness) in the range of about 0.2 to about 40 microns (micrometers, or μm), as measured using laser particle size distribution analysis (LPSA), laser image analysis, electron microscopy, optical microscopy, or other suitable techniques.

In certain types of Li metal and Li-ion rechargeable batteries, charge-storing anodes may comprise silicon (Si)-comprising anode particles with gravimetric capacities in the range from about 800 mAh/g to about 3000 mAh/g (per mass of Si-comprising anode particles in a Li-free state). A subset of such Si-comprising anode particles includes anode particles that are Si-comprising and C-comprising nanocomposite particles (referred to herein as Si—C composite or Si—C nanocomposite particles, even if such particles comprise elements other than Si and C in relatively small quantities of less than about 10-25 at. %). Such a class of charge-storing particles offers great promises for scalable manufacturing and achieving high cell-level energy density and other performance characteristics. A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing the gravimetric and volumetric energy of rechargeable batteries.

Conventional batteries, such as conventional Li-ion batteries, comprise anodes and cathodes that are produced from solvent-comprising slurries coated on and/or in metal current collectors, which are then dried and calendered (densified). Herein, the term “solvent,” in the context of a slurry used to form battery electrodes, is used to refer to a liquid substance in which solid components of the slurry (e.g., electrochemically active particles, conductive additive particles, etc.) are dispersed (e.g., suspended). After the slurry is coated on and/or in a substrate (e.g., current collector), most or substantially all of the solvents are removed in a drying process. Unfortunately, such conventional battery electrodes typically suffer from poor mechanical properties or slow ion transport or both, particularly when produced at relatively high areal capacity loadings (e.g., above around 4 mAh/cm², more so above around 6 mAh/cm² and even more so above around 8 mAh/cm²). Recently, Li-ion batteries that achieve such relatively high areal capacity loadings on the anode have been realized by incorporating Si—C nanocomposite particles. Although a variety of commercially available binders may be employed in making anode electrodes such as anodes incorporating Si—C nanocomposite particles, further improvements in binder materials are desired for improving electrode or battery performance (e.g., lower resistance, higher volumetric capacity, higher resistance stability during cycling, higher charge and/or discharge rate capability, longer cycle life, etc.)

Accordingly, there remains a need for improved binders and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of making a copolymer includes (A1) carrying out polymerization of a polymerizable composition dissolved in a solvent composition and in the presence of a free-radical initiator under reflux conditions to form a precipitate; (A2) obtaining the copolymer in acid form from the precipitate; and (A3) neutralizing the copolymer using a metal hydroxide to obtain the copolymer in neutralized form, wherein: the metal hydroxide is sodium hydroxide, potassium hydroxide, or calcium hydroxide; the polymerizable composition comprises acrylamide and a (meth)acrylic acid; the solvent composition comprises a water-miscible solvent, the precipitate being insoluble in the water-miscible solvent; a polydispersity of the copolymer in acid form is in a range of about 1.0 to about 5.0; a mass fraction of the acrylamide in the polymerizable composition is in a range of about 50 to about 90 wt. %; and a mass fraction of the (meth)acrylic acid in the polymerizable composition is in a range of about 5 to about 50 wt. %.

In an aspect, a binder material includes a copolymer of acrylamide and (meth)acrylate; wherein: the copolymer comprises sodium, potassium, or calcium; a polydispersity of the copolymer, excluding the sodium, the potassium, and the calcium, is in a range of about 1.0 to about 5.0; a mass fraction of the acrylamide in the copolymer, excluding the sodium, the potassium, and the calcium, is in a range of about 50 to about 96 wt. %; and a mass fraction of the (meth)acrylate in the copolymer, excluding the sodium, the potassium, and the calcium, is in a range of about 2 to about 50 wt. %.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw a contrast between different components, elements, features, etc., and are not meant to convey the use of particular materials, colors, or other properties that may be defined outside of the present disclosure for the specific pattern employed.

FIG. 1 illustrates an exemplary Li-ion battery in which the components, materials, processes, and other techniques described herein may be implemented.

FIG. 2 illustrates exemplary method steps of making a binder composition according to one aspect.

FIG. 3 illustrates exemplary method steps of making batteries in one aspect.

FIG. 4A and FIG. 4B illustrate exemplary compounds used in polymerization of a binder in one aspect.

FIGS. 5A and 5B (Table 1) show selected data relating to composition and synthesis of some example copolymers.

FIG. 6A (Table 2A) shows selected molecular weight and viscosity data of some example copolymers.

FIG. 6B (Table 2B) shows selected viscosity data of some example copolymers.

FIG. 7 (Table 3) shows selected data relating to glass transition temperature (T_{g}) and swelling in an electrolyte solvent (diethyl carbonate) of some example copolymers.

FIG. 8 (Table 4) shows flexural modulus, flexural stress at break, and flexural strain at break data of some example copolymers.

FIG. 9 (Table 5) shows out-of-plane electrical conductivity data of coatings of example PAMAA copolymers.

FIG. 10 (Table 6) shows a dependence of the electrical conductivity of electrode coatings on the bending radii under bending deformation conditions. The electrodes are prepared with different PAMAA copolymers on Cu foils, which are physically attached to poly(ethylene terephthalate) (PET) substrates.

FIG. 11 shows selected performance data (cycling start swell ratio, normalized coating thickness change, simplified volumetric energy density (VED), and cycling start anode volumetric charge capacity) of lithium-ion battery cells in which each anode comprises a respective PAMAA copolymer as a binder.

FIG. 12 shows selected performance data (discharge voltage, number of cycles of reach 80% of capacity as estimated at 300 cycles) of lithium-ion battery cells in which each anode comprises a respective PAMAA copolymer as a binder.

FIG. 13 shows selected performance data (DC resistance) of lithium-ion battery cells in which each anode comprises a respective PAMAA copolymer as a binder.

FIG. 14 (Table 7) illustrates certain selected performance data (formation efficiency, VED, volumetric charge density (VQD), normalized coating thickness change, DC resistance, number of cycles of reach 80% of capacity as estimated at 300 cycles, discharge voltage, 2C discharge retention, cycling start swell ratio, total swell at cycle 250, lifetime swell at cycle 250, total swell at cycle 480, and lifetime swell at cycle 480) of lithium-ion battery cells (e.g., designed for automotive applications) in which each anode comprises a respective PAMAA copolymer as a binder.

FIG. 15 (Table 8) illustrates certain selected performance data (formation efficiency, VED, volumetric charge density (VQD), normalized coating thickness change, DC resistance, number of cycles of reach 80% of capacity as estimated at 300 cycles, discharge voltage, 2C discharge retention, cycling start swell ratio, total swell at cycle 250, and lifetime swell at cycle 250) of lithium-ion battery cells (e.g., designed for consumer electronics applications) in which each anode comprises a respective PAMAA copolymer (or a blend of PAMAA copolymers) as a binder.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternative embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120 °C to about −60 °C encompasses (in °C) a set of temperature ranges from about −120 °C to about −119 °C, from about −119 °C to about −118 °C, . . . from about −61 °C to about −60 °C, as if the intervening numbers (in °C) between −120 °C and −60 °C in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about,” “approximately,” “around,” “≈” or “~” 80%, which encompasses “exactly” 80% (e.g., 80.0000 . . . %) plus some range around 80%. In some designs, the range encompassed around a measurement or threshold via the “about,” “approximately,” “around,” or “~” qualifier may encompass the level of precision for which the respective measurement or threshold is capable of being measured by the most accurate commercially available instrumentation as of the priority date of the subject application.

The expressions “ambient temperature” and “room temperature” as used herein are understood in the art and refer generally to a temperature, e.g., a reaction temperature, that is about the temperature of the room in which the reaction is carried out, for example, a temperature from about 20 °C to about 30 °C.

A dash (“-”) that is not between two letters or symbols is used to indicate a point of attachment for a substituent. For example, —(C═O)NH₂ is attached through carbon of the keto (C═O) group.

Throughout the specification, “alkyl” is generally used to refer to both unsubstituted alkyl groups and substituted alkyl groups; however, substituted alkyl groups are also specifically referred to herein by identifying the specific substituent(s) on the alkyl group. An alkyl group may be straight chain or branched. The term “alkyl” can also be referred to as a linking group of saturated hydrocarbons that are divalent radicals. In other words, in a broader description, the term “alkyls” also encompasses alkylenes. It is further understood that the term “alkyl” covers saturated hydrocarbons that are multivalent radicals.

The term “ester” as used herein is represented by the formula —OC(O)R¹ or —C(O)OR¹, where R¹ can be an alkyl, halogenated alkyl, alkenyl, alkynyl, aryl, heteroaryl, cycloalkyl, cycloalkenyl, heterocycloalkyl, or heterocycloalkenyl group.

The term “ketone” as used herein is represented by the formula R¹C(O)R², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide,” or “halogen,” or “halo,” as used herein, refers to fluorine, chlorine, bromine, and iodine.

As used herein, “halogen” refers to F, Cl, Br, or I.

“R¹,” “R²,” “R³,” “Rⁿ,” etc., where n is some integer, as used herein, can independently possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within the second group, or alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

The term “olefinically unsaturated group” or “ethylenically unsaturated group” is employed herein in a broad sense and is intended to encompass any groups containing a carbon-carbon double-bonded group (>C═C< group). Exemplary ethylenically unsaturated groups include (meth)acrylate, (meth)acrylamide, (meth)acryloyl, allyl, vinyl, styrenyl, or other >C═C< containing groups.

“Polymer” means a material formed by polymerizing one or more molecules (e.g., monomers, oligomers). Herein, the term “monomer” is sometimes used to refer to any molecule that undergoes polymerization; hence, the term “monomer” may include oligomers and polymers in some situations.

The term “(co)polymer” includes homopolymers, copolymers, or mixtures thereof.

The term “(meth)acryl . . . ” includes “acryl . . . ,” “methacryl . . . ,” or mixtures thereof.

“Molecular weight” of a polymeric material (including monomeric or macro-monomeric materials), as used herein, refers to the number-average molecular weight as measured by gel permeation chromatography (GPC) unless otherwise specifically noted or unless testing conditions indicate otherwise.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is less than about 1% by weight, e.g., less than about 0.5% by weight, less than about 0.1% by weight, less than about 0.05% by weight, or less than about 0.01% by weight of the stated material, based on the total weight of the composition.

In the following description, various material properties are described so as to characterize materials (e.g., binders, molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types, such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | Property | Measurement | |
|---|---|---|---|
| Type | Type | Instrumentation | Measurement Technique |
| Active | Coulombic | Potentiostat | Charge (current) is passed to |
| Material | Efficiency | | an electrode containing the |
| | | | active material of interest |
| | | | until a given voltage limit is |
| | | | reached. Then, the current is |
| | | | reversed (discharge current) |
| | | | until a second voltage limit is |
| | | | reached. The ratio of the two |
| | | | charges passed determines |
| | | | the Coulombic Efficiency |
| | | | (CE). In the simplest case, |
| | | | the charge and discharge |
| | | | currents may be constant |
| | | | and often have absolute |
| | | | values that are the same or |
| | | | close to each other. It should |
| | | | be understood though that in |
| | | | some experiments, either |
| | | | charge current or discharge |
| | | | current or both may be |
| | | | changing during such |
| | | | experiments (e.g., be initially |
| | | | constant and when the |
| | | | voltage limit is reached, |
| | | | diminishing to a |
| | | | predetermined value). In |
| | | | addition, the absolute value |
| | | | of the charge and discharge |
| | | | currents may differ. |
| Active | Partial | Manometer | The partial vapor pressure |
| Material | Vapor | | of an active material in a |
| | Pressure | | mixture (e.g., composite |
| | (e.g., Torr.) | | particle) at a particular |
| | at a | | temperature is given by the |
| | Temperature | | known vapor pressure of the |
| | (e.g., K) | | active material multiplied by |
| | | | its mole fraction in the |
| | | | mixture. |
| Active | Volume | Gas pycnometer | Gas pycnometer measures |
| Material | | | the skeletal volume of a |
| Particle | | | material by gas displacement |
| | | | using the volume-pressure |
| | | | relationship of Boyle's Law. |
| | | | A sample of known mass is |
| | | | placed into the sample |
| | | | chamber and maintained at |
| | | | a constant temperature. An |
| | | | inert gas, typically helium, is |
| | | | used as the displacement |
| | | | medium. |
| | | | Note: A vol. % change may |
| | | | be calculated from two |
| | | | volume measurements of the |
| | | | active material particle. |
| Active | Open | nitrogen | Nitrogen sorption/desorption |
| Material | Internal | sorption/desorption | isotherm (typically at 77K) is |
| Particle | Pore Volume | isotherm | collected and analyzed to |
| | (e.g., cc/g or | | estimate the total amount of |
| | cm³/g) | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such |
| | | | as Non-Local Density |
| | | | Functional Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in |
| | Size | electron microscope | combination with image |
| | Distributions | (TEM), scanning | analyses, laser microscopy |
| | (e.g., nm) | transmission | (for larger particles and |
| | | microscope (STEM), | larger pores) in combination |
| | | laser microscope, | with image analyses, optical |
| | | Synchrotron X-ray, | microscopy (for larger |
| | | X-ray microscope | particles and larger pores), |
| | | | neutron scattering, X-ray |
| | | | scattering, X-ray microscopy |
| | | | imaging may be employed to |
| | | | measure pore sizes (average |
| | | | pore size or pore size |
| | | | distribution) in different size |
| | | | ranges (in addition to the |
| | | | analysis of the |
| | | | sorption/desorption |
| | | | isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas |
| | | | pycnometer and comparing |
| | | | them to the theoretical |
| | | | density of the individual |
| | | | material components present |
| | | | in Si-comprising particles. In |
| | | | addition, closed internal |
| | | | pore volume may be |
| | | | estimated by comparing the |
| | | | total pore volume estimated |
| | | | from neutron scattering and |
| | | | the nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced |
| | (e.g., nm) | | by a solid can be determined. |
| Active | Size | TEM, STEM, SEM, | Laser particle size |
| Material | (e.g., nm, μm, | X-Ray, PSA, etc. | distribution analysis (LPSA), |
| Particle | etc.) | | laser image analysis, electron |
| | | | microscopy, optical |
| | | | microscopy or other suitable |
| | | | techniques |
| | | | transmission electron |
| | | | microscopy (TEM), scanning |
| | | | transmission electron |
| | | | microscopy (STEM), |
| | | | scanning electron |
| | | | microscopy (SEM)), X-ray |
| | | | microscopy, X-ray |
| | | | diffraction, neutron |
| | | | scattering and other |
| | | | suitable techniques |
| Active | Composition | Balance | Note #1: A wt. % change |
| Material | (e.g., mass | | may be calculated by |
| Particle | fraction or | | comparing the mass fraction |
| | wt. %, mg, | | of a material in the particle |
| | number of | | relative to the total particle |
| | atoms, etc.) | | mass. |
| | | | Note #2: The capacity |
| | | | attributable to particular |
| | | | active material(s) in the |
| | | | particle may be derived from |
| | | | the composition, based on |
| | | | the known (e.g., theoretical |
| | | | or practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be |
| | | | characterized by a number |
| | | | of atoms of a particular |
| | | | element (e.g., Si, C, etc.). In |
| | | | case of atoms, the number of |
| | | | atoms may be estimated |
| | | | from the weight of that atom |
| | | | in the particle (e.g., based on |
| | | | gas chromatography) |
| Active | Composition | X-ray Fluorescence | |
| Material | (e.g., mass | (XRF), Inductively | |
| Particle | fraction or | Coupled Plasma | |
| | wt. % of | Optical Emission | |
| | various | Spectroscopy (ICP- | |
| | atomic | OES); Energy | |
| | elements or | Dispersive | |
| | molecules, | Spectroscopy (EDS), | |
| | atomic | Wavelength | |
| | fraction or | Dispersive | |
| | at. % of | Spectroscopy | |
| | various | (WDS), Electron | |
| | elements, | Energy Loss | |
| | etc.) | Spectroscopy | |
| | | (EELS), Nuclear | |
| | | Magnetic Resonance | |
| | | (NMR); Secondary | |
| | | Ion Mass | |
| | | Spectrometry | |
| | | (SIMS); X-Ray | |
| | | Photoelectron | |
| | | Spectroscopy (XPS); | |
| | | Fourier Transform | |
| | | Infrared | |
| | | Spectroscopy (FTIR) | |
| | | and Raman | |
| | | Spectroscopy | |
| | | (Raman) | |
| Active | Specific | Potentiostat | An electrode containing an |
| Material | Capacity | | active anode or cathode |
| Particle, | | | material of interest is |
| Battery | | | charged or discharged (by |
| Half-Cell | | | passing electrical current to |
| | | | the electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) |
| | | | gives this quantity (e.g., in |
| | | | mAh/g). The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a |
| Material | (e.g., m²/g) | | sealed chamber at 77K, |
| Particle | | | where nitrogen is introduced |
| | | | at increasing pressure. The |
| | | | change in pressure of the |
| | | | nitrogen is used to calculate |
| | | | the surface area of the |
| | | | sample. |
| Active | Aspect Ratio | SEM, TEM | The dimensions and shape of |
| Material | | | the particles are typically |
| Particle | | | measured by using SEM or |
| | | | TEM or (for large particles) |
| | | | by using optical microscopy. |
| Active | True Density | Argon Gas | True density values may be |
| Material | of Particle | Pycnometer | measured by using an argon |
| Particle | (e.g., g/cc or | | gas pycnometer and |
| | g/cm³) | | comparing to the theoretical |
| | | | density of the individual |
| | | | material components present |
| | | | in the particle. |
| Active | Particle Size | Dynamic light | laser particle size |
| Material | Distribution | scattering particle | distribution analysis (LPSA) |
| Particle | (e.g., nm or | size analyzer, | on well-dispersed particle |
| Population | μm) | scanning electron | suspensions in one example |
| | | microscope | or by image analysis of |
| | | | electron microscopy images, |
| | | | or by other suitable |
| | | | techniques. While there are |
| | | | diverse processes of |
| | | | measuring PSDs, laser |
| | | | particle size distribution |
| | | | analysis (LPSA) is quite |
| | | | efficient for some |
| | | | applications. Note that other |
| | | | types of particle size |
| | | | distribution (e.g., by SEM |
| | | | image analysis) could also be |
| | | | utilized (and may even lead |
| | | | to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a |
| | | | fiftieth-percentile volume- |
| | | | weighted particle size |
| | | | parameter (e.g., abbreviated |
| | | | as D₅₀), a ninetieth-percentile |
| | | | volume-weighted particle |
| | | | size parameter (e.g., |
| | | | abbreviated as D₉₀), and a |
| | | | ninety-ninth-percentile |
| | | | volume-weighted particle |
| | | | size parameter (e.g., |
| | | | abbreviated as D₉₉). |
| Active | Width (e.g., | PSA | Parameters relating to |
| Material | nm) | | characteristic widths of the |
| Particle | | | PSD may be derived from |
| Population | | | these particle size |
| | | | parameters, such as D₅₀- |
| | | | D₁₀ (sometimes referred to |
| | | | herein as a left width), D₉₀- |
| | | | D₅₀ (sometimes referred to |
| | | | herein as a right width), and |
| | | | D₉₀-D₁₀ (sometimes |
| | | | referred to herein as a full |
| | | | width). |
| Active | Cumulative | Computed via LPSA | A cumulative volume |
| Material | Volume | data | fraction, defined as a |
| Particle | Fraction | | cumulative volume of the |
| Population | | | composite particles with |
| | | | particle sizes of a threshold |
| | | | particle size or less, divided |
| | | | by a total volume of all of the |
| | | | composite particles, may be |
| | | | estimated by LPSA. |
| Active | Composition | Balance | The mass of active materials |
| Material | (e.g., wt. %) | | added to the electrode |
| Particle | | | divided by the total mass of |
| Population | | | the electrode. |
| Active | BET SSA | BET Isotherm | obtained from the data of |
| Material | (e.g., m²/g) | | nitrogen sorption-desorption |
| Particle | | | at cryogenic temperatures, |
| Population | | | such as about 77K |
| Electrolyte | Salt | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar mass of the salt is then |
| | | | used to calculate the total |
| | | | number of moles of salt in |
| | | | the solution. The moles of |
| | | | salt is then divided by the |
| | | | total volume to obtain the |
| | | | solvent concentration in M |
| | | | (mol/L). |
| Electrolyte | Solvent | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar volume of each solvent |
| | | | is then used to calculate the |
| | | | total number of moles of |
| | | | solvent in the solution. The |
| | | | moles of solvent is then |
| | | | divided by the total volume |
| | | | to obtain the solvent |
| | | | concentration in M (mol/L). |
| Electrode | Composition | Balance | The mass fraction of a |
| | (e.g., mass | | material (e.g., active |
| | fraction or | | material, active material |
| | wt. %) | | particle, binder, etc.) in the |
| | | | electrode is calculated based |
| | | | on a measured or estimated |
| | | | mass of the material and a |
| | | | measured or estimated mass |
| | | | of the electrode, excluding |
| | | | the electrode current |
| | | | collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be |
| | | | measured before being |
| | | | mixed into a slurry to |
| | | | estimate their mass in a |
| | | | casted electrode. The mass of |
| | | | materials deposited onto the |
| | | | casted electrode may be |
| | | | measured by comparing the |
| | | | weight of the casted |
| | | | electrode before/after the |
| | | | material deposition. |
| Electrode | Areal Binder | balance | A mass fraction of the |
| | Loading (e.g., | | binder in the battery |
| | mg/m²) | | electrode, divided by a |
| | | | product of (1) a mass |
| | | | fraction of the active |
| | | | material (e.g., Si-C |
| | | | nanocomposite, etc.) |
| | | | particles in the battery |
| | | | electrode, and (2) a |
| | | | Brunauer-Emmett-Teller |
| | | | (BET) specific surface area |
| | | | of the active material |
| | | | particle population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical |
| | material | | capacity of the active |
| | capacity | | material. For example, the |
| | fraction) | | average wt. % of active |
| | | | material in each active |
| | | | material particle may be |
| | | | measured and used to |
| | | | calculate the mass of the |
| | | | active material based on the |
| | | | mass of the active material |
| | | | particles before being mixed |
| | | | in the slurry. This process |
| | | | may be repeated if the |
| | | | electrode includes two or |
| | | | more active materials to |
| | | | calculate the relative |
| | | | capacity attribution for each |
| | | | active material in the |
| | | | electrode. |
| Electrode | Capacity | Potentiostat and | Determine the average |
| | Attributable | balance | specific capacity (mAh/g) of |
| | to Active | | active material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may |
| | | | be repeated if the electrode |
| | | | includes two or more active |
| | | | material particle types to |
| | | | calculate the relative |
| | | | capacity attribution for each |
| | | | active material particle type |
| | | | in the electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed |
| | | | in slurry. |
| Electrode | Mass of | balance | Measure the active material |
| | Active | | particle before the active |
| | Material | | material particle type is |
| | Particle in | | mixed in the slurry. |
| | Electrode | | |
| Electrode | Areal | Potentiostat and | Areal capacity loading is the |
| | Capacity | balance | weight of the coated active |
| | Loading (e.g., | | material per unit area |
| | mAh/cm²) | | (g/cm²) multiplied by the |
| | | | gravimetric capacity of the |
| | | | active material (not the |
| | | | electrode, but the active |
| | | | material itself with zero |
| | | | binder and zero electrolyte; |
| | | | mAh/g). |
| Electrode | Coulombic | Potentiostat | The change in charge |
| | Efficiency | | inserted (or extracted) to an |
| | | | electrode divided by the |
| | | | charge extracted (or |
| | | | inserted) from the electrode |
| | | | during a complete |
| | | | electrochemical cycle within |
| | | | given voltage limits. Because |
| | | | the direction of charge flow |
| | | | is opposite for cathodes and |
| | | | anodes, the definition is |
| | | | dependent on the electrode. |
| | | | Coulombic Efficiency is |
| | | | measured for both materials |
| | | | by constructing a so-called |
| | | | half-cell, which is an |
| | | | electrochemical cell |
| | | | consisting of a cathode or |
| | | | anode material of interest as |
| | | | the working electrode and a |
| | | | lithium metal foil which |
| | | | functions as both the counter |
| | | | and reference electrode. |
| | | | Then, charge is either |
| | | | inserted or removed from |
| | | | the material of interest until |
| | | | the cell voltage reaches an |
| | | | appropriate limit. Then, the |
| | | | process is reversed until a |
| | | | second voltage limit is |
| | | | reached, and the charge |
| | | | passed in both steps is used |
| | | | to calculate the Coulombic |
| | | | Efficiency, as described |
| | | | above. |
| Battery Cell | Rate | Potentiostat | This is the time it takes to |
| | Performance | | charge or discharge a |
| | | | battery between a given state |
| | | | of charge. It is measured by |
| | | | charging or discharging a |
| | | | battery and measuring the |
| | | | time until a specified amount |
| | | | of charge is passed, or until |
| | | | the battery operating voltage |
| | | | reaches a specified value. |
| Battery Cell | Cell | Potentiostat | A battery consisting of a |
| | Discharge | | relevant anode and cathode |
| | Voltage (e.g., | | is charged and discharged |
| | V) | | within certain voltage limits |
| | | | and the charge-weighted cell |
| | | | voltage during discharge is |
| | | | computed. |
| Battery Cell | Operating | Potentiostat and | Average temperature of |
| | Temperature | thermocouples | battery cell as measured at |
| | | | the positive/negative |
| | | | terminal/cell shaft/etc. |
| | | | while charging/discharging, |
| | | | or at a certain voltage level, |
| | | | or while a load is applied, |
| | | | etc. |
| Battery | Anode | Potentiostat | An electrode containing an |
| Half-Cell | Discharge | | active anode material (or a |
| | (de- | | mixture of active materials) |
| | lithiation) | | of interest is charged and |
| | Potential | | discharged (by passing |
| | (e.g., V) | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to de- |
| | | | lithiation of the anode) is |
| | | | computed. |
| Battery | Cathode | Potentiostat | An electrode containing an |
| Half-Cell | Discharge | | active cathode material (or a |
| | (lithiation) | | mixture of active materials) |
| | Potential | | of interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to lithiation |
| | | | of the cathode) is computed. |
| Battery Cell | Volumetric | Potentiostat | The VED is calculated by |
| | Energy | | first calculating the energy |
| | Density | | per unit area of the battery, |
| | (VED) | | and then dividing the energy |
| | | | per unit area by the sum of |
| | | | the illustrative anode, |
| | | | cathode, separator, and |
| | | | current collector thicknesses |
| Battery Cell | Internal | Potentiostat | The internal resistance (also |
| | Resistance | | known as impedance in |
| | (impedance) | | many contexts) is measured |
| | | | by applying small pulses of |
| | | | current to the battery cell |
| | | | and recording the |
| | | | instantaneous change in cell |
| | | | voltage. |

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated cathodes. Unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries, it will be appreciated that various aspects may be applicable to other chemistries for Li-ion batteries (other conversion-type and alloying-type electrodes as well as various intercalation-type anodes and cathodes) as well as to other battery chemistries. During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying-type materials forming lithium alloys (hence the name “alloying”-type). Sometimes, “alloying”-type electrode materials are considered to be a subclass of “conversion”-type electrode materials.

While the description below may describe certain examples in the context of Si—C composite (e.g., nanocomposite) anode active materials (e.g., nanocomposite particles which comprise silicon (Si) and carbon (C) and may comprise other elements, such as nitrogen (N), phosphorus (P), boron (B), oxygen (O), hydrogen (H), sulfur (S), fluorine (F), to name a few and where a total mass of the Si and the C atoms may contribute from about 75 wt. % to about 100 wt. % of the total mass of the composite particles), it will be appreciated that various aspects may be applicable to other types of the high-capacity silicon-comprising anode active materials (including, for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including core-shell or hierarchical or nanocomposite particles, etc.).

An aspect is directed to a battery anode and/or a battery anode precursor composition comprising a population of Si-comprising particles (e.g., nanocomposite particles, among others), in which some or all of the Si-comprising particles comprise silicon (Si) and carbon (C) elements and may comprise other elements, such as nitrogen (N), phosphorus (P), boron (B), oxygen (O), hydrogen (H), sulfur (S), fluorine (F), to name a few. In some embodiments, the total mass of the Si and the C (on average) in the Si-comprising particles may contribute from about 75 wt. % to about 100 wt. % of the total mass of the Si-comprising particles. Such composite particles are sometimes referred to herein as Si—C composites (or nanocomposites, if Si and/or C are nanostructures, for example).

In some embodiments, the total mass of O may contribute (on average) from about 0 wt. % to about 10 wt. % of the total mass of the Si-comprising particles (e.g., about 0-1 wt. %; about 1-2.5 wt. %; about 2.5-5 wt. %; or about 5-10 wt. %;). In some embodiments, the total mass of N may contribute (on average) from about 0 wt. % to about 10 wt. % of the total mass of the Si-comprising particles (e.g., about 0-0.1 wt. %; about 0.1-2 wt. %; about 2-5 wt. %; or about 5-10 wt. %). In some embodiments, the total mass of P may contribute (on average) from about 0 wt. % to about 10 wt. % of the total mass of the Si-comprising particles (e.g., about 0-0.1 wt. %; about 0.1-1 wt. %; about 1-5 wt. %; or about 5-10 wt. %). In some embodiments, the total mass of B may contribute (on average) from about 0 wt. % to about 5 wt. % of the total mass of the Si-comprising particles (e.g., about 0-0.1 wt. %; about 0.1-2.5 wt. %; or about 2.5-5 wt. %). In some embodiments, the total mass of H may contribute (on average) from about 0 wt. % to about 2 wt. % of the total mass of the Si-comprising particles (e.g., about 0-0.5 wt. %; about 0.5-1 wt. %; or about 1-2 wt. %). In some embodiments, the total mass of S may contribute (on average) from about 0 wt. % to about 2.5 wt. % of the total mass of the Si-comprising particles (e.g., about 0-0.1 wt. %; about 0.1-0.5 wt. %; or about 0.5-2.5 wt. %). In some embodiments, the total mass of F may contribute (on average) from about 0 wt. % to about 2.5 wt. % of the total mass of the Si-comprising particles (e.g., about 0-0.1 wt. %; about 0.1-0.5 wt. %; or about 0.5-2.5 wt. %).

In some embodiments, a total atomic fraction of the Si and the C may contribute from about 75 at. % to about 100 at. % of the overall composite particles. Such composite particles are sometimes referred to herein as Si—C composites. In some embodiments, such composite particles comprise nano-sized or nanostructured elements (e.g., nano-sized or nanostructured Si, nano-sized or nanostructured C, or both), which may be referred to as nanocomposite particles. In some implementations, the Si or Si-comprising active material present in such nanocomposites may be in the form of nanoparticles. In some implementations, the mass-average size of Si or Si-comprising active material nanoparticles (or nanocrystals) may range from about 1 nm to about 200 nm (e.g., about 1.0-10.0 nm; about 10.0-30.0 nm; or about 30.0-100.0 nm; or about 100-200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. X-ray diffraction may be particularly convenient and easy for identifying the average size of Si nanocrystals. Too small (e.g., smaller than about 1.0 nm in some designs or, e.g., about 2 nm in other designs) Si nanocrystals may exhibit too high reactivity during synthesis and become less active or induce too high fist cycle capacity losses, while too large (e.g., larger than about 200 nm in some designs or, e.g., about 100 nm in other designs) Si crystals may reduce cycle stability of such Si—C composites (nanocomposites) or, broadly, nanocomposite silicon. As used here, a “nano”-material (e.g., nanostructure or nanoparticle or nanocomposite, etc.) may refer to any material that exhibits at least one dimension that is less than about 200 nm.

Below, reference is made to electrode (e.g., anode or cathode) compositions as well as electrode “precursor” compositions. As generally used herein, an electrode composition may be arranged as a dry powder (e.g., prior to being made part of a slurry), as a suspension in a slurry, as part of a casted (dried) electrode, or as part an electrode undergoing charge-discharge cycles during battery operation. Reference to an electrode “precursor” composition refers to an electrode composition in a state prior to that of the casted (dried) electrode (e.g., as a dry powder or as a slurry suspension). Note that the context in which certain examples are described below may further limit the interpretation of the electrode composition and/or electrode precursor composition.

An aspect is directed to a battery anode and/or a battery anode precursor composition comprising a population of Si-comprising particles (e.g., nanocomposite particles, among others), in which each of the particles comprises Si and C, and the Si-comprising particles have certain characteristics. In some embodiments, a mass fraction of the silicon in the Si-comprising particles (e.g., composite particles) is in a range of about 3 wt. % to about 80 wt. % (e.g., about 3-20 wt. %; about 20-35 wt. %; about 35-50 wt. %; or about 50-80 wt. %). In some embodiments, a Brunauer-Emmett-Teller (BET) specific surface area (SSA) of the Si-comprising particles (e.g., nanocomposite particles, among others) is in a range of about 0.5 m²/g to about 170 m²/g (e.g., about 0.5-3 m²/g; about 3-12 m²/g; about 12-20 m²/g; about 20-170 m²/g). In some embodiments, about 90% or more of the Si-comprising particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery anode and/or a battery anode precursor composition comprising a population of Si-comprising particles (e.g., nanocomposite particles, among others), in which each of the particles comprises Si and C, and the Si-comprising particles exhibit, on average, specific reversible capacity (as measured in half cells using a proper charge-discharge protocol such as, for example, by lithiation of the anode at the constant current density of 0.1 C to 0.01 V vs. Li/Li⁺ followed by taper till the current density decreases to 0.01C and then followed by delithiation at the constant current density of 0.1 C to 1.5 V vs. Li/Li⁺; note that the capacity of the Si-comprising particles may be estimated from the anodes comprising known wt. % blends with known graphite that have known specific capacity of its own) in the range of about 1400 mAh/g to about 2800 mAh/g (e.g., about 1400-1600 mAh/g; about 1600-1800 mAh/g; about 1800-2000 mAh/g; about 2000-2200 mAh/g; about 2200-2400 mAh/g; about 2400-2600 mAh/g; or about 2600-2800 mAh/g). Similarly, the irreversible (first cycle) specific capacity of the particles that comprise Si and C may preferably range from about 1500 mAh/g to about 2900 mAh/g (e.g., about 1500-1700 mAh/g; about 1700-1900 mAh/g; about 1900-2100 mAh/g; about 2100-2300 mAh/g; about 2300-2500 mAh/g; about 2500-2700 mAh/g; or about 2700-2900 mAh/g).

An aspect is directed to a battery electrode and/or a battery electrode precursor composition comprising a population of Si-comprising particles (e.g., nanocomposite particles, among others). The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising particles may advantageously be in a range of about 0.5 to about 25.0 μm (e.g., about 4.0-12.0 μm, about 0.5-4.0 μm, about 4.0-6.0 μm, about 6.0-8.0 μm, about 8.0-12.0 μm, about 12.0-16.0 μm, or about 16.0-25.0 μm).

Note that in some designs, the presence of excessively large particles comprising Si (e.g., in the form of nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion, etc.). In some embodiments (e.g., when the D₅₀ is in a range from about 0.5 μm to about 4.0 μm), the cumulative volume fraction, with the threshold particle size at about 10 μm, may advantageously be about 80 vol. % (D₅₀) or more, or about 85 vol. % (D₈₅) or more, or (in some designs) even about 90 vol. % (D₉₀) or more. In other embodiments (e.g., when the D₅₀ is in a range from about 4.0 μm to about 6.0 μm), the cumulative volume fraction, with the threshold particle size at about 15 μm, may advantageously be about 80 vol. % or more, or about 85 vol. % or more, or (in some designs) even about 90 vol. % or more. In other embodiments (e.g., when the D₅₀ is in a range from about 6.0 μm to about 8.0 μm), the cumulative volume fraction, with the threshold particle size at about 18 μm, may advantageously be about 80 vol. % or more, or about 85 vol. % or more, or (in some designs) even about 90 vol. % or more. In other embodiments (e.g., when the D₅₀ is in a range from about 8.0 μm to about 12.0 μm), the cumulative volume fraction, with the threshold particle size at about 22 μm, may advantageously be about 80 vol. % or more, or about 85 vol. % or more, or (in some designs) even about 90 vol. % or more. In other embodiments (e.g., when the D₅₀ is in a range from about 12.0 μm to about 16.0 μm), the cumulative volume fraction, with the threshold particle size at about 30 μm, may advantageously be about 80 vol. % or more, or about 85 vol. % or more, or (in some designs) even about 90 vol. % or more.

In one or more embodiments of the present disclosure, Si-comprising active material particles may exhibit true density (e.g., as measured by using an argon gas pycnometer) in the range from about 1.1 g/cc to about 2.8 g/cc (e.g., as measured by using an argon gas pycnometer) in the range from about 1.1 g/cc to about 2.8 g/cc (about 1.1-1.5 g/cc; about 1.5-1.8 g/cc; about 1.8-2.1 g/cc; about 2.1-2.4 g/cc; or about 2.4-2.8 g/cc).

In one or more embodiments of the present disclosure, Si-comprising active material (e.g., composite, such as Si—C composite) particles may comprise internal pores. In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming a theoretical density of the individual material components present in Si-comprising active material (e.g., composite, such as Si—C composite) particles)—e.g., about 0.00-0.10 cc/g; about 0.10-0.20 cc/g; about 0.20-0.30 cc/g; about 0.30-0.40 cc/g; about 0.40-0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising particles) may range from about 0.00 cc/g to about 1.00 cc/g—e.g., about 0.00-0.10 cc/g; about 0.10-0.20 cc/g; about 0.20-0.30 cc/g; about 0.30-0.40 cc/g; about 0.40-0.50 cc/g; about 0.50-0.60 cc/g; about 0.60-0.70 cc/g; about 0.70-0.80 cc/g; about 0.80-0.90 cc/g; about 0.90-1.00 cc/g. In some designs, the volume-average size of the open (e.g., to nitrogen gas at 77K) pores may range from about 0.5 nm to about 100 nm—e.g., about 0.5-5 nm; about 5-20 nm; about 20-50 nm; or about 50-100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm—e.g., about 0.5-5 nm; about 5-20 nm; about 20-50 nm; about 50-100 nm; or about 100-200 nm.

In one or more embodiments of the present disclosure, Si-comprising active material (e.g., composite, such as Si—C composite) particles may exhibit moderate (e.g., about 7-120 vol. %) or high (e.g., about 120-240 vol. %) volume changes during initial lithiation (e.g., down to around 0.01 V vs. Li/Li⁺). In some designs, 50-100% of such volume changes may be accommodated by plastic (irreversible) deformation (expansion) (the remaining being accommodated by, e.g., elastic deformations or other phenomena). In some designs, Si-comprising active material (e.g., composite, such as Si—C composite) particles may exhibit volume changes in the range from about 8 vol. % to about 240 vol. % during one or more charge-discharge cycles of the battery cell. In one or more embodiments of the present disclosure, Si-comprising active material particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation.

In one or more embodiments of the present disclosure, a preferred anode for a battery cell may comprise a mixture of Si-comprising active material particles (e.g., nanocomposite Si—C particles, nanocomposite Si particles, among others) and graphite active material particles (or, more broadly, carbon active material particles) as the anode active material, a so-called blended anode. In addition to the anode active material particles (e.g., Si—C composite particles and/or graphite particles), an anode may comprise inactive material (in addition to and separate from any inactive material that may be an integral part of the anode active material particles themselves, such as a C part of a Si—C composite particle), such as binder(s) (e.g., polymer binder) and other functional additives (e.g., surfactants, electrically conductive additives, etc.). In some implementations, the anode active material (e.g., Si—C composite particles and/or graphite particles) may be in a range of about 85 wt. % to about 98 wt. % of the total weight of the anode (not counting the weight of the current collector)—e.g., about 85-89 wt. %; about 89-91 wt. %; about 91-93 wt. %; about 93-95 wt. %; or about 95-98 wt. %.

In some implementations, blended anodes may comprise Si-comprising particles (e.g., Si—C nanocomposite particles, among others) ranging from about 7 wt. % to about 98 wt. % (e.g., about 7-15 wt. %, about 15-25 wt. %, about 25-40 wt. %, about 40-60 wt. %, about 60-80 wt. %, or about 80-98 wt. %) of all the anode active material particles and the graphite (e.g., particles) making up the remainder of the mass (the weight) of the anode active material particles (from about 2 wt. % to about 93 wt. %). Note that blended anode active material particles refer to a mixture of distinct active material particles (e.g., Si—C composite particles and graphite particles), and, by way of example, a homogeneous mixture of Si—C composite particles by itself is not considered to be a “blend” (e.g., because the C part of the Si—C composite particles is an integral part of the Si—C composite particles). For example, blended anode active material particles instead refer to a blend of different active material particle types (e.g., Si—C composite particles and graphite particles) that are held together by a binder, and would be independent particles without the presence of the binder.

While the descriptions below may also describe certain examples of the blended anode formulations expressed as mass (wt. %) of Si-comprising particles (e.g., Si—C nanocomposite particles, among others) among the anode active materials or as mass (wt. %) of Si-comprising particles (e.g., Si—C nanocomposite particles, etc.) in the total anode (not counting the weight of the current collector), it will be appreciated that various aspects of this disclosure may be applicable to blended anode formulations expressed as wt. % of Si in the anode (counting the weight of all the active materials, binder, conductive and other additives, but not counting the weight of the current collector). While the descriptions below may also describe certain examples of the blended anode formulations expressed as mass (wt. %) of Si-comprising particles (e.g., Si—C nanocomposite particles, etc.) in the active material blends, it will be appreciated that various aspects of this disclosure may be applicable to blended anode formulations attributing a fraction (e.g., %) of the total capacity of the blended anode to the capacity of the Si-comprising particles.

In some embodiments, the battery electrode (e.g., anode) and/or battery electrode (e.g., anode) precursor composition may advantageously comprise one or more carbon-comprising functional additives (e.g., additives that enhance electrical conductivity or rate performance of mechanical properties of the electrode). In some embodiments, the carbon-comprising functional additive is selected from: carbon nanotubes (e.g., single-walled carbon nanotubes (SWCNTs), multi-walled carbon nanotubes (MWCNTs)), carbon nanofibers, carbon black, dendritic carbon, carbon-coated fibers, graphite, exfoliated graphite, graphene oxide (which may be highly defective and curved, in some designs; single-walled or multi-walled, e.g., with from about 2 to about 200 walls, on average) and graphene (which may be highly defective and curved, in some designs; single-walled or multi-walled, e.g., with from about 2 to about 200 walls, on average). In some embodiments, the battery electrode (e.g., anode) precursor composition comprises a polymerizable binder precursor (e.g., polymerizable monomers, oligomers, and/or polymers). In addition, the battery electrode (e.g., anode) precursor composition may comprise one or more binder components. In some embodiments, the battery electrode (e.g., anode) may comprise a binder formed by polymerization of the polymerizable binder precursor present in the battery electrode (e.g., anode) precursor composition. In addition, the battery electrode (e.g., anode) may comprise one or more binder components (in some designs, two or more binder components).

An aspect is directed to a battery anode. In some embodiments, the battery anode is formed from any of the foregoing battery anode and/or battery anode precursor compositions, disposed on and/or in a current collector (e.g., Cu-based or Cu-containing current collector, such as a dense or porous foil or a mesh or a foam or a nanowire-comprising or nanoflake-comprising current collector, etc.). Note that a battery anode disposed “on and/or in” a current collector may refer to a battery anode that is deposited on top of the current collector, or a battery anode that is at least partially disposed inside one or more pores of a porous current collector, in some designs (in addition to and/or in place of an anode part that is deposited on top of the current collector). In some embodiments, a coating density of the battery electrode is in a range of about 0.8 to about 1.7 g/cm³ (e.g., about 0.8-0.9 g/cm³; about 0.9-1.0 g/cm³; about 1.0-1.2 g/cm³; about 1.2-1.4 g/cm³, or about 1.4-1.7 g/cm³). Higher fraction of suitable graphite material in a blended anode may benefit from higher anode density for better performance (e.g., better stability, better rate performance, higher volumetric capacity, lower swell during cycling, etc.), although excessive density may also be detrimental for the same or other characteristics. As such, detailed optimization would need to be conducted for a particular battery design, electrode thickness, areal capacity loading, battery cycling environment and regime, among other factors.

An aspect is also directed to a blended battery anode, wherein both the Si-comprising active anode particles (e.g., nanocomposite Si—C particles, among others) and graphite (or, broadly, carbon-based) active anode material may be present. The anode may preferably comprise a binder amount optimized for the properties of both the Si-comprising active material particles (e.g., Si—C composite particles) and the graphite particles. For example, the anode may be characterized by an areal binder loading, defined as a mass of the binder in the battery anode (e.g., measured in mg) normalized by the surface area of the active material particles (e.g., Si-comprising (e.g., nanocomposite, etc.) active anode material particles and (if present) graphite active material particles in the same battery anode (e.g., measured in m² and defined by the mass of active material particles (in g) multiplied Brunauer-Emmett-Teller (BET) specific surface area (SSA, in m²/g)). Since a BET SSA of both the Si-comprising active material particle (e.g., Si—C composite particles) population and the graphite active material particle population may vary from slurry to slurry, in some designs, the binder loading may preferably be adjusted based on the desired areal binder loading. Higher BET SSA of the active anode materials (measured in m²/g) typically require a higher mass fraction of the binder in the anode electrode. For example, the anode electrode comprising active material particle population (e.g., Si-comprising (e.g., nanocomposite, etc.) active anode material particle population or a blend of Si-comprising active material(s) (e.g., Si—C composite particles) and a graphite active material(s)) with BET SSA of about 10 m²/g would typically require from about 20 mg to about 150 mg of the binder per 1 g of active material particles (approximately 2-13 wt. % relative to the sum of the weight of the binder and the active material composition, not counting the weight of conductive or other additives or the weight of the current collector), while another anode electrode comprising another active material particle population (e.g., Si-comprising (e.g., nanocomposite, etc.) active anode material particle population or a blend of Si-comprising active material(s) and a graphite active material(s)) with BET SSA of only 1 m²/g would typically require from about 2 mg to about 40 mg of the binder per 1 g of active material particles (approximately 0.2-4 wt. % relative to the total weight of the binder+active material composition, not counting the weight of conductive or other additives or the weight of the current collector). However, in some designs, an areal binder loading of the battery anode in both cases is in the range from about 2.0 mg/m² to about 40.0 mg/m² (e.g., about 2.0-5.0 mg/m²; about 5.0-9.0 mg/m²; about 9.0-15.0 mg/m²; or about 15.0-40.0 mg/m²). In some designs, a higher fraction of Si-comprising (e.g., nanocomposite, etc.) active anode material particle population in the anode (relative to the total weight of all active materials) may preferably utilize a higher areal binder loading. In some designs, a larger average size of Si-comprising (e.g., nanocomposite, etc.) active anode material particle population in the anode may preferably utilize a slightly higher areal binder loading. In some designs, a larger BET SSA of Si-comprising (e.g., nanocomposite, etc.) active anode material particle population in the anode may preferably utilize a slightly smaller areal binder loading. In some designs, the areal binder loading may also depend on the binder composition and properties (e.g., adhesion, chemical composition, hardness, elastic modulus when exposed to electrolyte, maximum elongation at break, among others). Thus, in some designs, the optimal areal binder loading content within a range of about 2.0 mg/m² to about 40.0 mg/m² depends on the anode formulation. So, the optimal areal binder loading content in some designs may range from about 2.0-5.0 mg/m²; about 5.0-9.0 mg/m²; about 9.0-15.0 mg/m²; or about 15.0-40.0 mg/m².

An aspect is directed to a battery and an anode comprising Si-comprising particles that also comprise C (e.g., Si—C nanocomposite particles, C-coated particles, etc.), wherein the ratio of intensities of the carbon D band and carbon G band (I_{D}/I_{G}) in the Raman spectra of the majority of Si- and C-comprising particles (measured, for example, using the laser wavelength of about 532 nm; and analyzed, for example, in the spectral (wavenumber) range from about 1000 to about 2000 cm⁻¹ by fitting two Gaussian peaks after a linear background subtraction in this range) to range from I_{D}/I_{G} of about 0.7 to I_{D}/I_{G} of about 2.7 (e.g., about 0.7-0.9; about 0.9-1.2; about 1.2-1.5; about 1.5-1.8; about 1.8-2.1; about 2.1-2.4; or about 2.4-2.7).

An aspect is also directed to a Li-ion battery comprising: (i) a suitable battery anode, wherein the suitable anode may comprise one or more of the following, in some designs: (ia) Si-comprising anode comprising Si-comprising anode particles (e.g., nanocomposite Si—C particles, silicon oxide particles, silicon nitride particles, among others), which, in some design may also be a blended battery anode (wherein both the Si-comprising active anode particles (e.g., nanocomposite Si—C particles or silicon oxide particles or silicon nitride particles, among others) and suitable graphite (or, broadly, carbon-based) active anode particles are present in the anode), (ib) intercalation-type carbon (C)-comprising anode comprising natural graphite, synthetic graphite, hard carbon or soft carbon or their various combinations or (ic) metal oxide-comprising anode (e.g., Li, Ti, Nb, Mo, V and/or W-comprising metal oxides, such as, for example, lithium titanium oxide, niobium titanium oxide, niobium molybdenum oxide, niobium molybdenum titanium oxide, niobium tungsten oxide, niobium tungsten molybdenum oxide, niobium tungsten molybdenum titanium oxide, vanadium oxide, their various combinations and mixtures, etc.) or (id) their various combinations and (ii) a suitable battery cathode, wherein the suitable cathode may comprise one or more of the following, in some designs: (iia) intercalation-type cathode or (iib) conversion-type cathode (which may include a displacement-type cathode, a chemical transformation type cathode or a true conversion-type cathode) or (iic) a mixed intercalation/conversion type cathode (either a physical mixture of (iia) and (iib) or a cathode that exhibits both intercalation-type or conversion-type Li-ion storage).

In some designs, a suitable cathode may advantageously comprise one, two or more of the following additives (e.g., in the form of particles, nanoparticles, nanofibers, flakes or nanoflakes): natural graphite, synthetic graphite, graphene, graphene oxide, exfoliated graphite, hard carbon, soft carbon, carbon black, carbon fibers, carbon nanofibers, carbon nanotubes in the total amount from around 0.1 wt. % to about 15 wt. % relative to the total weight of the cathode layer but not counting the weight of the cathode current collector (e.g., about 0.1-0.5 wt. %; about 0.5-2 wt. %; about 2-5 wt. %; or about 5-15 wt. %).

Illustrative examples of suitable intercalation-type cathodes to be used in preferable cells may include: lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as those comprising Mn, Mo, Cr, Ti, and/or Nb, such as, for example, Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333}Ti_{0.333}Mo_{0.133}O₂), various high capacity Li-ion based materials with partial substitution of oxygen for fluorine or iodine (e.g., disordered or ordered rocksalt compositions comprising Mn, Mo, Cr, Ti and/or Nb, such as, for example, Li₂Mn_{2/3}Nb_{1/3}O₂F, Li₂Mn_{1/2}Ti_{1/2}O₂F, Li_{1.5}Na_{0.5}MnO_{2.85}I_{0.12}) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode active materials that rely on the intercalation of lithium (Li) and changes in the TM oxidation state.

Illustrative examples of suitable conversion-type cathodes to be used in preferable cells may include: metal fluorides, metal oxy-fluorides, metal chlorides, metal sulfides, metal selenides, their various mixtures, composites and others. Illustrative examples of metal fluorides, in a Li-free state, include FeF₃, FeF₂, MnF₃, CuF₂, NiF₂, BiF₃, BiF₅, SnF₂, SnF₄, SbF₃, SbF₅, CdF₂, ZnF₂, TiF₃, TiF₄, AgF, AgF₂, NbF₅, NbF₄, MoF₅, MoF₄, MoF₃, ZrF₄, BaF₂, SrF₂, YF₃, LaF₃, PbF₂, PbF₄, CeF₃, CeF₄, SmF₃, CaF₂, their various mixtures, alloys and combinations. In some designs, Fe may contribute to the majority (e.g., about 50-100 at. %, about 75-100 at. %) of the transition metals in the metal fluoride cathodes. In some designs, Cu may contribute to the majority (e.g., about 50-100 at. %, about 75-100 at. %) of the transition metals in the metal fluoride cathodes.

In some of the preferred examples, a surface of cathode active materials (e.g., intercalation-type cathode materials, such as LCO, NCM, NCMA, NCA, LMO, LMNO, LFP, LMP, LMFP, etc. or conversion-type active materials comprising S, Li₂S, metal sulfides, metal fluorides, etc.) may be coated with a layer of ceramic (e.g., oxide) material (e.g., comprising one, two or more of Li, Mg, Al, Ti, Zr, W and/or Nb, among other metals). In some of the preferred examples, a surface of cathode active materials may be coated with a layer of a polymeric material. In some designs, a preferred cathode current collector material is aluminum or aluminum alloy or an aluminum-comprising composite. In some designs, a preferred anode current collector material is copper or copper alloy or a copper-comprising composite. In some designs, a preferred battery cell includes a polymer or polymer-comprising separator membrane or a polymer-comprising separator layer. In some of the preferred examples, a polymer separator is made of or comprises polyethylene, polypropylene or a mixture thereof. In some of the preferred examples, a surface of a polymer separator (membrane or layer) is coated with a layer of ceramic material or a polymer separator (membrane or layer) comprising ceramic material. Examples of a preferred coating material for polymer separators may include titanium oxide (TiO₂), aluminum oxide (Al₂O₃), aluminum hydroxide or oxyhydroxide, zirconium oxide (ZrO₂), magnesium oxide (MgO), or magnesium hydroxide or oxyhydroxide.

An aspect is directed to a Li-ion battery with a Si-comprising anode or with a blended anode (e.g., comprising Si-comprising active material (e.g., Si—C composite particles) and graphite active material, etc.) that exhibits a relatively high areal capacity loading and properly matched (by areal capacity) cathode (with slightly smaller areal capacity loadings, selected according to the desired negative (N) to positive (P) ratio, N/P (the N/P ratio corresponds to the ratio of the reversible areal capacities of the anode to cathode) in a range of around 0.95 to around 1.35 (e.g., around 0.95-1.10; around 1.01-1.05; around 1.05-1.10; around 1.10-1.15; around 1.15-1.20; around 1.20-1.25; around 1.25-1.35). Note that both the performance characteristics and cycle stability of Li-ion battery cells may become particularly unsatisfactory for applications requiring long calendar life or long cycle life or low first cycle losses, or other properties if the electrode areal capacity loading exceeds around 1-2 mAh/cm², even more, if the electrode areal capacity exceeds around 4-5 mAh/cm², yet even more if the electrode areal capacity exceeds around 6 mAh/cm² and yet even more if the electrode areal capacity exceeds around 8 mAh/cm². Higher loading, however, is advantageous for reducing the cost of energy storage devices and increasing their energy density. One or more embodiments of the present disclosure are directed to fabrication processes, compositions and various physical and chemical properties of anodes and cathodes that enable satisfactory performance for electrode areal loadings in the range from around 2 mAh/cm² to around 16 mAh/cm² (e.g., about 2-4 mAh/cm², about 4-8 mAh/cm², or about 8-16 mAh/cm²).

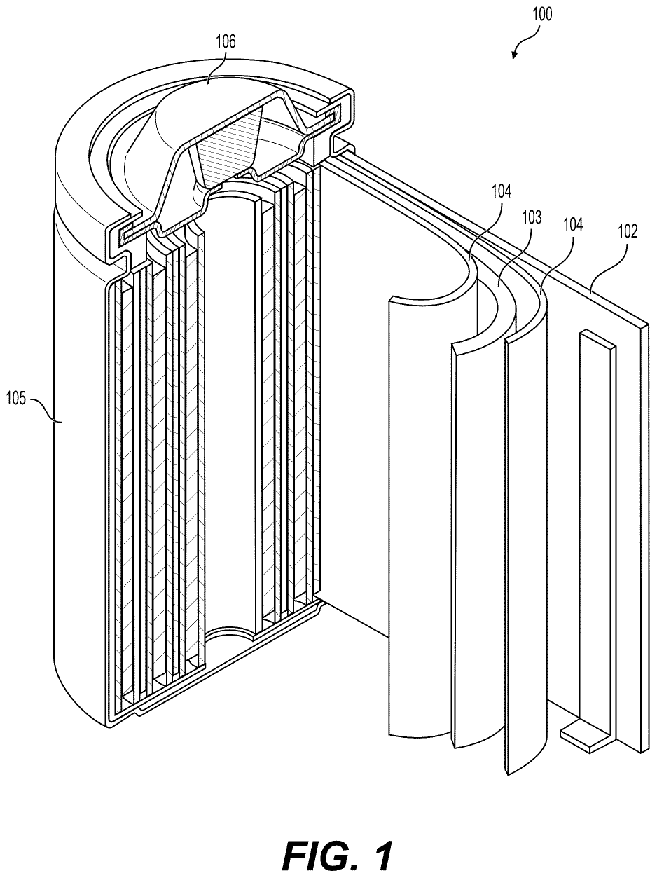

FIG. 1 illustrates an example metal-ion (e.g., Li-ion) battery in which the electrode particles, components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector.

An aspect is directed to new binder materials that enhance mechanical strength, reduce the amount of binder needed for the fabrication of electrodes and improve one or more of Li-ion battery performance characteristics (e.g., rate, stability, energy density, specific energy, direct-current resistance, etc.).

It is typically desirable to minimize the mass and volume fraction of the binder(s) within the electrodes to enhance volumetric and gravimetric energy densities, lower electrode impedance, and improve rate capability. It may be particularly advantageous, for example, for the electrode to comprise less than about 25-30 vol. % binder relative to the combined volume of the binder, conductive and other additives and active material particles (not counting the volume of the pores left within the electrode during or after its fabrication and also excluding the current collector) (less than about 25 vol. %; less than about 20 vol. %; less than about 16 vol. %; less than about 12 vol. %; less than about 8 vol. %; or less than about 6 vol. %). It may also be advantageous for the electrode to comprise less than about 14-16 wt. % binder relative to the combined weight of the binder, conductive and other additives, and active material particles (less than about 14 wt. %; less than about 12 wt. %; less than about 10 wt. %; less than about 8 wt. %; less than about 6 wt. %; less than about 5 wt. %; less than about 4 wt. %; or less than about 3 wt. %).

Previously, blends of styrene-butadiene rubbers (SBR) with carboxymethyl cellulose (CMC) as a thickener were proposed to be used as aqueous binders for lithium-ion batteries. SBR is an attractive component for the binder due to its relatively low cost combined with a good water-dispersibility. However, while such binders demonstrated a good adhesion between various active components of the battery and current collectors, these binders exhibited low mechanical stability and relatively low swelling resistance to an electrolyte solvent(s). Furthermore, SBR binders demonstrated decreasing charge-discharge cycle characteristics of a lithium-ion secondary battery when used at high temperatures. Other binders, such as polyvinylidene fluoride (PVDF), polyacrylic acid (PAA) and its derivatives (such as lithium polyacrylate, abbreviated as LiPAA), sodium carboxymethyl cellulose (CMC-Na), and their combinations, were also proposed to be used in lithium-ion batteries. However, these binders also lack the desired mechanical, physical, and electrical properties for some advanced lithium-ion battery applications in which: (1) the anode comprises high-capacity nanocomposite particles (e.g., Si—C nanocomposite particles) that exhibit moderately high volume changes (e.g., about 8-240 vol. %) during one or more charge-discharge cycles; and (2) the areal capacity loading of the anode is quite high (e.g., in some cases, about 2 mAh/cm² to about 4 mAh/cm², or in some other cases, about 4 mAh/cm² to about 8 mAh/cm², or in yet some other cases, about 8 mAh/cm² to about 16 mAh/cm²). Accordingly, there is still a need for new, improved binders. This need is also addressed by aspects of this disclosure.

An aspect is directed to polymer binder properties used in electrode processing. In some designs, a primary function of a polymer binder is to hold the active battery materials (e.g., cathode or anode) together and provide long-term mechanical stability and stable operation of a battery cell without inducing undesirable side reactions. In some designs, the inventors identified that this typically requires one or more of the following characteristics, numbered (i) through (vi): (i) Good adhesion between active materials particles and between the particles and the current collector (e.g., copper foil for anode and aluminum foil for cathode). Adhesion strength or “peel strength” is a measure of how strongly the coated materials are adhered to the substrate (e.g., aluminum or copper foil) and is measured by estimating the force (common unit is Newton (N)) acting across the width of the coated surface when peeled at a constant velocity. In some designs, the peel strength of the coatings formed upon polymerization should preferably range between about 0.001 N/cm to about 10 N/cm. (ii) No significant chemical or electrochemical degradation of the binder at the applied potential range in the presence of electrolytes. This is typically ensured by a polymer binder having strong chemical bonds having bond energy in the range from about 60 kcal/mol to about 250 kcal/mol, in some designs. The constituent elements of such bonds may preferably include: carbon, nitrogen, fluorine, phosphorus, oxygen, sulfur, chlorine, bromine, and silicon, to name a few. These chemical bonds may be single bonds, double bonds, and/or triple bonds, or in some cases, may comprise aromatic moieties, including heteroaromatic moieties, such as pyridine, pyrimidine, triazine, triazole, tetrazole, furan, pyrrole, thiophene, and their higher homologs, to name a few. In some designs, these rather stringent requirements may preferably be maintained during battery cycling, including elevated temperature operations. This is particularly important in some designs for high-capacity electrodes (e.g., conversion cathodes and anodes) that undergo large volume changes during charge-discharge cycles. Furthermore, in some designs, the polymeric binder may preferably (iii) not dissolve in the employed electrolyte and may swell to only a relatively small degree (in some designs, below about 100 vol. %, on average; in other designs, below about 90 vol. %; in other designs, below about 80 vol. %; in other designs, below about 70 vol. %; in other designs, below about 60 vol. %; in other designs, below about 50 vol. %; in other designs, below about 40 vol. %; in yet other designs, below about 30 vol. %); note that a high degree of swelling may allow or enhance ion transportation through the binder, but at the expense of reducing adhesion properties; while low swell in the electrolyte, in contrast, may reduce or minimize or prevent its adhesion properties from being significantly degraded to the extent that the polymeric binder cannot maintain mechanical stability, which may cause undesired capacity fade over time. In some times, it is important though to ensure that such a low-swell binder does not block ion access to/from active material (e.g., by not coating the particles completely or by maintaining sufficiently fast ion transport through at least a portion of the binder). Other key preferences for the binder properties in some designs may include: (iv) good thermal stability (e.g., especially suitable when binders exhibit a thermal expansion coefficient being relatively small or moderate, in the range about 0.01 to about 40 K⁻¹) to allow stable operation of different batteries at different temperatures (e.g., about −10 to about 50 °C), (v) low outgassing (binder should preferably not contribute significantly (e.g., by more than about 50%; in some designs, by more than about 20%; in yet some designs, by more than about 10%) to outgassing during “formation” cycling or during high temperature storage, which is primarily contributed by electrolyte decomposition and the solid electrolyte interphase (SEI) formed therefrom), and (vi) low fatigue (for example, preferably reducing mechanical properties and/or adhesion and/or cohesion of the electrode or other important binder or electrode properties by less than about 30% (in some designs by less than 20%; in yet other designs by less than 10%; note that in some designs, the binder properties may even improve during cycling) after about 2000 charge-discharge cycles (e.g., at about 10-100% depth-of-charge, DoC; about 10-100% depth of discharge, DoD) or till the end of battery life) over time; fatigue refers to loss of a physical property upon cyclic operation for a long time. In general, binder fatigue is most commonly related to mechanical properties, but in the case of electrochemical testing, binder fatigue here represents other polymer properties as well, such as swelling (e.g., deleterious increase in swelling), adhesion and cohesion properties, ion-conduction ability, among others. In some designs, it is desirable that the polymers maintain their original properties, and if fatigue is inevitable, then the loss of the above properties are not more than about 30% (preferably no more than 20%; most preferably no more than 10%) over a period of about 2000 charge-discharge cycles (e.g., about 10-100% DoD).

An aspect is directed to an electrode fabricated using either (i) a casting technique, such as, a slot-die coating (e.g., tape casting, extrusion, etc.), a blade coating, a gravure coating, their various variations and combinations or (ii) printing (e.g. screen printing, digital printing, etc.) or their variations or combinations with other methods. For high-precision electrode thickness control and uniformity, either a blade coating system or a slot-die coating system may be applied. In some implementations, an electrode slurry (e.g., solvents, active material particles, conductive and other functional additives, binder(s), etc.) is poured from a reservoir onto a moving current collector (e.g., a metal foil, etc.). The gap between the bottom of the reservoir (defined by the position of a doctor blade or a slot-die) and the substrate (i.e., current collector) determines the initial coating thickness (prior to thickness changes caused by densification and/or solvent evaporation) and areal mass loading of the electrode. The thickness is also controlled by the movement speed, electrode mass viscosity, the particular composition of the electrode mass, and other factors.

In some designs, an ultrasound treatment, a vibration treatment and/or continuous stirring (e.g., at high rates) may be applied during the casting procedure to break-up agglomerates and reduce slurry viscosity when a small volume fraction of the binder is used in the electrode slurries (e.g., below about 20-25 vol. %).

In some designs, the use of solid lubricants (e.g., carbon or graphite-based particles) may also be highly advantageous for electrode casting since these may reduce viscosity, agglomeration, and inter-particle friction.

An aspect is directed to suitable properties of graphite particles that may be advantageously used in electrode processing. In some designs, graphite particles with suitable properties may work effectively as solid lubricant(s) or as active material(s) (e.g., within the anode) that also function as solid lubricant(s). Such graphite particles may enhance various properties (e.g., volumetric capacity, rate performance, stability, etc.) of electrodes.

In some designs, it may be advantageous for the suitable graphite to constitute from about 0.1 wt. % to about 95 wt. % of the total weight of the electrode (including active material particles, conductive and other functional additives, binder, surfactant, etc.; but not counting the weight of the current collector or tabs)—e.g., about 0.1-10 wt. %; about 10-25 wt. %; or about 25-95 wt. %. In case of electrode processing of anodes for use in Li-ion batteries, the other components of electrodes may include various Si-comprising particles (e.g., nanocomposite silicon, silicon-carbon composite, silicon-graphite composite, silicon oxide including carbon-coated silicon oxide, silicon oxide-carbon composite; silicon nitride-carbon composite, silicon oxynitride-carbon composites, etc.), other graphite particles, metal oxide particles, among others.

In some aspects, disclosed herein are compositions of improved Li battery cells comprising suitable cathodes of a suitable areal capacity loading (e.g., in some designs, about 2-20 mAh/cm²; in some designs, about 2-4 mAh/cm²; in other designs, about 4-6 mAh/cm²; in other designs, about 6-8 mAh/cm²; in other designs, about 8-10 mAh/cm²; in other designs, about 10-20 mAh/cm²), a suitable separator (e.g., in some designs, a ceramic-comprising separator), a suitable anode of a suitable areal capacity loading (e.g., in some design, in the range of about 2.1-21 mAh/cm²; in some designs, about 2.1-4 mAh/cm²; in other designs, about 4-6 mAh/cm²; in other designs, about 6-8 mAh/cm²; in other designs, about 8-10 mAh/cm²; in other designs, about 10-21 mAh/cm²), a suitable electrolyte and other components. In some aspects, the anode comprises an anode composition, comprising: (i) suitable Si-comprising anode active materials (e.g., Si—C composite or nanocomposites, among others) of suitable specific reversible capacity, such as in the range of about 1200 mAh/g to about 2800 mAh/g (e.g., about 1200-1600 mAh/g; about 1600-1900 mAh/g; about 1900-2200 mAh/g; about 2200-2500 mAh/g; or about 2500-2800 mAh/g), suitable composition (e.g., about 80-100 wt. % being C and Si elements, in some designs), suitable chemical, physical and mechanical properties, as described in herein, (ii) suitable carbon active materials (e.g., one, two or more of natural or synthetic graphite active material, soft carbon, hard carbon, etc.), (iii) suitable binder compositions and mixtures thereof, (iv) suitable conductive or other additives or other suitable anode components (e.g., carbon black, graphene incl. multi-layered graphene, graphene oxide, exfoliated graphite, carbon fibers, single walled carbon nanotubes, double-walled carbon nanotubes, multi-walled carbon nanotubes, polymer nanofibers, surfactants, etc.) in suitable ratios and arrangements relative to each other.

In some aspects, a suitable binder may comprise a copolymer, which may comprise a copolymer of acrylamide and (meth)acrylic acid (or (meth)acrylate or a salt of the (meth)acrylic acid). In certain implementations, the binder is an aqueous solution having a volatile content in a range of about 35 to about 95 wt. % (e.g., about 35-50 wt. %, or about 50-65 wt. %, or about 65-80 wt. %, or about 80-95 wt. %). In certain implementations, the binder is an aqueous solution having a non-volatile content in a range of about 5 to about 65 wt. % (e.g., about 5-20 wt. %, or about 20-35 wt. %, or about 35-50 wt. %, or about 50-65 wt. %). In some implementations, the binder may have a room temperature dynamic viscosity in a range of about 30 to about 3000 mPa·s (e.g., about 30-100 mPa·s, or about 100-300 mPa·s, or about 300-1000 mPa·s, or about 1000-3000 mPa·s). In some implementations the binder (e.g., an aqueous binder solution) may have a pH in a range of about 6 to about 8, or in a range of about 6 to about 7, or in a range of about 7 to about 8.

In certain implementations the binder may include a copolymer, for example a random copolymer. In some aspects, disclosed herein are methods of making the binders useful for making and operating Li batteries.

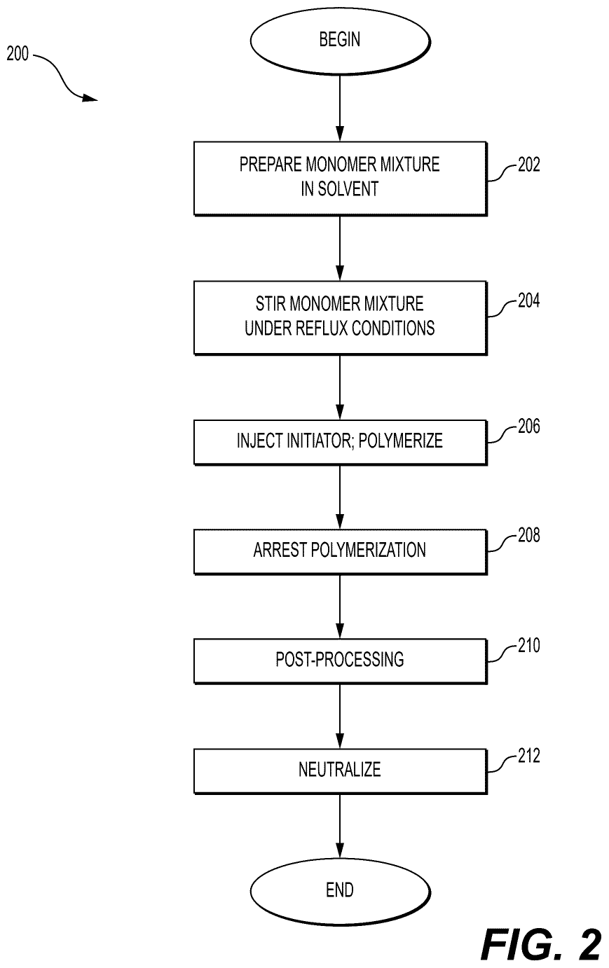

In certain aspects, disclosed herein is a method of making a binder material. In such aspects, the method comprises carrying out polymerization of a polymerizable composition. A general schematic of the polymerization is shown in FIG. 2. In certain aspects, the polymerization process 200 comprises operations 202, 204, 206, 208, 210, and 212. Operation 202 includes providing a polymerizable composition (e.g., monomers) and dissolving and mixing the polymerizable composition in a solvent composition to obtain a reaction mixture. Operation 204 includes charging the reaction mixture into a reactor equipped with a reflux condenser and a stirrer. Operation 204 additionally includes heating and stirring the reaction mixture until steady-state reflux conditions are attained. Operation 206 includes injecting a free-radical initiator into the reaction mixture. In some implementations, the free-radical initiator may be dissolved in a solvent (e.g., the same solvent(s) as the solvent composition) before being injected into the reaction mixture. Within a short time (e.g., in some designs, less than about 1 minute, about 1 to about 2 minutes, etc.) from injecting the free-radical initiator, precipitation indicative of copolymer formation may preferably be visible in the reactor. Operation 206 may additionally include stirring the reaction mixture under reflux conditions for a desired time (e.g., about 10-20 minutes, about 20-40 minutes, about 40-60 minutes, about 60-120 minutes, about 120-180 minutes, etc.) depending on the specifics of the reaction (e.g., concentration of monomers in the solvent composition, concentration of free-radical initiator in the solvent composition). Operation 208 includes arresting the polymerization, by rapidly lowering the temperature in the reactor. For example, this may be accomplished by immersing the reactor in an icy water bath. In some designs, operation 208 may advantageously minimize the maximum molecular weight (MW) of the polymers and thus help minimize binder viscosity in solutions. Operation 210 includes any suitable post-processing operations, such as filtering, washing, and/or drying of the copolymer obtained at operation 208. Upon completion of operation 210, the copolymer in acid form (hydrogen form or H form) may be obtained. In some implementations, it may be preferable to convert the copolymer from the acid form to a metal salt form (neutralized form), such as a sodium salt form, a potassium salt form, or a calcium salt form. This conversion process is sometimes referred to as neutralization. Operation 212 includes neutralization of the H-form copolymer by using a metal hydroxide (e.g., sodium hydroxide NaOH, potassium hydroxide KOH, calcium hydroxide Ca(OH)₂). In some designs, the neutralization may be carried out in an aqueous solution of a metal hydroxide (e.g., NaOH, KOH, Ca(OH)₂), in a temperature range of about 25 to about 80 °C. In some implementations, it may be preferable that the neutralization be carried out to completion, i.e., substantially 100% of the acid moieties are converted to metal (e.g., Na, K, Ca) salts. In some other implementations, it may be preferable for the degree of neutralization to be less than 100%, depending on the performance of the copolymer in a battery cell. The details of the polymerization and the compositions formed by such polymerizations are described herein. In some designs, Li may also be used instead of Na, K or Ca (or as a portion of such metals), although this may undesirably increase the binder cost and, in some cases, may even reduce the binder performance characteristics. In some designs, it may be preferred for the binder to have minimal (e.g., about 0.01-5 at. % relative to all metals) or no Li in its composition.

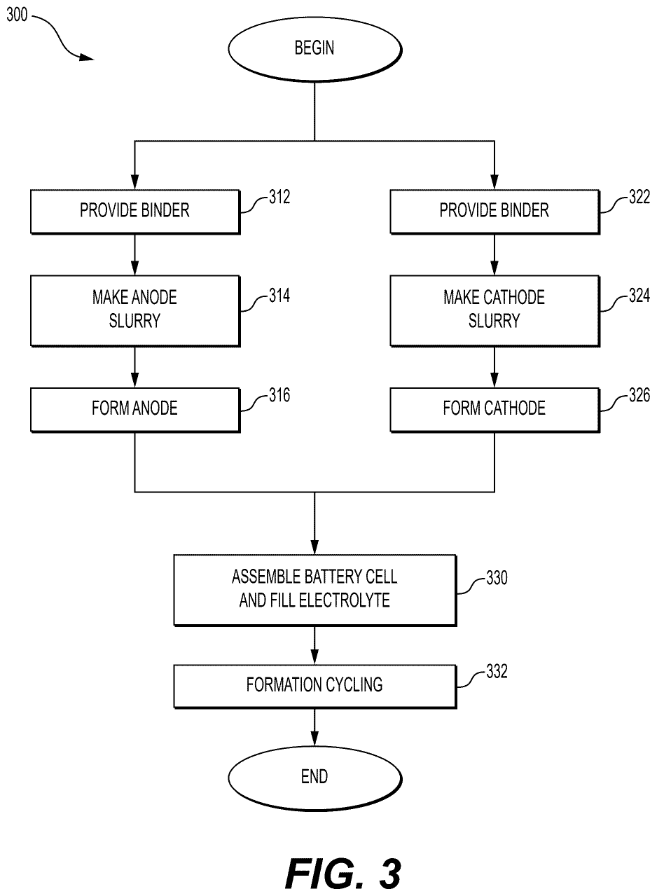

FIG. 3 illustrates an example method (300) for the formation of a Li-ion battery. This example shows the formation of both electrodes (anode and cathode). The left branch relates to the formation of an anode, including stages 312, 314, and 316. On the other hand, the right branch relates to the formation of a cathode, including stages 322, 324, and 326. For each of the branches, an electrode (an anode or a cathode) may be formed by casting from a slurry onto a current collector, as described herein.

In still further aspects, the left and right branches may be carried out concurrently or sequentially as desired. In addition, method 300 also includes stage 330 after the production of the anode and the cathode, which includes assembling of the battery cell and filling the cell with an electrolyte. In such aspects disclosed herein, a battery electrode prepared by the methods shown in FIG. 3. The battery electrode can comprise a current collector; and an electrode material disposed on and/or in the current collector (e.g., if the current collector is porous or has a rough or porous surface). In still further aspects, the electrode material may be disposed as a coating. In still further aspects, the coating may have an average thickness in a range of about 5 μm to about 200 μm (e.g., about 5-10 μm, about 10-20 μm, about 20-40 μm, about 40-60 μm, about 60-80 μm, about 80-100 μm, or about 100-200 μm). The electrode material can comprise a battery electrode composition and the binder formed by the methods disclosed herein.

In still further aspects, the battery electrode composition may comprise active materials suitable for a specific battery. In some exemplary and unlimiting aspects, the battery electrode composition may comprise, for example, and without limitations, graphite active materials, silicon oxide or silicon-comprising active materials (including composites or nanocomposites, such as Si—C nanocomposites, among others), metal oxide and other active anode materials, conductive additives, other functional additives, but may be substantially free of conventional solvents. In certain aspects, the anode active materials may be provided as particles or as core-shell particles or composite anode particles. In still further aspects, the anode active materials can comprise Si-comprising composite particles whereby Si-comprising active material is deposited within pore(s) of a particle core.

In some exemplary and unlimiting aspects, the battery electrode composition, as described herein, may comprise composite particles, wherein each of the composite particles can comprise carbon and silicon. It is understood that a ratio of carbon and silicon in the composite particles can be any ratio that provides the desired battery performance. Yet in still further aspects, the silicon can be present in a mass fraction in a range of about 20 wt. % to about 75 wt. % based on the total mass of the composite particles, including exemplary values of about 22 wt. %, about 25 wt. %, about 28 wt. %, about 30 wt. %, about 32 wt. %, about 35 wt. %, about 40 wt. %, about 42 wt. %, about 45 wt. %, about 48 wt. %, about 50 wt. %, about 52 wt. %, about 55 wt. %, about 58 wt. %, about 60 wt. %, about 62 wt. %, about 65 wt. %, about 68 wt. %, about 70 wt. %, and about 72 wt. % (note that each of the foregoing example values may constitute an upper bound or a lower bound to a sub-range that is bounded to any of the other stated values, as explained in a preceding paragraph related to numerical ranges). It is understood that silicon can be present in any amount between any two foregoing values; for example, and without limitations, silicon can have a mass fraction in a range of about 25 wt. % to about 70 wt. %, or about 40 wt. % to about 60 wt. %, or about 30 to about 57 wt. %, and so on.

In certain aspects, each or some of the composite particles may be present in a core-shell configuration. Yet in still further aspects, at least a portion of the composite particles is present in a core-shell configuration.

In still further aspects, the suitable electrode materials may advantageously comprise conductive fillers (conductive additives). It is understood that the terms conductive fillers and conductive additive compositions can be used interchangeably. In such exemplary and unlimiting aspects, the conductive fillers or conductive additive compositions may comprise one, two or more of the following: carbon, carbon black, modified carbon, modified carbon black, dendritic carbon, graphene (incl. single-layered graphene and/or multi-layered graphene with about 2 to about 40 layers, on average (e.g., about 2-10, about 10-20, about 20-30, or about 30-40, on average)), graphene oxide, graphite, exfoliated graphite, carbon nanotubes, carbon nanofibers, carbon fibers, carbon nano-flakes, graphite ribbons, salts of carboxymethyl cellulose (CMC) or salts of alginic acid (note that CMC and alginates are not conductive, but may help to disperse conductive additives), or any combination thereof.

In some aspects, the electrode material comprises lower-capacity particles. In some aspects, the lower-capacity particles have a charge capacity of about 400 mAh/g or less, including exemplary values of about 380 mAh/g or less, about 372 mAh/g or less, or 350 mAh/g or less. In still further aspects, the lower-capacity particles can comprise graphite-based active material particles. In some aspects, such graphite-based active material may comprise natural, artificial or a mixture of natural and artificial graphites. In some aspects, at least some of the graphite-based active material particles exhibit a specific capacity in a range of about 320 mAh/g to about 372 mAh/g. Graphite-based active material that may be useful in various aspects include various soft-type synthetic graphite (or soft carbon, broadly), various hard-type synthetic graphite (or hard carbon, broadly), and various natural graphite (which may, for example, be pitch carbon coated, among others); including those which exhibit discharge capacity from about 320 to about 372 mAh/g (e.g., about 320-350 mAh/g; about 350-362 mAh/g; or about 362-372 mAh/g).

In still further aspects, the composite particles and lower-capacity particles can be present in any ratio that provides for desired battery performance. In some aspects, a mass ratio of the composite particles to the lower-capacity particles is in a range of about 10:90 to about 99:1(e.g., about 15:85, about 20:80; about 30:70, about 40:60, about 50:50, about 60:40, about 70:30, about 80:20, about 90:10, and about 95:5 (note that each of the foregoing example values may constitute an upper bound or a lower bound to a sub-range that is bounded to any of the other stated values, as explained in a preceding paragraph related to numerical ranges)).

While the description below may describe certain examples of suitable intercalation-type graphites to be used in combination with Si—C nanocomposite (e.g., particles) in a blend, it will be appreciated that various aspects of this disclosure may be applicable to soft-type synthetic graphite (or soft carbon, broadly), hard-type synthetic graphite (or hard carbon, broadly), and natural graphite (which may, for example, be pitch carbon coated); including those which exhibit discharge capacity from about 320 to about 372 mAh/g (e.g., about 320-350 mAh/g; about 350-362 mAh/g; or about 362-372 mAh/g); including those which exhibit low, moderate and high swelling; including those which exhibit good and poor compression, including those which exhibit Brunauer-Emmett-Teller (BET) specific surface area of about 0.5 to about 8 m²/g (about 0.5-2 m²/g; about 2-4 m²/g; or about 4-8 m²/g); including those which exhibit lithiation efficiency of about 90% and more; including those which exhibit average particle sizes from about 8 μm to about 18 μm; including those which exhibit true densities ranging from about 1.5 g/cm³ to about 2.3 g/cm³ (e.g., about 1.5-1.8 g/cm³, or about 1.8-2.3 g/cm³); including those which exhibit poor, moderate, or good cycle life when used in Li-ion battery anodes on their own (e.g., without Si—C composites or other active particles); including those which are coated and comprise coatings with coating thickness to appreciably improve compression and springing during cycling.

Referring to FIG. 3, the method of forming the electrode first comprises providing a binder (stages 312 and 322). It is understood that the binder for the anode and the cathode can be the same or different. Yet in still further aspects, the binder provided for the anode is the binder formed by the methods disclosed herein. In still further aspects, the method comprises a stage 314 of making an anode slurry.

In certain aspects, the conductive fillers or additives disclosed above may be mixed with the electrode active material to form a slurry. The conductive additive compositions present in the slurry (or in the blend that is used to form a slurry) can comprise carbon black and/or carbon nanotubes.

In still further aspects, a suitable anode material composition is mixed with the formed binder to form the slurry. The slurry can comprise a solvent, one or more surfactants, or other functional additives if needed. The functional additives can comprise, for example, and without limitation, flame retardant or flame-resistant agents, antifoaming agents, biocide agents, or any combination thereof.

In still further aspects, the slurry can be formed by any known-in-the-art methods. For example and without limitations, the slurry can comprise a solvent composition. In some aspects, the solvent composition comprises water. In some aspects, the solvent composition comprises N-methylpyrrolidone (NMP). In some aspects, the solvent composition comprises 2,5,7,10-tetraoxaundecane (TOU), 4,8-dimethyl-2,5,7,10-tetraoxaundecane (Elcosol DM), 1,3-dioxolane, triethyl phosphate (TEP), or another NMP alternative. In some aspects, the solvent composition comprises an alcohol.

Similarly, the cathode slurry can be formed by mixing a suitable cathode active material with a binder, a solvent, and any other functional additives at a stage 324. Any suitable cathode active materials known in the art and disclosed herein can be used to form a cathode electrode at stage 326. It is understood that the cathode electrode coating and/or the cathode slurry can also comprise conductive fillers, as disclosed above.

In still further aspects, the electrodes (either anode or cathode) are formed on the current collectors at stages 316 and 326, respectively, by casting the respective slurry onto and/or into a current collector. In certain aspects, the current collector can comprise a metal foil, metal wire, metal mesh, or any combination thereof. In certain aspects, the current collector can comprise Cu or Cu-alloy foil for most anodes and Al or Al-alloy foil for most cathodes.

In still further aspects, at stages 316 and 326, the cast compositions (either an anode-forming composition or a cathode-forming composition) are dried to completely evaporate the solvent. In still further aspects, at stages 316 and 326, the cast compositions undergo a calendering process (compaction), which may be carried out after the drying (solvent evaporation) process.

The current collector can be present in any known form depending on the desired application. In some exemplary and unlimiting aspects, the current collector can be a metal mesh, metal foam or a very rough metal foil (e.g., comprising metal nanowires or metal nanosheets on its surface). Such current collectors can be used if higher areal capacity loadings or faster charge are desired. In still further aspects, the current collector can comprise a metal coated with a thin polymer. Such collectors can be provided as sheets. It is understood that such a design of the current collector may ensure (improved safety or lower current collector weight, etc.). Other examples of current collectors include a porous metal foil or composite (e.g., nanocomposite) metal foils may be used in some designs (e.g., for improved properties, lower weight, etc.).

In still further aspects, disclosed herein is a battery. In such exemplary and unlimiting aspects, the battery is a lithium-ion battery comprising a battery electrode prepared by the method disclosed herein and configured to be an anode. Still further, the battery comprises another battery electrode configured as a cathode and an electrolyte. Referring to FIG. 3, at stage 330, the lithium battery cell is assembled from at least the anode electrode and the cathode electrode with an electrolyte interposed between the anode electrode and the cathode electrode (as shown in FIG. 1). The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations, e.g., implementations in which a liquid electrolyte is used, a separator may be used to maintain a space between the anode and the cathode electrodes. In such an implementation, the liquid electrolyte may infiltrate the separator.

In still further aspects, the step of assembling the battery can comprise positioning a suitable separator that can comprise polymer and/or ceramic components between the cathode and anode electrodes. Packaging the battery into a desired configuration (e.g., a cylindrical cell configuration, a prismatic cell configuration, a pouch cell configuration), carrying out electrochemical formation (for example, in stage 332), degassing, sealing and aging processes, among others, are employed to produce a superior battery cell for use in a battery system for energy storage in transportation, electronic devices, electrical grid, and other applications.

Some embodiments of the present disclosure on Li-ion batteries may benefit from the use of certain electrolyte compositions in battery cell fabrication to attain superior characteristics. In some designs, suitable electrolyte composition may comprise (i) one, two, three or more Li salts with the total concentration in the range from about 0.8 M to about 2.0 M (e.g., about 0.8-1.0 M; about 1-1.1 M; about 1.1-1.2 M; about 1.2-1.3 M; about 1.3-1.4 M; about 1.4-1.5 M; about 1.5-1.6 M; about 1.6-1.7 M; about 1.7-1.8 M; or about 1.8-2.0 M); (ii) one or more cyclic carbonates (e.g., one or more of vinylene carbonate (VC), ethylene carbonate (EC), fluorinated cyclic carbonates, such as fluoroethylene carbonate (FEC), among others), (iii) zero, one, or more nitrogen-comprising co-solvents (in some designs, at least some of the nitrogen comprising co-solvents may advantageously comprise two or three or more nitrogen atoms per molecule), (iv) zero, one, or more sulfur comprising co-solvents, (v) zero, one, or more phosphorous comprising co-solvents (note that some co-solvents may advantageously comprise both phosphorus and sulfur), (vi) zero, one, or more linear or branched esters as co-solvents, (vii) zero, one, or more linear carbonates as co-solvents, (viii) zero, one, or more additional electrolyte co-solvents or additives. In some designs, the volume fraction of linear esters (as a fraction of all co-solvents in the electrolyte) may range from about 20 vol. % to about 85 vol. % (e.g., about 20-40 vol. %; about 40-60 vol. %; or about 60-85 vol. %). In some designs, the volume fraction of branched esters (as a fraction of all co-solvents in the electrolyte) may range from about 10 vol. % to about 80 vol. % (e.g., about 10-30 vol. %; about 30-60 vol. %; or about 60-80 vol. %). In some designs, the volume fraction of cyclic carbonates (as a fraction of all co-solvents in the electrolyte) may range from about 5 vol. % to about 40 vol. % (e.g., about 5-10 vol. %; about 10-20 vol. %; or about 20-40 vol. %). In some designs, the volume fraction of fluorinated cyclic carbonates (as a fraction of all co-solvents in the electrolyte) may range from about 1 vol. % to about 20 vol. % (e.g., about 1-4 vol. %; about 4-6 vol. %; about 6-12 vol. %; or about 12-20 vol. %). In some designs, the volume fraction of VC (as a fraction of all co-solvents in the electrolyte) may range from about 0.25 vol. % to about 6 vol. % (e.g., about 0.25-0.5 vol. %; about 0.5-1 vol. %; about 1-2 vol. %; or about 2-6 vol. %). In some designs, 50 vol. % or more of the co-solvents may advantageously exhibit a melting point below about minus (−) 60 °C (in some designs, below about −70 °C; in other designs, below about −80 °C). In some designs utilizing two or more salts, it may be advantageous for the two or more salts to comprise LiPF₆. In some designs, the incorporation of such salts may enhance battery performance properties (cycle stability, resistance, thermal stability, performance at high or low temperatures, etc.), enhance properties of the cathode-electrolyte interphase (CEI) or of the anode's solid-electrolyte interphase (SEI), or provide other performance advantages. In some designs utilizing two or more salts (e.g., the first salt being LiPF₆), it may be additionally advantageous for at least one other salt to also be a salt of Li. Examples of some of such suitable additional salts include lithium bis(fluorosulfonyl) imide (LiFSI), lithium bis(trifluoromethanesulfonyl)imide (LiTFSI), lithium bis(pentafluoroethanesulfonyl)imide (LiBETI) (and other Li imide salts), lithium bis(oxalato)borate (LiBOB), lithium difluoro(oxalato)borate (LiDFOB), lithium 4,5-dicyano-2-(trifluoromethyl)imidazole (LiTDi), lithium 4,5-dicyano-2-(pentafluoroethyl) imidazolide (LiPDi), lithium difluorophosphate (LiDFP), and lithium nitrate (LiNO₃).

In some aspects, the polymerizable composition can comprise one or more ethylenically unsaturated compounds. As described in detail above, the ethylenically unsaturated compounds are employed in a broad sense and is intended to encompass any compounds containing a reactive carbon-carbon double-bonded group (>C═C< group).

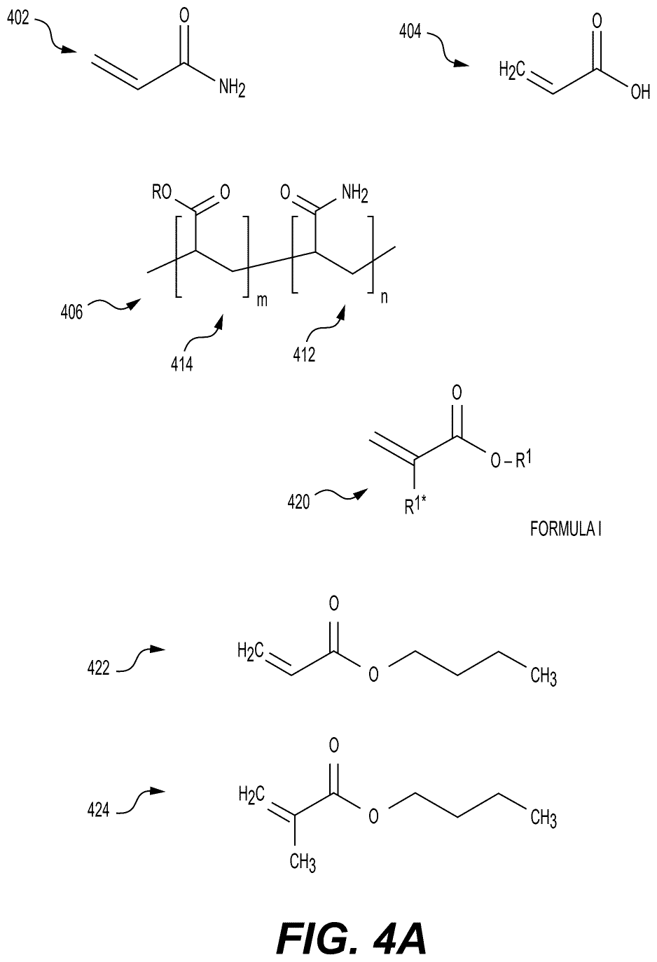

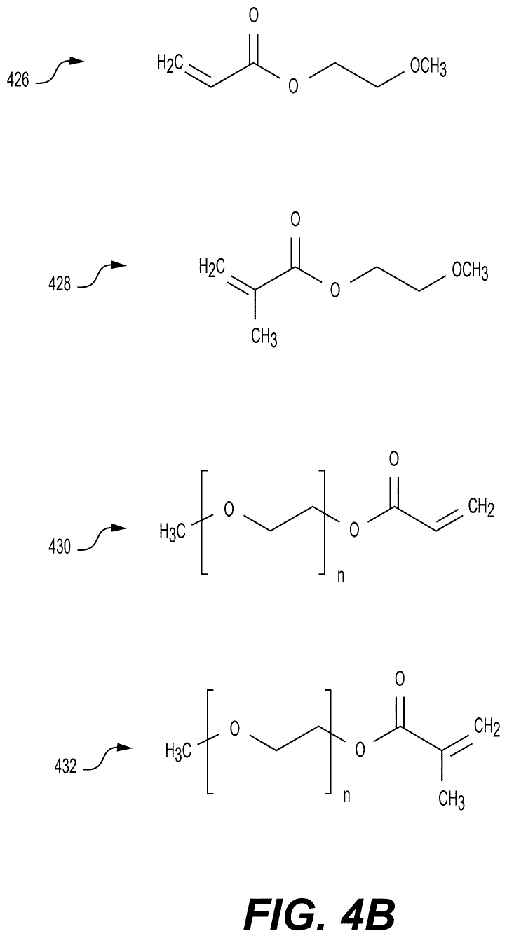

In certain aspects, the polymerizable composition comprises acrylamide monomers (shown as 402 in FIG. 4A) and (meth)acrylic acid monomers (acrylic acid monomer is shown as 404 in FIG. 4A). These reactive monomers, dissolved in a solvent composition, may undergo polymerization in the presence of a free-radical initiator. A poly(acrylamide-co-acrylic acid) copolymer that may be formed from acrylamide monomers and acrylic acid monomers is shown schematically as 406 (FIG. 4A). In the example shown, copolymer 406 comprises n units of the acrylamide monomeric unit 412 and m units of the acrylic acid monomeric unit (or acrylate monomeric unit) 414. In the example shown, monomeric unit 414 includes an RO moiety in which R can be H or a metal (e.g., Na, K). When R is H, the monomeric unit 414 is an acrylic acid unit. When R is Na or K, the monomeric unit 414 is a sodium or potassium acrylate monomeric unit, respectively. A poly(acrylamide-co-acrylic acid) copolymer is sometimes referred to as a PAMAA polymer (or a PAMAA copolymer) herein. It is understood that terms such as acrylamide and (meth)acrylic acid may refer to the respective monomers, before polymerization, or the respective monomeric units, after polymerization.

In some aspects, the polymerizable composition can additionally comprise a (meth)acrylic ester having a generic Formula I shown as 420 in FIG. 4A, wherein R^{1*} is selected from H and CH₃, and R¹ is C₁₋₁₂ alkyl or an oligo(ethylene glycol) alkyl. In some implementations, R¹ is C₁₋₁₂ alkyl or C₁₋₈ alkyl or C₁₋₆ alkyl or C₁₋₄ alkyl or C₂₋₈ alkyl or C₂₋₆ alkyl or C₂₋₄ alkyl. In some implementations, R¹ is an oligo(ethylene glycol) alkyl, wherein the oligo(ethylene glycol) comprises n units of ethylene glycol and n is at least 1. In some implementations, the (meth)acrylic ester may be butyl acrylate (molecular weight or MW of about 128) (shown as 422 in FIG. 4A), butyl methacrylate (MW of about 142) (424), ethylene glycol methyl ether acrylate (MW of about 130) (426, FIG. 4B), or ethylene glycol methyl ether methacrylate (MW of about 144) (428). Ethylene glycol methyl ether acrylate (426) is an example of an oligo(ethylene glycol) methyl ether acrylate (430), in which the number of ethylene glycol units n is 1. Ethylene glycol methyl ether methacrylate (428) is an example of an oligo(ethylene glycol) methyl ether methacrylate (432), in which the number of ethylene glycol units n is 1. In some implementations, the (meth)acrylic ester may be an oligo(ethylene glycol) alkyl ether (meth)acrylate (e.g., the alkyl is methyl), in which the number of ethylene glycol units is in a range of 1 to 22 (e.g., 1 to 4, 4 to 8, 8 to 12, 12 to 16, 16 to 22, 1 to 2, 2 to 4, 4 to 5, 5 to 7, 7 to 10, 10 to 13, 13 to 16, 16 to 19, 19 to 20, or 20 to 22). Herein, oligo(ethylene glycol) methyl ether (meth)acrylate monomers and units are referred to as OEGMA-type monomers and units, respectively. OEGMA is an abbreviation for oligo(ethylene glycol) methyl ether (meth)acrylate, which may also be referred to as poly(ethylene glycol) methyl ether (meth)acrylate. In some implementations, (meth)acrylic esters of Formula I (420) are examples of “softer” units that may make the resulting copolymers somewhat softer.

In some exemplary and unlimiting aspects, the (meth)acrylic ester can have an average molecular weight of at most about 200, but can also include (meth)acrylic esters having an average molecular weight (MW) of less than about 200, for example, an average molecular weight of about 198, about 184, about 170, about 168, about 156, about 154, about 142, about 128, about 114, about 100, or about 86. An average molecular weight may be within a range of any two of the foregoing values. In some aspects, the (meth)acrylic ester can have an average molecular weight of about 86 or greater. Some examples of (meth)acrylic esters are (MW is shown after each compound): methyl acrylate (86), ethyl acrylate (100), n-propyl or isopropyl acrylate (114), n-butyl or isobutyl or tertbutyl acrylate (128), n-pentyl or isopentyl acrylate (142), n-hexyl acrylate (156), cyclohexyl acrylate (154), 2-ethylhexyl acrylate (184), methyl methacrylate (100), ethyl methacrylate (114), n-propyl or isopropyl methacrylate (128), n-butyl or isobutyl or tertbutyl methacrylate (142), n-pentyl or isopentyl methacrylate (156), n-hexyl methacrylate (170), cyclohexyl methacrylate (168), 2-ethylhexyl methacrylate (198), and combinations of any of the foregoing.

In some exemplary and unlimiting aspects, the (meth)acrylic ester can have an average molecular weight of at most about 1100 but can also include (meth)acrylic esters having an average molecular weight (MW) of less than about 1110. In some aspects, the (meth)acrylic ester can have an average molecular weight of about 130 or greater. Some examples of (meth)acrylic esters are: oligo(ethylene glycol) methyl ether acrylate (MW of about 86.09+44.053·n, wherein n is at least 1) and oligo(ethylene glycol) methyl ether methacrylate (MW of about 100.117+44.053·n, wherein n is at least 1).

In still further aspects, a mass fraction of the acrylamide in the polymerizable composition is in a range of about 45 to about 95 wt. %. It is understood that the mass fraction of the acrylamide in the polymerizable composition may be in any range falling between any two foregoing values. For example, the mass fraction of the acrylamide in the polymerizable composition can be in a range of about 50-95 wt. %, or about 50-90 wt. %, or about 60-90 wt. %, or about 70-90 wt. %, or about 45-50 wt. %, or about 50-60 wt. %, or about 60-70 wt. %, or about 70-80 wt. %, or about 80-90 wt. %, or about 90-95 wt. %, and so on. It is understood that all wt. % disclosed herein are calculated based on the total weight (mass) of the reactive monomers in the polymerizable composition.

In still further aspects, a mass fraction of the (meth)acrylic acid in the polymerizable composition is in a range of about 5 to about 50 wt. %. It is understood that the mass fraction of the (meth)acrylic acid in the polymerizable composition may be in any range falling between any two foregoing values. For example, the mass fraction of the (meth)acrylic acid in the polymerizable composition can be in a range of about 5-30 wt. %, or about 5-25 wt. %, or about 5-10 wt. %, or about 10-15 wt. %, or about 15-20 wt. %, or about 20-25 wt. %, or about 25-30 wt. %, or about 5-15 wt. %, or about 15-25 wt. %, or about 20-30 wt. %, and so on.

In still further aspects, the polymerizable composition comprises a (meth)acrylic ester in addition to the acrylamide and the (meth)acrylic acid. In some implementations, a mass fraction of the (meth)acrylic ester in the polymerizable composition is in a range of about 1 to about 40 wt. %. It is understood that the mass fraction of the (meth)acrylic ester in the polymerizable composition may be in any range falling between any two foregoing values. For example, the mass fraction of the (meth)acrylic ester in the polymerizable composition can be in a range of about 1-3 wt. %, about 1-5 wt. %, about 1-7 wt. %, about 1-10 wt. %, about 10-20 wt. %, about 15-25 wt. %, about 20-30 wt. %, about 30-40 wt. %, about 25-35 wt. %, about 2-5 wt. %, about 5-10 wt. %, or about 2-25 wt. %, and so on. In some implementations, the polymerizable composition does not comprise fluorine. In some implementations, the polymerizable composition does not comprise nitrile groups.

In still further aspects, the polymerizable composition is dissolved and mixed in a solvent composition for carrying out the polymerization process. In some implementations, the solvent composition comprises a water-miscible organic solvent, in which the product of the polymerization (e.g., PAMAA copolymers) precipitate out of solution. Such a water-miscible organic solvent may be selected, for example, from certain alcohols (e.g., ethanol, n-propanol, isopropanol), certain ketones (e.g., acetone, methyl ethyl ketone (MEK)), methyl acetate, dimethylformamide (DMF), and dimethylsulfoxide (DMSO). In some implementations, the solvent composition may employ acetone. By employing such solvents in the solvent composition, the PAMAA copolymers precipitate (in some designs, with a relatively tight control over the copolymer size and molecular weight, which may be highly advantageous) and may be readily purified. In the industrial-scale synthesis of some polymers for battery-grade applications, the synthesis of the polymers is often conducted in water, which may be preferred for cost and environmental reasons. In some of these conventional synthetic processes, the polymerization is conducted at relatively high temperatures and for relatively long periods of time to reduce the amount of residual monomers. However, this leads to the formation of polymers of relatively high molecular weights (MW). Such high-molecular weight polymers may exhibit high viscosities and may be difficult (or undesirable) to employ in slurry formulations. For example, it may be difficult to de-agglomerate the polymer particles. A slurry formulation comprising such high-molecular weight polymers may contain relatively low mass fractions of solids (e.g., polymers) which may result in poor coating quality (e.g., wrinkling), high cost of solvent vaporization, and/or low coating yield. A relatively narrow distribution of MW may be advantageous in some designs. In some designs, it may be preferable for the polydispersity (defined as the weight-average molecular weight divided by the number-average molecular weight (M_{w}/Mₙ)) to be in the range from about 1.0 to about 5.0 (e.g., about 1.0-4.0, about 1.0-2.0, about 2.0-3.0, about 3.0-4.0, or about 4.0-5.0).

In still further aspects, the solvent composition employed in the polymerization comprises a water-miscible solvent and water. In some implementations, solvents other than the water-miscible solvent(s) and water are not present or are present only in negligible quantities (e.g., less than about 3 wt. %, less than about 1 wt. %, or less than about 0.3 wt. %) in the solvent composition. In some implementations, the solvent composition is a mixture of acetone and water. In some implementations of acetone-water mixtures for a solvent composition, the mass ratio of water to acetone may be in a range of about 1:100 to about 25:100 (e.g., about 1:100-10:100, about 5:100-15:100, about 10:100-20:100, about 20:100-25:100, or about 15:100-25:100). In cases in which water and acetone (or another water-miscible solvent) are present in the solvent composition, relative ratios (e.g., mass ratio, volume ratio) of the water to the acetone may be adjusted to obtain a desired outcome. The solubility of the synthesized polymer (e.g., PAMAA copolymer) is greater in water than in acetone. As the water content in an acetone-water mixture of a solvent composition increases, the solubility of the polymerization product in the solvent composition increases concomitantly. When water is employed in an acetone-water mixture of the solvent composition at a higher mass fraction (or higher volume fraction), the solubility of the reaction product in the solvent composition before the onset of precipitation is greater. Accordingly, when water is employed in an acetone-water mixture of the solvent composition at a higher mass fraction (or higher volume fraction), the weight-average molecular weight (M_{w}) and the viscosity of the synthesized polymer (e.g., PAMAA copolymer) are greater. The inventors have found that the concentration of water in the solvent composition influences the molecular weight (and hence the mechanical properties) of the synthesized polymer to a much greater extent than do the concentrations of the polymerizable composition (e.g., monomers) and the free-radical initiator mixed into the reaction medium. Water, when mixed into a solvent composition comprising a water-miscible solvent, may function to regulate the molecular weight of the synthesized polymer, and hence regulate the viscosity and the mechanical properties of the synthesized polymer. During the polymerization reaction, the polymerizable composition (e.g., monomers) reacts to form a mixture with suspended solids that precipitate. The PAMAA copolymers may be obtained in substantially pure solid form by filtering the arrested reaction mixture. According to the synthesis method described herein, the polymerization reaction can be stopped (arrested) by rapidly cooling the reaction mixture (e.g., immersing the reactor in icy water), without waiting for complete conversion of the monomers. In conventional water-based polymerization processes (employing water as the solvent), it may be preferable for the polymerization to proceed until complete conversion of all monomers is attained, because both monomers and the synthesized polymers are soluble in the water and the purification of the synthesized polymers is difficult. However, this leads to the problem that polymers of excessively high molecular weights are obtained. As a result of having such high MW polymers in the conventional binder composition, the aqueous (e.g., PAMAA or PAA-comprising) binder viscosity becomes undesirably high, which may prevent or severely limit their use in large-scale (high-throughput) electrode and battery factories. Alternatively, water-soluble polymers may be purified by an additional step of precipitating in a non-solvent, but such an additional step is not necessary according to the processes described herein.

In still further aspects, the polymerization reaction is carried out under reflux conditions. Under reflux conditions, the temperature of the reaction medium can be readily controlled. In turn, the temperature at which reflux conditions occur depend on the specific solvent composition. In the case of an acetone-water mixture, this temperature is between about 56 °C (boiling point of acetone) and about 100 °C (boiling point of water) and depends on the relative amounts of acetone and water in the mixture. The temperature of the reaction medium influences the outcome of the polymerization. The temperature of the reaction medium affects the solubility of the synthesized polymer, which in turn affects its molecular weight and relative molar ratios of monomeric units (e.g., acrylamide, (meth)acrylic acid, (meth)acrylic ester) in the synthesized polymers. On the other hand, carrying out polymerization at temperatures lower than reflux temperatures may result in uncontrollable overheating of the reaction media, in some designs.

An example polymerization process to obtain the PAMAA copolymers in their COOH form is as follows. All monomers except acrylic acid are dissolved in a minimum amount of acetone (or another suitable solvent such as ethyl alcohol, propyl alcohol, butyl alcohol, isopropyl alcohol, methyl ethyl ketone), and the monomer solution is passed through a column to remove any inhibitors present in the purchased monomers. The column may then be washed with acetone, and the combined monomer solutions are collected in the reaction vessel. Subsequently, acrylic acid is added, and the mixture is diluted with acetone/water to adjust final concentration of the monomers and maintain desired acetone/water ratio. The reaction mixture may then be charged into, for example, a round bottom reactor equipped with a reflux condenser and an effective mechanical stirrer. The reaction mixture is stirred and warmed until a steady reflux is observed (in some designs, the water bath temperature may be around 65 °C). After a few minutes of refluxing, the desired amount of azobisisobutyronitrile (AIBN) (an initiator) dissolved in a minimal quantity of fresh acetone is injected. The precipitation indicating the onset of the copolymer formation may typically be observable within 1-2 minutes. The reaction mixture is stirred under reflux for the desired time (typically 10-120 min, depending on monomer and initiator concentration). At the end of reaction, the reactor is immersed in an ice-water bath to arrest the polymerization. The obtained copolymer powder may then be filtered, washed thoroughly (e.g., with acetone), and air-dried (e.g., at around 70 °C).

A more specific example of a small-scale synthesis of copolymer of acrylamide (AM), acrylic acid (AA), and butyl acrylate (BA) is as follows (2VK 91-1 copolymer). In a 0.5-liter reaction vessel equipped with a mechanical stirrer and reflux condenser immersed in a heating water bath at 70 °C, 180 g of acetone, 20 g of water, 16 g of acrylamide, 4 g of acrylic acid, 12 g of butyl acrylate, and 0.067 g of AIBN were added. The polymerization was conducted for 1 hour under reflux conditions, where white polymer powder was precipitated during the polymerization. The reaction mixture was cooled down to room temperature in an ice-water bath. The polymer was filtered on a filter paper and washed three times with 15 ml of acetone. The product was dried overnight in a convection oven at 70 °C to produce about 13.9 g of the copolymer. The copolymer was then converted into Na salt by the addition of 20.35 ml of 1N NaOH to the 1% copolymer solution in water (13.9 g of copolymer dissolved in 1376 g of DI water) to reach the pH of 7.1. The composition of the final copolymer binder, obtained via a combination of titration and ¹H NMR, was estimated as AM:AA:BA=85.76:10.54:3.70, expressed in wt. %.

Disclosed herein is a method that comprises making a copolymer binder. In further aspects, disclosed herein is a copolymer that is made according to such a method. In some aspects, the copolymer is a copolymer of acrylamide and (meth)acrylic acid. Herein, “a copolymer of acrylamide and (meth)acrylic acid” includes acrylamide monomeric units (monomeric units obtained upon polymerization of the acrylamide monomer, 402), and (meth)acrylic acid monomeric units (monomeric units obtained upon polymerization of the (meth)acrylic acid monomer, acrylic acid monomeric unit shown as 404). In addition, “a copolymer of acrylamide and (meth)acrylic acid” may include monomeric units other than acrylamide and (meth)acrylic acid monomeric units. For example, such a copolymer may be obtained by carrying out a polymerization process as described herein, in which the polymerizable composition includes acrylamide, (meth)acrylic acid, and (meth)acrylic ester. Herein, “a copolymer of acrylamide and (meth)acrylic acid” is sometimes referred to as a PAMAA copolymer. The PAMAA copolymer as initially obtained from the polymerization process is in acid form and may be converted to a metal salt form (e.g., Na salt form, K salt form, Ca salt form) by neutralization. Neutralization converts at least a fraction of the (meth)acrylic acid monomeric units to Na or K or Ca (methyl)acrylate. Herein, such copolymers that comprise Na or K or Ca (methyl)acrylates are also referred to as PAMAA copolymers. The PAMAA copolymers may be obtained as random copolymers or block copolymers. For a random copolymer synthesis, all monomers can be employed at the same time wherein the polymerization is random, whereas for a block polymer synthesis the polymerization of each monomer is controlled or made “living” under the reaction conditions. Each type of copolymer may offer particular properties suitable for binder applications in lithium-ion batteries. For example, in a block copolymer (e.g., PAMAA copolymer for application in an anode formed on a Cu foil current collector), one of the blocks may be chosen for better adhesion to the Cu foil and/or anode particles, and another one of the blocks may be chosen to facilitate better inter-particle adhesion or lithium ion diffusion. For example, for application in an anode comprising Si-comprising particles (e.g., Si—C(nano)composite particles) and graphite particles, one of the blocks may be chosen for better adhesion to the Si surfaces or Si (nano)composite surfaces of the Si-comprising particles and another one of the blocks may be chosen for better adhesion to the graphite particle surfaces. In some implementations, the PAMAA copolymer does not comprise fluorine. In some implementations, the PAMAA copolymer does not comprise nitrile groups. In some implementations, the PAMAA copolymer, as synthesized, and before and after neutralization, does not comprise lithium.

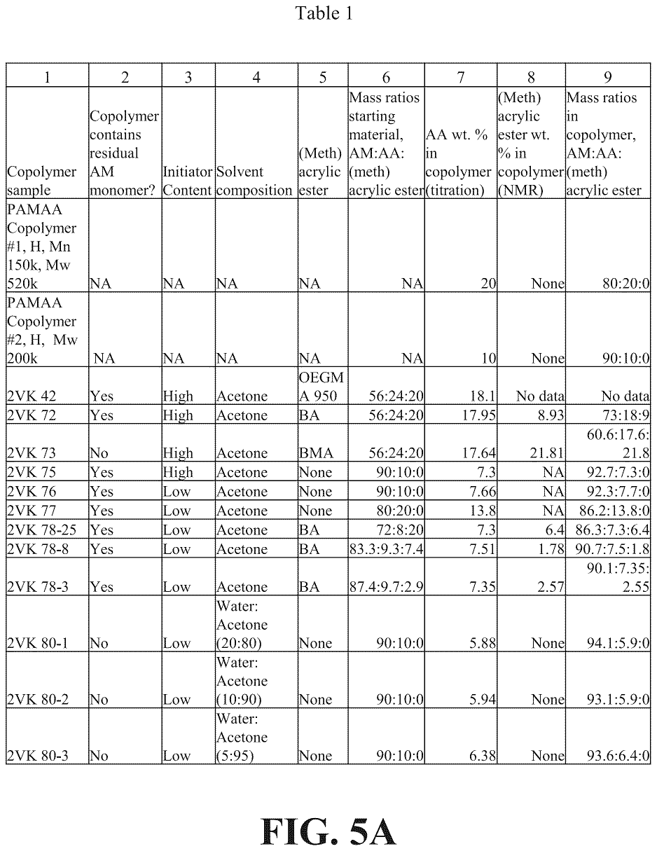

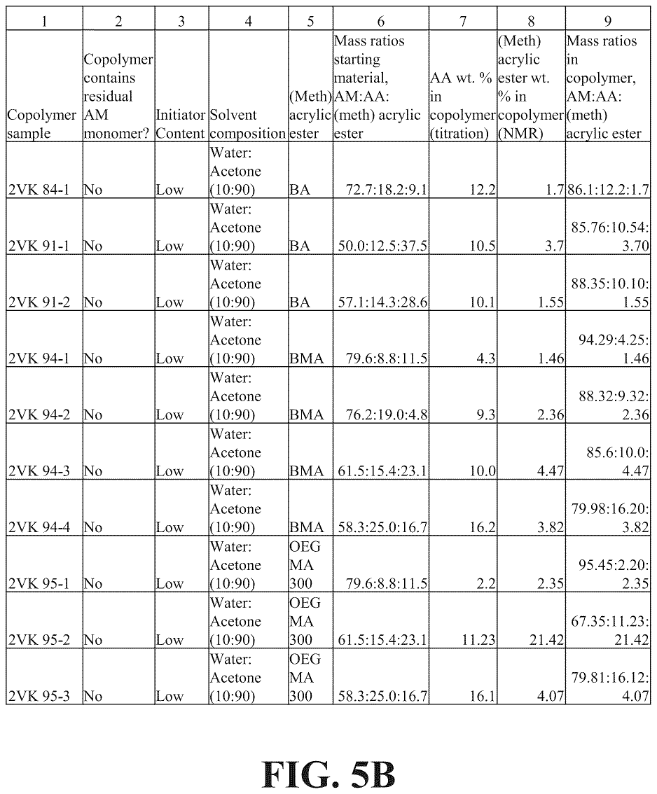

Table 1 of FIG. 5A and FIG. 5B shows selected data relating to composition and synthesis of some example PAMAA copolymers. Copolymers that were synthesized in-house have identifiers that start with “2VK”. For comparison, commercially available PAMAA copolymers #1 and #2 are listed. PAMAA copolymer #1 is reported to be in acid form (H form) and exhibit a number-average molecular weight (M.) of about 150,000 and a weight-average molecular weight (M_{w}) of about 520,000. PAMAA copolymer #2 is reported to be in acid form (H form) and exhibits a weight-average molecular weight (M_{w}) of about 200,000. For the PAMAA copolymers that were synthesized in-house, acrylic acid was the only (meth)acrylic acid used in the polymerizable composition (i.e., methacrylic acid was not used in the examples shown). The presence of detectable amounts of residual acrylamide (AM) monomer in the synthesized copolymers is reported in column 2. Column 3 reports the concentration of the free-radical initiator in the reaction medium at the beginning of the polymerization process. AIBN was used as the free-radical initiator. A “high” concentration of initiator corresponds to an initiator concentration of 0.26 wt. % in the polymerizable composition. A “low” concentration of initiator corresponds to an initiator concentration of 0.026 wt. % in the polymerizable composition. In the example shown, the solvent compositions (shown in Column 4) were acetone or acetone-water mixtures (with water:acetone mass ratios of 20:80, 10:90, and 5:95). Column 5 reports the (meth)acrylic esters that were employed in the polymerizable composition: “BA” means butyl acrylate, “BMA” means butyl methacrylate, and “None” means that no (meth)acrylic ester was employed in the polymerizable composition. In some of the example polymerizable compositions herein, OEGMA 300 or OEGMA 950 was employed. Herein, OEGMA 300 refers to an oligo(ethylene glycol) methyl ether methacrylate with a number-average molecular weight, Mₙ, of about 300 (corresponding to an average n of about 4.5). OEGMA 950 refers to an oligo(ethylene glycol) methyl ether methacrylate with an Mₙ of about 950 (corresponding to an average n of about 20.4). Column 6 indicates the mass ratios of the starting materials (in the polymerizable composition) in the order acrylamide (AM):acrylic acid (AA):(meth)acrylic ester. The amount of incorporated meth(acrylic) acid could be different from the monomer feed ratio due to different reactivities of the monomers, and thus the actual amount of meth(acrylic) acid can be determined by doing an acid-base titration. The results are reported in Column 7, which reports the mass fraction of the acrylic acid (AA) unit in the copolymer, as determined by titration. Column 8 reports the mass fraction of (meth)acrylic ester in the copolymer, as determined by ¹H NMR in aqueous solvent. Column 9 reports the mass ratios of the respective monomeric units (acrylamide (AM):acrylic acid (AA):(meth)acrylic) in the PAMAA copolymer, in acid form, upon completion of operation 210. The relative quantities of acrylamide are calculated from the relative amounts of acrylic acid (column 7) and (meth)acrylic ester (column 8).

Table 1 (FIG. 5A, FIG. 5B) reports examples of polymerizable compositions in which mass fractions of acrylamide in the respective polymerizable compositions are in a range of 50 to 90 wt. %, mass fractions of the acrylic acid in the respective polymerizable compositions are in a range of 8 to 25 wt. %, and mass fractions of the (meth)acrylic ester (butyl acrylate or butyl (meth)acrylate or OEGMA), if present, in the respective polymerizable compositions are in a range of 2.9 to 37.5 wt. %. Table 1 reports examples of PAMAA copolymers in acid form in which mass fractions of acrylamide units in the respective copolymers are in a range of 60.6 to 95.45 wt. %, mass fractions of the acrylic acid in the respective copolymers are in a range of 2.2 to 18 wt. %, and mass fractions of the (meth)acrylic ester (butyl acrylate or butyl (meth)acrylate or OEGMA), if present, in the respective copolymers are in a range of 1.46 to 21.8 wt. %.

In some implementations, synthesis process 200 affords copolymers (in acid form, upon completion of 210), in which a mass fraction of the acrylamide (units) in the copolymer is in a range of about 45 to about 96 wt. % (e.g., about 45-50 wt. %, about 50-60 wt. %, about 60-70 wt. %, about 70-80 wt. %, about 50-96 wt. %, about 60-96 wt. %, about 70-96 wt. %, or about 80-96 wt. %). In some implementations, synthetic process 200 affords copolymers (in neutralized form, upon completion of 212), in which a mass fraction of the acrylamide (units) in the copolymer, excluding any sodium, potassium, or calcium, is about 45 to about 96 wt. % (e.g., about 45-50 wt. %, about 50-60 wt. %, about 60-70 wt. %, about 70-80 wt. %, about 50-96 wt. %, about 60-96 wt. %, about 70-96 wt. %, or about 80-96 wt. %). In some implementations, synthetic process 200 affords copolymers (in acid form, upon completion of 210), in which a mass fraction of the (meth)acrylic acid (units) in the copolymer is in a range of about 2 to about 50 wt. % (e.g., about 2-25 wt. %, about 2-20 wt. %, in a range about 2-10 wt. %, about 10-25 wt. %, about 10-20 wt. %, or about 20-25 wt. %). In some implementations, synthetic process 200 affords copolymers (in neutralized form, upon completion of 212), in which a mass fraction of the (meth)acrylate (units) in the copolymer, excluding any sodium, potassium, or calcium, is in a range of about 2 to about 50 wt. % (e.g., about 2-25 wt. %, about 2-20 wt. %, about 2-10 wt. %, about 10-25 wt. %, about 10-20 wt. %, or about 20-25 wt. %). In some implementations, synthetic process 200 affords copolymers that comprise a (meth)acrylic ester. In some implementations, synthetic process 200 affords copolymers (in acid form, upon completion of 210), in which a mass fraction of the (meth)acrylic ester (units) in the copolymer is in a range of about 1 to about 30 wt. % (e.g., about 1-3 wt. %, about 1-5 wt. %, about 1-7 wt. %, in a range about 1-10 wt. %, about 10-20 wt. %, about 20-30 wt. %, about 1-25 wt. %, about 1-20 wt. %, about 1-15 wt. %, about 20-25 wt. %, or about 15-25 wt. %). In some implementations, synthetic process 200 affords copolymers (in neutralized form, upon completion of 212), in which a mass fraction of the (meth)acrylic ester (units) in the copolymer, excluding any sodium, potassium, or calcium, is in a range of about 1 to about 30 wt. % (e.g., about 1-3 wt. %, about 1-5 wt. %, about 1-7 wt. %, in a range about 1-10 wt. %, about 10-20 wt. %, about 20-30 wt. %, about 1-25 wt. %, about 1-20 wt. %, about 1-15 wt. %, about 20-25 wt. %, about 15-25 wt. %, or about 15-30 wt. %.).

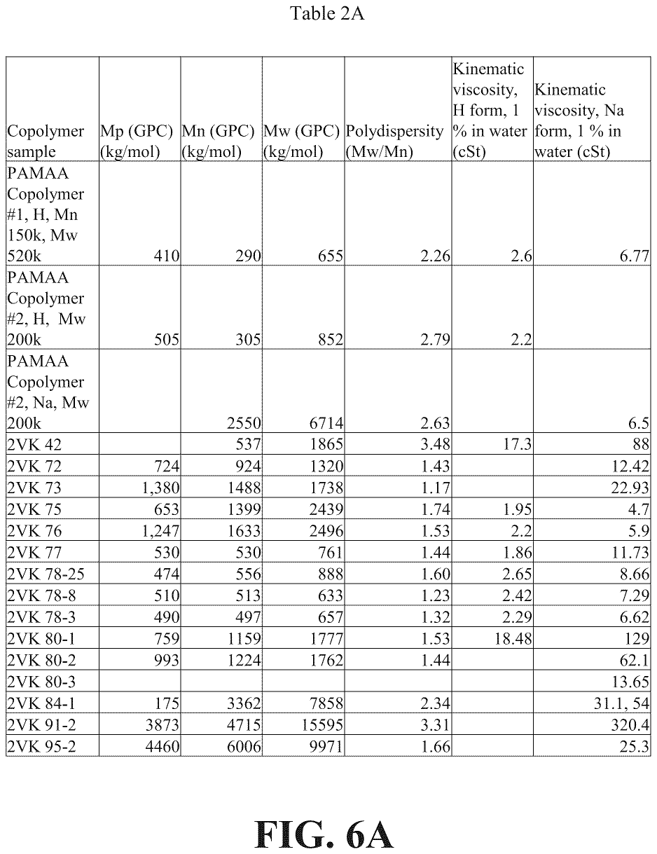

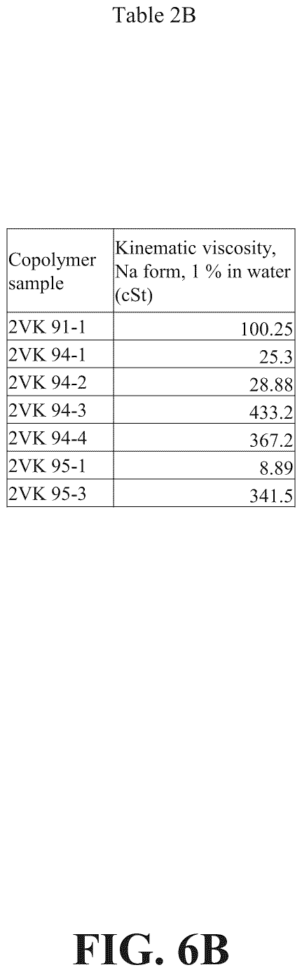

Table 2A of FIG. 6A shows selected molecular weight and viscosity data of some example PAMAA copolymers. The purified copolymers in their acid form (i.e., before neutralization) were tested for molecular weight and polydispersity index determinations using gel permeation chromatography (GPC)/Size exclusion chromatography (SEC) in water. Table 2A reports the peak molecular weight (Mₚ), the number-average molecular weight (Mₙ), and the weight-average molecular weight (M_{w}) of commercially available PAMAA copolymers in acid form (#1, #2) and PAMAA copolymers synthesized in-house, in acid form (2VK samples). For the GPC/SEC chromatography, Agilent 1100 series HPLC setup was used which include G1315B 1100 Series Diode Array UV-vis (ultraviolet-visible) Detector and is equipped with Agilent A4000 SEC column, working temperature of 40 °C, flow rate of 0.5 mL/min. The column was calibrated using two ReadyCal-Kit PEO/PEG: the “black cap” kit (1180000, 99000, 6530 Da Mp) and the “blue cap” kit (504000, 42700, 599 Da Mp) by PSS, Mainz, Germany. The samples were prepared by dissolving in Milli-Q DI water, a concentration of 1.0-5.0 mg/mL, obtained solutions were filtered using 25 mm diameter PTFE Syringe Filters, Hydrophilic, pore size 0.22 μm (if viscosity allows) or 0.45 μm (when viscosity was too high), by Advantec. The concentration of the PAMAA copolymer solutions used in the experiments was 1 wt. % solution, either in their H-form or Na-form. For PAMAA copolymers synthesized in-house, the Mₚ values ranged between 175 kg/mol (2VK 84-1) and 4460 kg/mol (2VK 95-2), the Mₙ values ranged between 497 kg/mol (2VK 78-3) and 6006 kg/mol (2VK 95-2), and M_{w} values ranged between 633 kg/mol (2VK 78-8) and 15,595 kg/mol (2VK 91-2). These measured molecular weight values may be compared to the measured molecular weight values of the commercially available PAMAA copolymers (in acid form) (Mₚ of 410 and 505 kg/mol, Mₙ of 290 and 305 kg/mol, and M_{w} of 655 and 852 kg/mol). For each of Mₚ, Mₙ, and M_{w}, the average value for the commercially available PAMAA copolymers (in acid form) (average Mₚ is 458 kg/mol, average Mₙ is 298 kg/mol, average M_{w} is 754 kg/mol) is lower than the average value for the in-house synthesized PAMAA copolymers (average Mₚ is 1251 kg/mol, average Mₙ is 1753 kg/mol, average M_{w} is 3554 kg/mol). In some implementations, synthetic process 200 affords polymers (in acid form, upon completion of 210) of a number-average molecular weight (Mₙ) in a range of about 400 to about 6200 kg/mol (e.g., about 400-800 kg/mol, about 800-1200 kg/mol, about 1200-1700 kg/mol, about 1700-2200 kg/mol, about 2200-2700 kg/mol, about 2700-3200 kg/mol, about 3200-3700 kg/mol, about 3700-4200 kg/mol, about 4200-4700 kg/mol, about 4700-5200 kg/mol, about 5200-5700 kg/mol, or about 5700-6200 kg/mol). In some implementations, synthetic process 200 affords copolymers (in acid form, upon completion of 210) of a weight-average molecular weight (M_{w}) in a range of about 600 to about 16500 kg/mol (e.g., about 600-1000 kg/mol, about 1000-1200 kg/mol, about 1200-2500 kg/mol, about 2500-4500 kg/mol, about 4500-6500 kg/mol, about 6500-8500 kg/mol, about 8500-10500 kg/mol, about 10500-12500 kg/mol, about 12500-14500 kg/mol, or about 14500-16500 kg/mol).

In some implementations, synthetic process 200 affords polymers (in neutralized form, upon completion of 210) of a number-average molecular weight (Mₙ) in a range of about 400 to about 6200 kg/mol (e.g., about 400-800 kg/mol, about 800-1200 kg/mol, about 1200-1700 kg/mol, about 1700-2200 kg/mol, about 2200-2700 kg/mol, about 2700-3200 kg/mol, about 3200-3700 kg/mol, about 3700-4200 kg/mol, about 4200-4700 kg/mol, about 4700-5200 kg/mol, about 5200-5700 kg/mol, or about 5700-6200 kg/mol). In some implementations, synthetic process 200 affords copolymers (in neutralized form, upon completion of 210) of a weight-average molecular weight (M_{w}) in a range of about 600 to about 16500 kg/mol (e.g., about 600-1000 kg/mol, about 1000-1200 kg/mol, about 1200-2500 kg/mol, about 2500-4500 kg/mol, about 4500-6500 kg/mol, about 6500-8500 kg/mol, about 8500-10500 kg/mol, about 10500-12500 kg/mol, about 12500-14500 kg/mol, or about 14500-16500 kg/mol).

In some implementations, synthetic process 200 affords polymers (in acid form or neutralized form, upon completion of 210) of a number-average molecular weight (Mₙ) in a range of about 600 to about 10,000 kg/mol (e.g., about 600-1300 kg/mol, about 1300-1900 kg/mol, about 1900-2700 kg/mol, about 2700-3500 kg/mol, about 3500-4300 kg/mol, about 4300-5100 kg/mol, about 5100-5900 kg/mol, about 5900-6700 kg/mol, about 6700-7500 kg/mol, about 7500-8300 kg/mol, about 8300-9100 kg/mol, or about 9100-10,000 kg/mol). In some implementations, synthetic process 200 affords copolymers (in acid form or neutralized form, upon completion of 210) of a weight-average molecular weight (M_{w}) in a range of about 1000 to about 26,500 kg/mol (e.g., about 1000-1600 kg/mol, about 1600-1900 kg/mol, about 1900-4000 kg/mol, about 4000-7200 kg/mol, about 7200-10,400 kg/mol, about 10,400-13,600 kg/mol, about 13,600-16,800 kg/mol, about 16,800-20,000 kg/mol, about 20,000-23,200 kg/mol, or about 23,200-26,500 kg/mol).

Table 2A reports the polydispersity of selected PAMAA copolymers. Polydispersity is calculated as M_{w}/Mₙ and is a measure of the heterogeneity of the size (molecular weights) of the polymers (copolymers) in a population. A polydispersity of 1 indicates that the polymers of a population are uniform in size (molecular weight). The polydispersity of the PAMAA copolymers synthesized in-house ranged between 1.17 and 3.48 (average 1.8), significantly smaller, on average, than the polydispersity of the commercially available PAMAA copolymers (in acid form) (2.26 and 2.79) (average 2.53). The synthesis processes of the present technology afford polymers of lower polydispersity than in polymers made according to conventional technologies, which may be highly advantageous when used as binders (e.g., in Si—C comprising anodes). In some implementations, synthetic process 200 affords copolymers (e.g., in acid form, upon completion of 210) of polydispersity in a preferred range of about 1.0 to about 5.0 (e.g., about 1.0-4.0, about 1.0-2.0, about 1.0-1.8, about 1.0-1.7, about 1.0-1.6, about 1.0-1.5, about 1.0-1.4 about 1.0-1.3, or about 1.0-1.2). In some designs, smaller polydispersity values may be highly advantageous for electrode production yield and performance in battery cells. Similarly, the polydispersity of the copolymers in neutralized form, excluding any sodium, potassium, or calcium (e.g., upon completion of 212) may be in a preferred range of about 1.0 to about 5.0 (e.g., about 1.0-4.0, about 1.0-2.0, about 1.0-1.8, about 1.0-1.7, about 1.0-1.6, about 1.0-1.5, about 1.0-1.4 about 1.0-1.3, or about 1.0-1.2).

Table 2A of FIG. 6A shows viscosity (kinematic viscosity) data of some example PAMAA copolymers. Kinematic viscosities (in cSt) are reported for (1) PAMAA copolymers in acid form (H form), dissolved in water at a concentration of 1 wt. %, and (2) PAMAA copolymers in Na salt form after neutralization of the copolymer using NaOH, dissolved in water at a concentration of 1 wt. %. The two commercially available PAMAA copolymers were obtained in acid form and their kinematic viscosities, in 1 wt. % solution in water, were measured before and after neutralization. Similarly, Table 2B of FIG. 6B shows viscosity data of some example PAMAA copolymers, for which molecular weight data are not available. Kinematic viscosities (in cSt) are reported for PAMAA copolymers in Na salt form after neutralization of the copolymer using NaOH, dissolved in water at a concentration of 1 wt. %. Viscosity measurements of polymer solution at 1 wt. % in water were carried out using Cannon-Fenske Routine Viscometer. The viscometer was used to measure the kinematic viscosity of transparent liquids in accordance with standard ASTM D445, ASTM D446, ISO 3104, and ISO 3105 methods. For the measurements, the viscometers with capillary size ranging from 50 to 400 μm were selected. Before each measurement, the viscometer was cleaned with DI water and dried in a stream of N₂ gas. An approximate 10 ml sample was used. The flow time of each liquid was recorded at 25 °C. The kinematic viscosity was calculated by multiplying the flow time in seconds by the viscometer constant. Among the synthesized copolymers for which kinematic viscosities were measured for both acid and neutralized forms (i.e., 2VK 42, 2VK 75, 2VK 76, 2VK 77, 2VK 78-25, 2VK 78-8, 2VK 78-3, 2VK 80-1), the kinematic viscosities in acid form ranged between 1.86 to 18.48 cSt (average 6.14 cSt) and the kinematic viscosities in neutralized form (Na form) ranged between 4.7 to 320.4 cSt (average 32.7 cSt). Among those samples for which measurements were carried out on both acid and neutralized forms, the kinematic viscosity increased by a factor of about 4.1, on average, upon neutralization (i.e., conversion to Na salt form). For comparison, the commercially available PAMAA copolymers exhibited kinematic viscosities in a range of 2.2 to 2.6 cSt (average 2.4 cSt) in acid form and kinematic viscosities in a range of 6.5 to 6.77 cSt (average 6.64 cSt) in neutralized form (Na salt form). For these commercially available PAMAA copolymers, the average kinematic viscosity increased by a factor of about 2.8, on average, upon neutralization (conversion to Na salt form). For the population of all in-house synthesized PAMAA copolymers (Na salt form) shown in Table 2A, the kinematic viscosities were in a range of 4.7 to 129 cSt. For the population of all in-house synthesized PAMAA copolymers (Na salt form) shown in Table 2A and Table 2B, the kinematic viscosities were in a range of 4.7 to 433.2 cSt. In some implementations, synthetic process 200 affords copolymers (in neutralized form (Na salt form), upon completion of 212) for which solutions of the respective copolymer at 1 wt. % in water exhibit kinematic viscosities in a range of about 3 to about 450 cSt (e.g., about 3-150 cSt, about 5-150 cSt, about 3-10 cSt, about 10-30 cSt, about 3-30 cSt, about 30-50 cSt, about 50-100 cSt, about 100-130 cSt, about 130-150 cSt, about 100-150 cSt, about 150-300 cSt, about 150-200 cSt, about 200-250 cSt, about 250-300 cSt, about 300-350 cSt, about 350-400 cSt, or about 400-450 cSt). The PAMAA copolymers may be employed as a binder in an electrode coating. In some designs, the content of the PAMAA copolymer, as binder solids, in an electrode slurry may be adjusted in accordance with the viscosity of the PAMAA copolymer. For example, binder solids content in a saturated solution may range from as low as about 3 wt. % (for highly viscous binder polymers) to as high as about 20 wt. % (for less viscous binder polymers). Viscosity of binder solutions has implications in the kneading process (hardmix or dough phase) of slurry making as well as total slurry solids content. A low slurry solids content is a direct implication of highly viscous binder solutions with low solubility of binders (< about 5 wt. %, or in some cases < about 10 wt. %). In some designs, a low total slurry solids content makes the coating process inefficient and more costly due to the need for removal of large amounts of the solvent. Conventional binder polymers often be used at low total solids content (in some cases, about 5-10 wt. %, while in other cases < about 5 wt. %) to attain acceptable slurry viscosities. On the other hand, a high binder solubility (> about 10 wt. %) may be particularly beneficial as such binders often result in high total slurry solids content. The kneading viscosity using such binder solutions may be adjusted by dilution with solvent as needed. For example, a highly viscous binder solution has a viscosity of > about 150 cSt (e.g., about 150-450 cSt), whereas the medium viscosity solution ranges between 50 and 150 cSt, and a low viscosity solution has a viscosity of < about 50 cSt. In some designs, a higher solubility of binder (e.g., > about 10 wt. %) offers the advantage of tunability of viscosity by dilution while maintaining appropriate binder content.

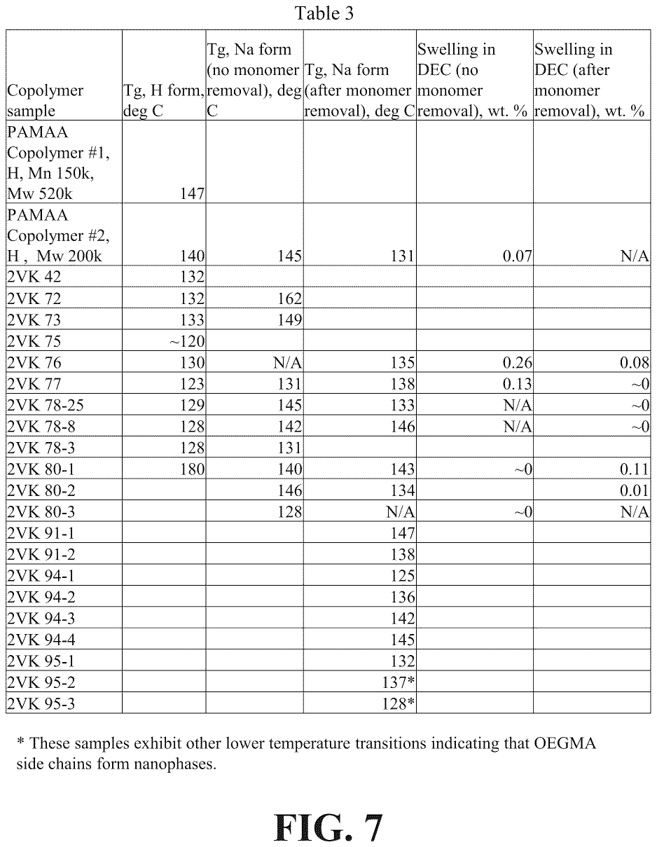

Table 3 of FIG. 7 shows data relating to the glass transition temperature (T_{g}, measured from differential scanning calorimetry (DSC)). For DSC measurements using DSC 2920 (TA Instruments), samples were first dried in an oven at 110 °C for 2 h before analysis. Samples (approximately 5 mg) were heated from −100 °C to 180 °C at a heating rate of 20 °C/min; and then cooled down to −100 °C at the same rate. Subsequently, a second cycle of heating and cooling was performed. All experiments were conducted under a nitrogen atmosphere with a gas flow of 20 mL/min. Table 3 shows T_{g} data of the PAMAA copolymers in the following stages: (1) in acid form (H form), upon completion of 210; (2) in neutralized form (Na salt form), upon completion of 212, which has not had any monomer removal; and (3) in neutralized form (Na salt form), upon completion of 212, after a monomer removal process by washing with acetone and water. The glass transition temperatures were in a range of about 120 to about 180 °C for the in-house synthesized PAMAA copolymers in acid form, in a range of about 128 to about 162 °C for the in-house synthesized PAMAA copolymers in Na form, without monomer removal, and in a range of about 125 to about 147 °C for the in-house synthesized PAMAA copolymers in Na form, after monomer removal. The mass fraction of acrylamide units in the in-house synthesized PAMAA copolymers (acid form) was in a range of about 60.6 to about 95.45 wt. % (Table 1). The copolymer with the lowest mass fraction of acrylamide units (mass fraction of 60.6 wt. %, copolymer sample 2VK 73) exhibited a T_{g} (Na form, no monomer removal) of 149 °C, and the copolymer with one of the higher mass fractions of acrylamide units (mass fraction of 94.1 wt. %, copolymer sample 2VK 80-1) exhibited a T_{g} (Na form, no monomer removal) of 140 °C. On the other hand, copolymer sample 2VK 72, which has a mass fraction of acrylamide units of 73 wt. %, exhibited the highest T_{g} (Na form, no monomer removal) of 162 °C. Copolymer sample 2VK 80-3, which has a mass fraction of acrylamide units of 93.6 wt. %, exhibited the lowest T_{g} (Na form, no monomer removal) of 128 °C.

The monomer removal process may affect the T_{g} of PAMAA copolymers in neutralized form. Among the PAMAA copolymers for which T_{g} data are available in Table 3, the monomer removal affects T_{g} in a range of −12 to +7 °C (here, a negative number means that the T_{g} decreases upon monomer removal). In the examples shown, the effect of monomer removal on the T_{g} is quite small. Accordingly, unless indicated otherwise, the T_{g} of PAMAA copolymers will be reported without any monomer removal process. In some implementations, synthetic process 200 affords copolymers (in neutralized form (Na form), upon completion of 212) of glass transition temperatures in a range of about 100 to about 180 °C (e.g., about 100-170 °C, about 100-120 °C, about 120-140 °C, about 140-170 °C, about 120-170 °C, about 120-150 °C, or about 120-180 °C). The inventors have unexpectedly found that when the mass fraction of the acrylamide in a PAMAA copolymer in neutralized form, excluding any sodium, potassium, or calcium, is at least about 45 wt. % (e.g., about 45-95 wt. %, about 50-95 wt. %, or about 60-95 wt. %), the copolymer exhibits a glass transition temperature of over about 100 °C (e.g., about 100-170 °C, about 120-170 °C, or about 120-180 °C), in some implementations. This phenomenon of relatively high T_{g} was observed even when the copolymer comprises a monomer unit that is ordinarily used for synthesizing low-T_{g} polymers. For example, poly(butyl acrylate) exhibits a T_{g} in a range of about −30 to −50 °C. However, the incorporation of butyl (meth)acrylate (BMA) does not have a significant effect on the T_{g} of the PAMAA copolymers in the examples shown (e.g., 2VK 73, 2VK 94-1, 2VK 94-2, 2VK 94-3, 2VK 94-4 incorporate BMA).

Table 3 reports data of the swelling of the PAMAA copolymers in neutralized form (Na salt form), upon completion of 212, before and after monomer removal. The swelling is reported as a fraction (percentage) of the original mass (dry mass) of the polymer sample. In a typical procedure, 0.1-0.2 g of dry polymer samples were immersed into diethyl carbonate (DEC) and left for two days. Next, samples were recovered, wiped dry with disposable wipes (ChemWipe), and weighed. The difference between dry and swollen polymer's weight was used to determine the solvent uptake. The observed swelling is quite small, in a range of about 0 to about 0.26 wt. %, and the differences between the pre-monomer removal and post-monomer removal samples are also quite small. The inventors have unexpectedly found that when the mass fraction of the acrylamide in a PAMAA copolymer in neutralized form, excluding any sodium, potassium, or calcium, is at least about 45 wt. % (e.g., about 45-95 wt. %, about 50-95 wt. %, or about 60-95 wt. %), the copolymer exhibits low swelling in a diethyl carbonate (DEC) under the testing conditions as described herein. In some implementations, the swelling is in a range of about 0 to about 1 wt. % (e.g., about 0 to about 0.1 wt. %, about 0 to about 0.2 wt. %, or about 0 to about 0.4 wt. %). This phenomenon of low swell in DEC is observed even when the copolymer comprises a monomer unit that is ordinarily used for synthesizing polymers that dissolve in DEC. For example, poly(methyl methacrylate) dissolves in DEC. However, the incorporation of (meth)acrylates does not have a significant effect on the swell of the PAMAA copolymers in the examples shown.

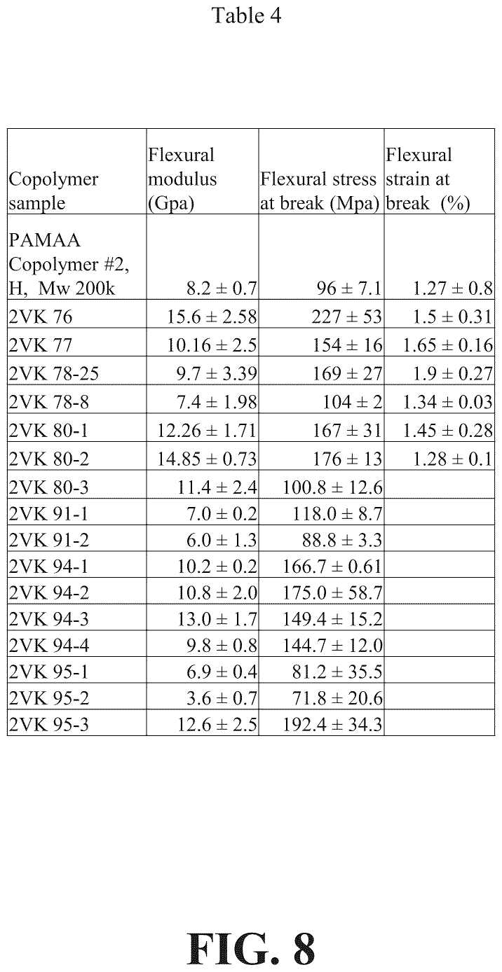

Table 4 of FIG. 8 shows flexural modulus, flexural stress at break, and flexural strain at break data of some example PAMAA copolymers (commercially available PAMAA copolymer #2, and in-house synthesized PAMAA copolymers). Mechanical testing was performed employing a 3-point flexural test method per the ASTM D₇₉₀ standard test method. Flexural testing was conducted on an Instron Model 5582 using a 10 kN load cell at a 1 mm/min strain rate. At least three samples were tested for each material. The samples for the mechanical testing were prepared by the solvent casting process. A degassed polymer solution in water (4-20 wt. % solution) was cast into a polystyrene mold and dried initially at 45 °C to solidify the sample. Then, the temperature was increased to 80 °C, and the sample was dried until constant mass was attained. The samples for the 3-point flexural test were cut using a laser cutter. The dimensions of the samples were measured using a micrometer. Typical dimensions of the samples: depth of beam (thickness) is 0.3-0.9 mm; width of beam is 7-10 mm; support span is about 20 mm. The following equations were used to report the results of the testing. The ASTM D790 standard was used to calculate the flexural modulus (modulus of elasticity in bending) E_{B}, the flexural stress at break (stress in the outer fibers at midpoint) σ_{f}, and the flexural strain at break (strain at the outer surface) ε_{f}. The modulus of elasticity in bending E_{B} is calculated as follows:

$${E}_{B} = \frac{{L}^{3} m}{4 b {d}^{3}}$$

wherein E_{B} is the modulus of elasticity in bending (MPa), L is the support span (mm), b is the width of the beam tested (mm), d is the depth of the beam tested, and m is the slope of the tangent to the initial straight-line portion of the load-deflection curve, N/mm of deflection. The stress in the outer fibers at midpoint σ_{f} is calculated as follows:

$${σ}_{f} = \frac{3 PL}{2 b {d}^{3}}$$

wherein σ_{f} is the stress in the outer fibers at midpoint (MPa), P is the load at a given point on the load-deflection curve (N), L is the support span (mm), b is the width of the beam tested (mm), and d is the depth of the beam tested. The strain in the outer surface ε_{f} is calculated as follows:

$${ε}_{f} = \frac{6 D d}{{L}^{2}}$$

wherein ε_{f} is the strain in the outer surface (mm/mm), D is the maximum deflection of the center of the beam (mm), L is the support span (mm), and d is the depth of the beam tested.

The inventors have unexpectedly found that the example in-house synthesized PAMAA copolymers exhibited relatively high values of flexural modulus and flexural stress at break. The in-house synthesized PAMAA copolymers exhibited flexural moduli in a range of about 3.6 to about 15.6 GPa (average about 10.1 GPa), flexural stress at break in a range of about 71.8 to about 227 MPa (average about 142.9 MPa), and flexural strain at break in a range of about 1.28 to about 1.9% (average about 1.52%). Each of these average values is higher than the respective corresponding value measured for the commercially available PAMAA copolymer #2 (flexural modulus 8.2 GPa, flexural stress at break 96 MPa, flexural strain at break 1.27%). The inventors have unexpectedly found that when the mass fraction of the acrylamide in a PAMAA copolymer in neutralized form, excluding any sodium, potassium, or calcium, is at least about 45 wt. % (e.g., about 45-95 wt. %, about 50-95 wt. %, or about 60-95 wt. %), the copolymer exhibits relatively high values of flexural modulus and flexural stress at break. In some implementations, the flexural modulus is in a range of about 3 to about 20 GPa (e.g., about 3-7 GPa, about 7-9 GPa, about 9-16 GPa, about 16-20 GPa, about 3-16 GPa, about 7-16 GPa, about 3-12 GPa, about 7-12 GPa, about 12-16 GPa, or about 9-12 GPa). In some implementations, the flexural stress at break is in a range of about 70 to about 300 MPa (e.g., about 70-90 MPa, about 90-230 MPa, about 230-300 MPa, about 90-100 MPa, about 100-230 GPa, about 100-150 MPa, or about 150-230 MPa). In some implementations, the copolymers exhibit a flexural strain at break in a range of about 0.4 to about 2.2% (e.g., in a range of about 0.4-1.2%, about 1.2-1.9%, or about 1.9-2.2%).

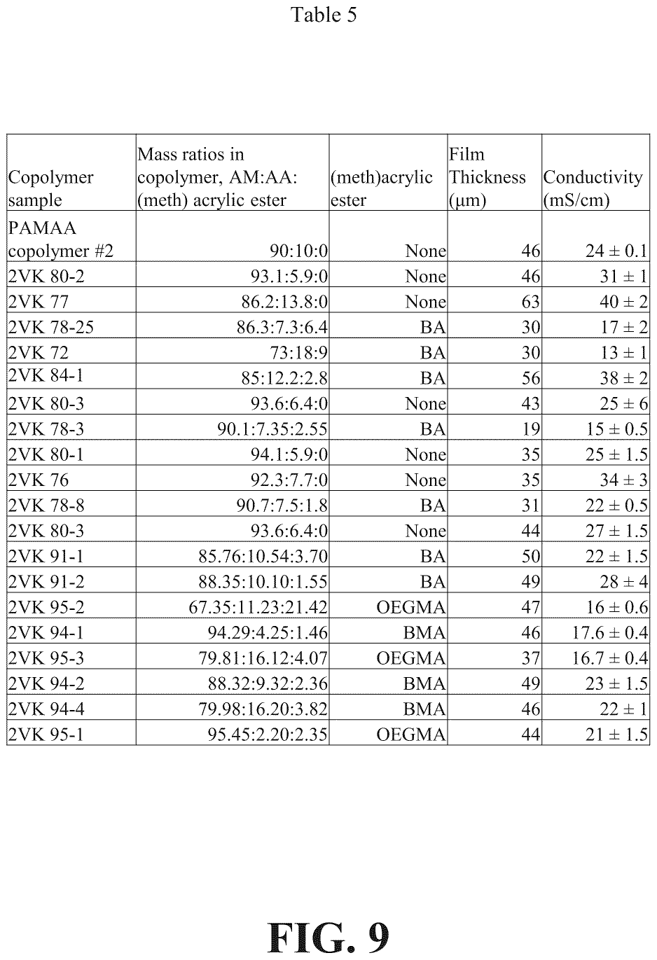

Table 5 of FIG. 9 (Table 5) shows out-of-plane electrical conductivity data of coatings of example PAMAA copolymers (Na form). To prepare the samples shown, the slurries were made using 6.5 wt. % copolymers as binders, 0.1 wt. % conductive additive, 46.7 wt. % silicon-carbon nanocomposite material, and 46.7 wt. % graphite. The slurries were then cast on a Cu foil and dried in a vacuum oven for 1 h. For these measurements, rectangular-shaped copper foil pieces with one rounded end were cut with scissors, firmly attached to cardboard pieces (25 mm×25 mm) with a double-sided tape and compressed in face-to-face orientation to form a sandwich structure with a circular overlapping area between the two copper electrodes. The sandwich structure was additionally fixed with two glass slides from both sides and paper clips to apply pressure to ensure good electrical contact between the polymer surfaces. The current-voltage (I-V) curves were obtained using a WaveDriver 20 Bipotentiostat/Galvanostat system using a two-electrode setup (typically, a scanning rate of 20 mV/s in a range −0.2 V to +0.2 V). The conductivity a of the samples, expressed in S/cm, was then calculated using a formula:

$$σ = \frac{4 Il}{π {D}^{2}}$$

where I is a current under an applied voltage V, l is double the thickness t of the electrode film, and D is the diameter of the circular overlapping area of the two electrodes. The thickness, t, was measured using a micrometer.

Coatings of the respective PAMAA copolymers (in Na form) on a copper foil substrate were formed. The thicknesses of the coatings are reported in Table 5. Coating thicknesses ranged between 30 and 63 μm. Two samples were punched out from the polymer-coated copper substrate and were assembled in a measurement apparatus with the coatings overlapping each other and directly contacting each other (the area of overlap and direct contact is set as area A). A voltage (V) was applied between the two copper current collector foils and the resulting current (I) was measured. The out-of-plane conductivity a was calculated as σ=Id/AV wherein d is the distance between the two copper current collector foils, approximately twice the coating thickness. The out-of-plane electrical conductivity of the in-house synthesized PAMAA copolymers was in a range of 13 to 40 mS/cm. This range is similar to the out-of-plane electrical conductivity of the commercially available PAMAA copolymer #2 which was 24 mS/cm.

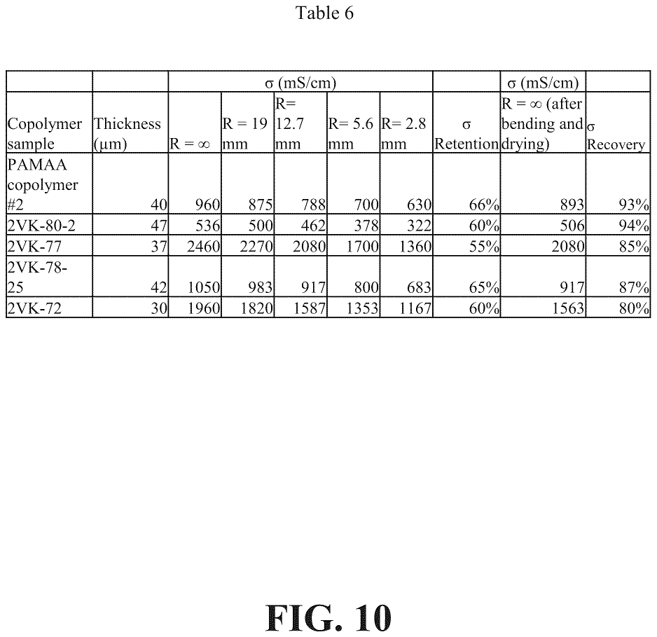

Table 6 of FIG. 10 (Table 6) shows a dependence of the electrical conductivity of electrodes comprising (1) anode active material comprising a mixture of Si—C nanocomposite particles and graphite particles, (2) conductive carbon nanotube additive (0.1 wt. % in the electrode), and (3) binder (6.47 wt. % in the electrode). The amount of anode active material (Si—C composite particles and graphite particles) in the electrode was about 93.43 wt. %. The Si—C nanocomposite particles (with specific capacity of around 1600 mAh/g and mass average size of 6-7 μm) and graphite particles were present in the electrode at 50:50 weight ratio. Respective electrodes were fabricated using PAMAA copolymers (in their Na salt form) listed in Table 6, and the conductivity data were collected for different bending radii under bending deformation conditions. For these measurements, in the case of conductivity under bending deformation experiments, the anode material was deposited on a non-conductive flexible support (polyethylene terephthalate (PET) transparency sheets, 100 μm thick). Prior to the deposition, the substrate was washed with acetone and ethanol and then activated in air plasma for 30 seconds to ensure good adhesion contact with the composite film. After drying in the oven at 70 °C for several hours, rectangular strips 10 mm×75 mm were cut with scissors and additionally dried in the oven for at least 3 hours at 70 °C. The copper foil was wrapped over the ends of such strips and fixed with paper clips to ensure good mechanical and electrical contact. The whole structure was sequentially wrapped over cylindrical objects with a known diameter changing sequentially from an unwrapped flat configuration (radius of curvature R=∞) to R=19 mm, R=12.7 mm, R=5.6 mm, and R=2.8 mm. The bend film was then connected to the Wave-Driver 20 Bipotentiostat/Galvanostat using alligator clips, and I-V curves were recorded using potential in the range of −0.5 V to 0.5 V with a scanning rate of 50 mV/s. Conductivity was calculated from the obtained current-voltage (I-V) curves using a formula:

$$σ = \frac{Il}{AU}$$

wherein I is current under an applied potential U, l is the distance between the alligator clips (typically about 7 cm), t is the thickness of the polymer film, and A is the cross-sectional area of the polymer film (conductive film) (A is the product of the width of the strip of polymer film multiplied by the thickness of the polymer film).

The thicknesses of the coatings are reported in Table 6, which ranged between 30 and 47 μm. The conductivity as measured at R=2.8 mm, divided by the conductivity as measured at R=∞ (flat condition), is reported under the column labeled a retention (conductivity retention). Subsequently, each sample was dried in an oven for 3 hours at 70 °C and the conductivity was measured again at R=∞ (flat condition). The conductivity results are reported under the column labeled R=∞ (after bending and drying). The conductivity as measured at R=∞ (after bending and drying), divided by the conductivity as measured initially at R=∞, is reported under the column labeled a recovery (conductivity recovery). In some applications of PAMAA copolymers, it may be preferable for the conductivity, the retention, and the recovery to be high.

In some implementations, stable slurry formulations may be obtained when PAMAA copolymers are employed as a binder polymer, in which the PAMAA copolymer has a high acrylamide content. In some examples, a “high acrylamide content” refers to a mass fraction of the acrylamide (units) in the copolymer (in acid form) in a range of about 45 to about 95 wt. % (e.g., about 45-50 wt. %, about 50-60 wt. %, about 60-70 wt. %, about 70-80 wt. %, about 50-95 wt. %, about 60-95 wt. %, about 70-95 wt. %, or about 80-95 wt. %). In some examples, a “high acrylamide content” refers to a mass fraction of the acrylamide (units) in the copolymer in neutralized form, excluding any sodium, potassium, or calcium, in a range of about 45 to about 95 wt. % (e.g., about 45-50 wt. %, about 50-60 wt. %, about 60-70 wt. %, about 70-80 wt. %, about 50-95 wt. %, about 60-95 wt. %, about 70-95 wt. %, or about 80-95 wt. %). In some implementations, stable slurry formulations may not be obtained when the PAMAA copolymer has an acrylamide content that is not high enough (e.g., less than “high acrylamide content”). Unstable slurry formulations may be observed when the copolymer comprises a Na salt of a (meth)acrylic acid unit, which exhibits a large water absorption. In some implementations, dispersibility of a PAMAA copolymer in solution is affected by the mass fraction of the respective monomer units. For example, a mass fraction of butyl (meth)acrylate units greater than about 7 wt. % in the PAMAA copolymer, excluding any Na, K, or Ca, may result in (1) agglomeration of conductive additives, (2) agglomeration of active material particles, or (3) insufficient deagglomeration of active material particles, in some examples. Accordingly, in some implementations, the mass fraction of butyl (meth)acrylate (or a (meth)acrylic ester) in the PAMAA copolymer, excluding any Na, K, or Ca, may be in a range of about 1 to about 7 wt. % (e.g. about 1-3 wt. %, about 1-5 wt. %, or about 1-7 wt. %). Furthermore, a mass fraction of butyl (meth)acrylate (or a (meth)acrylic ester) in the polymerizable composition may be selected so that the mass fraction of butyl (meth)acrylate (or (meth)acrylic ester) in the copolymer would be in the range of about 1 to about 7 wt. %. In some implementations, a mass fraction of the butyl (meth)acrylate (or (meth)acrylic ester) in the polymerizable composition is in a range of about 1 to about 20 wt. %. (e.g., about 1-3 wt. %, about 1-5 wt. %, about 1-7 wt. %, about 1-10 wt. %, or about 10-20 wt. %, about 2-5 wt. %, or about 5-10 wt. %).

In some examples described herein, for formulating a slurry for an electrode coating, a so-called “dough” or “hardmix” phase is first prepared by mixing a binder solution (e.g., PAMAA copolymer solution) and the active particles, that is, graphite and Si—C nanocomposite particles. The total amount of solids for each of the dough phases may vary for each case and is also dependent on the viscosity of the binder. This “hardmix” solids mass fraction is experimentally determined and qualitatively ensures that each of the dough phases is well dispersed by the binder solution, wherein the resulting dough is preferably not too fluid-like and not too dry (e.g., preferably a viscosity in a range of about 1000 to about 10000 cP at 10 s⁻¹ shear rate). After optimizing the “dough” phase, additional binder may be added according to the desired anode formulation, and water may be added to the slurry at the last stage to adjust the final viscosity. Depending on its physical state, a conductive additive may be added at the “hardmix” phase or at later stages of the slurry making process. For example, a pre-dispersed conductive additive may be added during the dough phase or at the final stage of the slurry making prior to its dilution with water. On the other hand, a dry powder of conductive additive may be added at earlier stages, e.g., before the dough phase to prepare a pre-mix with a binder or during the dough phase together with active particles. In some designs, the final slurry viscosity (after mixing of all components and before casting on a current collector) may preferably be in a range of about 2000 to about 6000 cP at a shear rate of 10 sec⁻¹. The final slurry viscosity is correlated to the viscosity of the binder polymer (e.g., PAMAA copolymer) in solution. Accordingly, in some designs, if the polymer viscosity is too high, it may be necessary to lower the total solids content in the slurry solvent, which may not be desired in some applications, as coating yield will be low due to the presence of a large amount of solvent. In some implementations, it may be preferable to employ a mixture of a lower-viscosity polymer (e.g., a first PAMAA copolymer) and a higher-viscosity polymer (e.g., a second PAMAA copolymer) as binder components in a slurry formulation. For example, the dough phase can be prepared with a PAMAA binder solution with a viscosity in a range of about 100 to about 500 cP at 25 °C (for 1 wt. % aqueous solution of binder), while total (sufficiently high) slurry viscosity in the above specified range may be ensured by a highly viscous PAMAA binder solution (in a range of about 600 to about 4000 cP at 25 °C for 1 wt. % binder solutions). In some implementations, a lower-viscosity polymer may be beneficially used in a slurry kneading process (also referred to as a hardmix kneading process), which includes mixing the electrode powder (e.g., electrode active materials) and the binder. However, a slurry comprising a lower-viscosity polymer as a binder may exhibit settling of solids in the slurry. A higher-viscosity polymer may be used to maintain the stability of the slurry. Accordingly, a mixed polymer binder comprising a lower-viscosity polymer and a higher-viscosity polymer may be used to enhance mixing during the kneading process and enhance stability of the slurry. In some designs, if PAMAA copolymers are used for the lower-viscosity and higher-viscosity polymers, the polymers comprise similar functional groups and do not exhibit a tendency to phase separate over time. The phase separation is a problem that is commonly observed in carboxymethyl cellulose (CMC): styrene-butadiene rubber (SBR) binders. A first implementation of a mixed binder process may be as follows. A lower-viscosity PAMAA copolymer (e.g., in neutralized form, in a 1 wt. % solution in water, exhibiting a kinematic viscosity in a range of 5 to 50 cSt at 25 °C) and a higher-viscosity PAMAA copolymer (e.g., in neutralized form, in a 1 wt. % solution in water, exhibiting a kinematic viscosity in a range of 50 to 150 cSt or 50 to 300 cSt or 50 to 450 cSt at 25 °C) are employed. Firstly, a dough is formed by kneading the lower-viscosity PAMAA copolymer (e.g., in neutralized form, in a suitable first solution) and the electrode materials (e.g., composite particles such as Si—C composite particles, conductive additives, other additives). Secondly, a slurry is formed by mixing dough and the higher-viscosity PAMAA copolymer (e.g., in neutralized form, in a suitable second solution). A second implementation of a mixed binder process may also employ a lower-viscosity PAMAA copolymer and a higher-viscosity PAMAA copolymer. A second implementation of a mixed binder process may be as follows. Firstly, a dough is formed by kneading the higher-viscosity PAMAA copolymer (e.g., in neutralized form, in a suitable first solution) and the electrode materials (e.g., composite particles such as Si—C composite particles, conductive additives, other additives). Secondly, a slurry is formed by mixing dough and the lower-viscosity PAMAA copolymer (e.g., in neutralized form, in a suitable second solution). In both implementations, an electrode coating is formed by casting the slurry onto a substrate (e.g., a current collector). The lower-viscosity PAMAA copolymer and the higher-viscosity PAMAA copolymer are preferably present in the electrode coating in a mixed state.

In some examples described here, the electrode slurries were prepared in a Thinky mixer by mixing binder solutions, active materials (Si—C nanocomposite particles and graphite particles) and conductive additive in aqueous medium. Appropriate measures were taken such that the graphite and Si—C nanocomposites were well dispersed and dilutions with water were performed to ensure appropriate viscosity (e.g., in a range of about 2000 to about 6000 cP at a shear rate of 10 sec⁻¹). The slurries were found to be stable without exhibiting flocculation or settling. The dispersibility of active materials were checked by measuring particle sizes which exhibited a particle size lower than 25 μm. The settling was gauged by checking flow sweep rheometry, which exhibited identical viscosity at different shear rates. The slurries can be cast on a variety of Cu foils using a doctor blade. Standard coating conditions could be used with these slurries. The wet coatings thus generated are uniform without any severe cavity or agglomerates. The coatings were dried at temperatures below about 110 °C (e.g., in a range of about 70 to about 100 °C, or about 70 to about 110 °C). The dry coatings were uniform (thickness variation of < about 2-5% from coating map imaging or < about 2-5% mass variations of different punches taken from different positions of the dried coatings). Furthermore, the coating density maps revealed uniformity with thickness deviations in the range of ± about 4 μm. The resulting electrode coatings were flexible and can be calendered to a desired press density (e.g., in a range of about 1.2 to about 1.8 g/cc) by either press or roll calendering. In some designs, the calendering process further improves the uniformity and does not cause either graphite or Si—C nanocomposite particles to crack. The calendered electrodes are next used as electrodes of battery test cells.

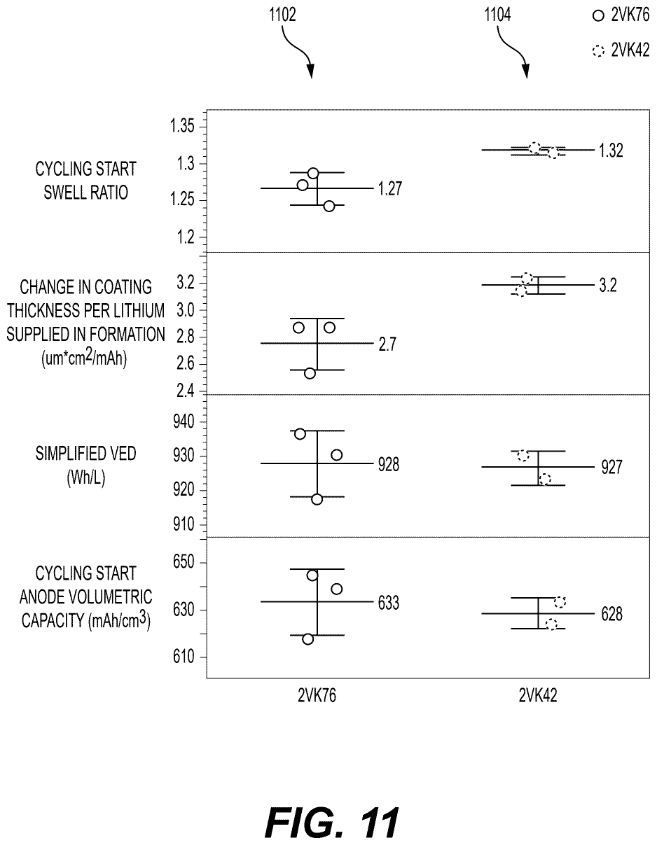

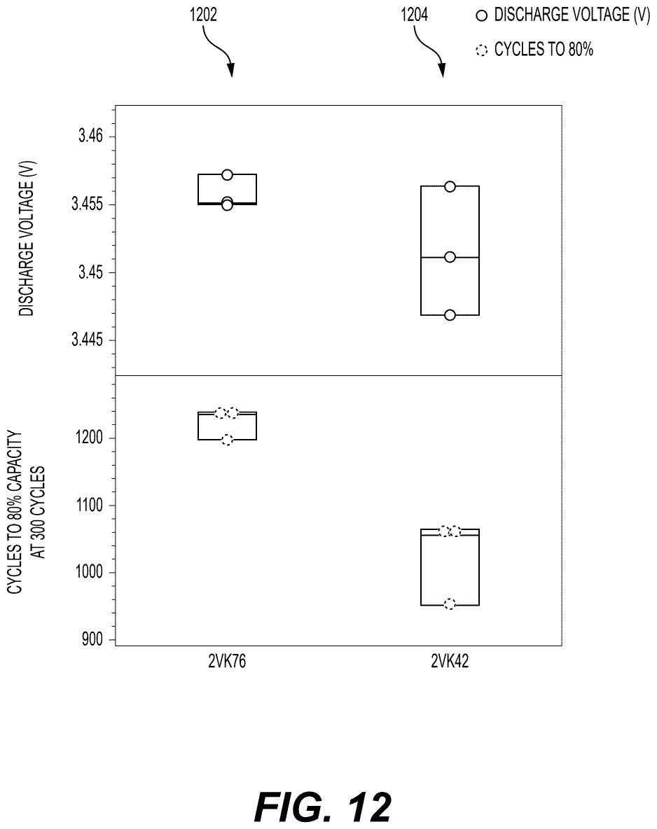

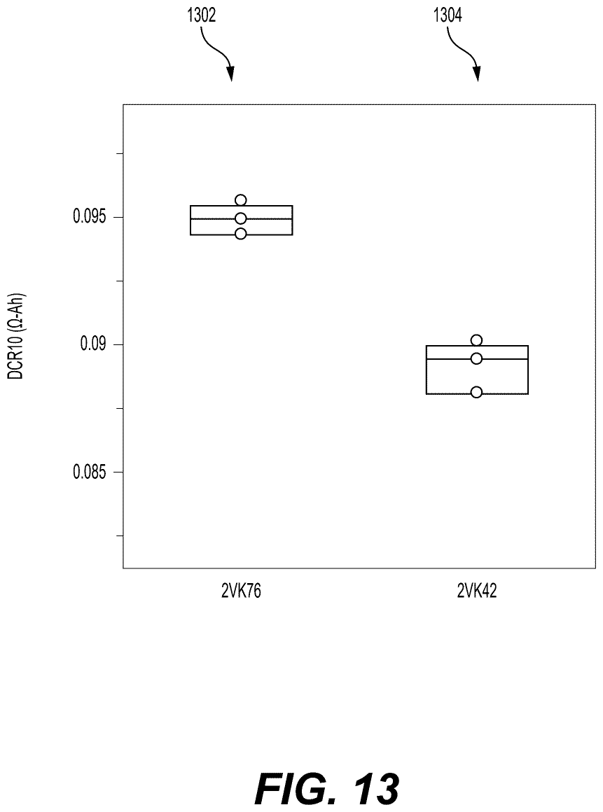

Test cells were fabricated for the battery test results reported herein. For the results reported in FIGS. 11, 12, and 13, Si—C nanocomposite particles (with specific reversible capacity of about 1600 mAh/g to about 2100 mAh/g, normalized by the weight of the respective Si—C nanocomposite particles) were employed in the anode coating. The anode coating was formed by casting an aqueous suspension (slurry) comprising active material particles (e.g., Si—C nanocomposite active material particles, graphite particles), a respective binder composition or binder mixture, and respective conductive additives (single-walled carbon nanotubes (SWCNT) or carbon black) on a Cu current collector foil. The binder composition or binder mixture was selected from the following: (1) PAMAA copolymers of different compositions (i.e., different ratios of acrylic acid Na salt, acrylamide and an optional softening unit comprising butyl acrylate or butyl methacrylate or OEGMA-type (meth)acrylate or combination thereof); (2) a mixture of above PAMAA copolymers with different viscosities. In the test cell results reported in FIG. 11, FIG. 12, and FIG. 13, a mixture of Si—C nanocomposite particles and graphite particles (the mixture contained about 50 wt. % of Si—C nanocomposite particles and about 50 wt. % of graphite particles) was the active material in the anode coating. In the examples herein (FIGS. 11, 12, 13, 14, and 15), carbon-containing nanocomposite particles containing silicon nanoparticles were used as the Si-based nanocomposite active material. In the test cell examples reported herein, the anode coating comprised the binder composition (e.g., one particular PAMAA copolymer of certain viscosity or combination of different PAMAA copolymers of different viscosities) at a mass fraction in a range of about 5.0 to about 8.0 wt. %. In the test cell examples reported in FIGS. 11, 12, and 13 (in which the anode active material comprised a mixture of about 50 wt. % of Si—C nanocomposite particles and about 50 wt. % of graphite particles), the anode coating comprised conductive additives (e.g., carbon black, SWCNT) at a mass fraction of less than about 0.1 wt. %. In these test cells for the examples in FIGS. 11, 12, and 13, the areal capacity loading of the anode was about 5.40 mAh/cm². In the examples shown, the anode coating comprises anode active material, binder composition or binder mixture, and conductive additives.

For the test cells reported in FIGS. 11, 12, and 13, the cathode coating included high-voltage NMC811 (with an approximate composition of LiNi_{0.8}Co_{0.1}Mn_{0.1}O₂) active material (with specific reversible capacity of ~200 mAh/g when normalized by the weight of active materials in the cathode) cast on Al current collector foil from an organic solvent suspension including a polyvinylidene fluoride (PVDF)-based binder and a carbon black conductive additive. The anode:cathode areal capacity ratio (N:P ratio) was in a range of about 1.05:1 to about 1.14:1 and the charge voltage was about 4.2 V. A polymer-ceramic separator was interposed between the anode coating and the cathode coating. An electrolyte was infiltrated in between the anode coating and the cathode coating. In the test cell examples shown in FIGS. 11, 12, and 13 (in which the anode active material comprised a mixture of about 50 wt. % of Si—C nanocomposite particles and about 50 wt. % of graphite particles), an electrolyte of the following approximate composition was used: 13.92 wt. % LiPF₆, 13.33 wt. % FEC (fluoroethylene carbonate, a fluorinated cyclic carbonate), 5.04 wt. % EC (ethylene carbonate, a cyclic carbonate), 3.85 wt. % EMC (ethyl methyl carbonate, a linear carbonate), 62.49 wt. % DMC (dimethyl carbonate, a linear carbonate), 0.52 wt. % VC (vinylene carbonate, a cyclic carbonate), and 0.85 wt. % LFO (lithium difluorophosphate or LiDFP, as another lithium salt additive). In the test cell examples reported in FIGS. 11, 12, and 13, the median cathode thickness was about 75 μm, and the median cathode loading was about 23 mg/cm². In the test cell examples of FIGS. 11, 12, and 13 (in which the anode active material comprised a mixture of about 50 wt. % of Si—C nanocomposite particles and about 50 wt. % of graphite particles), the median anode loading was about 6.0 mg/cm², and the anode coating thickness was in a range of about 40 to 60 μm.

FIG. 11 shows selected performance data of lithium-ion battery test cells comprising respective PAMAA copolymers: the left column 1102 shows data for test cells comprising 2VK 76 (copolymer with acrylamide, acrylate) (in Na salt form), and the right column 1104 shows data for test cells comprising 2VK 42 (copolymer with acrylamide, acrylate, OEGMA 950) (in Na salt form). The performance data shown in FIG. 11 are: (1) cycling start swell ratio (unitless), (2) normalized coating thickness change (sometimes abbreviated as Δt/Li) (μm·cm²/mAh), (3) simplified volumetric energy density (VED) (Wh/L), and (4) cycling start anode volumetric charge capacity (VQD) (mAh/cm³). The cycling start swell ratio is defined as an average thickness of a lithiated electrode at cycling start (e.g., at cycle 3, upon completion of the formation cycling), divided by an average thickness of the processed electrode before it is soaked in an electrolyte. In the example shown, the normalized coating thickness change is also referred to as a change in coating thickness per quantity of lithium supplied in formation. The normalized coating thickness change is defined as the coating thickness change (expressed in μm), divided by the quantity of lithium ions per unit area of electrode inserted into the electrode (anode) in going from the discharged state to the charged state (expressed in mAh/cm²) during the so-called “formation” cycle. The coating thickness is measured, using a high-accuracy digital contact sensor (with approximately 0.1 μm resolution), on test cells. The normalized coating thickness change may be regarded as a quantitative measurement of the degree of swell of an electrode coating, particularly the degree of swell in the thickness direction. The volumetric energy density (abbreviated as VED) is defined as the cell energy (at cycling start, e.g., at cycle 3, after formation cycles) (expressed in Wh) divided by the cell's external volume (expressed in liters (L)). Simplified VED does not account for lateral expansion distributed in the XY plane (and therefore overestimates actual VED) and assumes zero or constant XY expansion across different electrode compositions to allow for swell comparison. In some cases, it may be convenient to use a simplified VED to project the actual VED. To calculate the simplified VED, the energy per unit area of the battery is first obtained. Then, the energy per unit area of the battery is divided by the sum of the thicknesses of the anode, cathode, separator, and current collectors. Any changes to the simplified VED values may be assessed by measuring changes to the thicknesses of any of these components; however, as mentioned above, the caveat is that the simplified VED is not sensitive to subsequent changes to the energy per unit area, resulting from lateral expansion and/or contraction of the electrode. The cycling start anode volumetric capacity is defined as the volumetric capacity of the anode (excluding any current collector) at cycling start (e.g., at cycle 3, after formation cycling). In the examples shown, the cycling start swell ratios were quite small, in a range of about 1.24 to about 1.33. Such relatively low swell ratios show that these PAMAA copolymers may be used effectively as binder polymers in anode electrodes comprising Si—C composite particles and graphite particles. The normalized coating thickness change is greater in lithium-ion battery test cells comprising 2VK 42 (about 3.2 μm·cm²/mAh) than in lithium-ion battery test cells comprising 2VK 76 (about 2.7 μm·cm²/mAh), suggesting that additional “soft” unit incorporation (in this example an OEGMA-type unit) leads to greater thickness changes. Both types of test cells exhibited relatively high simplified VEDs (simplified VEDs in a range of about 920 to about 940 Wh/liter) and relatively high volumetric capacities (cycling start anode volumetric capacities in a range of about 620 to about 650 mAh/cm³).

FIG. 12 shows selected performance data of lithium-ion battery test cells comprising respective PAMAA copolymers: the left column 1202 shows data for test cells comprising 2VK 76 (in Na salt form), and the right column 1204 shows data for test cells comprising 2VK 42 (in Na salt form). The performance data shown in FIG. 12 are: (1) discharge voltage, and (2) number of cycles to reach 80% of cycling start capacity, as estimated at 300 cycles. An average discharge voltage of a battery cell is defined as the discharge energy (Wh) divided by discharge capacity (Ah). The estimated number of cycles to reach 80% of cycling start capacity is also referred to as N80. N80 is a convenient metric of the cycle life of a battery cell. In the example shown, N80 is obtained by estimating at cycle 300, the number of cycles to reach 80% of cycling start capacity (during cycling at 25 °C). The cycling start capacity is defined as the capacity at cycling start (e.g., at cycle 3, after formation cycles up to cycles 2). In the examples shown, the lithium-ion battery test cells exhibited relatively high discharge voltages (e.g., in a range of about 3.445 to about 3.460 V) and relatively high N80 values (e.g. in a range of about 950 to about 1070 cycles for the lithium-ion battery test cells comprising 2VK 42 and in a range of about 1180 to about 1250 cycles for the lithium-ion battery test cells comprising 2VK 76).

FIG. 13 shows selected DC resistance (DCR) data (labeled as “DCR10” in FIG. 13) of lithium-ion battery cells comprising respective PAMAA copolymers: the left column 1302 shows data for test cells comprising 2VK 76 (in Na salt form), and the right column 1304 shows data for test cells comprising 2VK 42 (in Na salt form). DCR is determined as follows: A series of high-rate current pulses are applied to the cell at a predetermined state-of-charge (e.g., 10% state-of-charge, 50% state-of-charge, etc.), and the resulting voltages are measured. An average voltage is determined by averaging over the respective voltages that are measured for each of the current pulses. The DCR is the average voltage divided by the normalized applied current. The DCR is typically normalized to allow for a comparison that eliminates factors such as cell size, capacity, or energy. In the example shown, the DCR is normalized by capacity of the cell. When DCR is normalized by capacity, it is expressed in Ω·Ah. The normalized applied current is expressed as the applied current (expressed in A) divided by the cell's capacity (the capacity is expressed in Ah). The internal direct-current (DC) resistance of a cell is sometimes referred to as DC resistance or DCR. In the examples shown in FIG. 13, DCR was measured at a state-of-charge of 50% at a discharge rate of 2.3C for 30 sec of total pulse time. In the examples shown, the lithium-ion battery test cells exhibited relatively low DCR values of less than about 0.100 Ω·Ah (e.g., in a range of about 0.093 to about 0.098 Ω·Ah for the lithium-ion battery test cells comprising 2VK 76 and in a range of about 0.087 to about 0.091 Ω·Ah for the lithium-ion battery test cells comprising 2VK 42). In some designs, there is a tendency of higher DCR values when the lithium-ion battery cells employ PAMAA copolymers comprising more than about 7 wt. % of butyl (meth)acrylate as an anode binder. The increase in DCR for PAMAA copolymers with > about 7 wt. % of butyl (meth)acrylate can be about 5-about 10% higher compared to a PAMAA copolymer that has no butyl (meth)acrylate or less than about 7 wt. % butyl (meth)acrylate. In an aspect, this increase in DCR when more than about 7 wt. % of butyl (meth)acrylate group is present in the copolymer composition may be due to agglomeration tendency of conductive additives in the electrodes in such polymer formulations under the experimental conditions. In an aspect, by changing the formulations (e.g., adding stabilizer such as carboxymethyl cellulose) or mixing procedures (longer mixing time, gentle mixing), such agglomeration tendencies can be avoided, and a more homogenous electrode can be produced that can mitigate increase in DCR values due to high (i.e., higher than about 7 wt. %) butyl acrylate group incorporation in the copolymer composition.

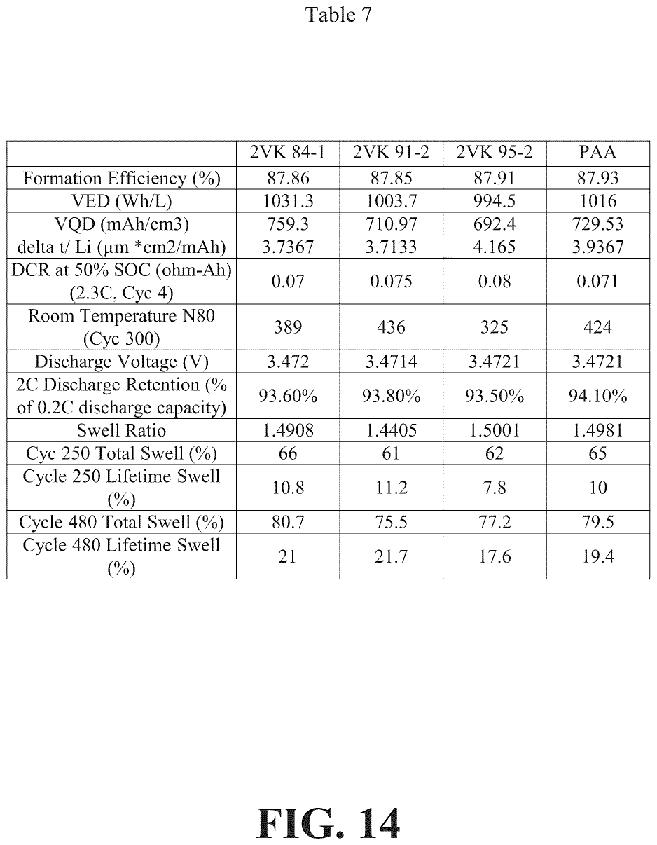

Test cells were fabricated for the battery test results reported in Table 7 (FIG. 14). Si—C nanocomposite particles (with specific reversible capacity of about 1600 mAh/g to about 2100 mAh/g, normalized by the weight of the respective Si—C nanocomposite particles) were employed in the anode coating. The anode coating was formed by processes outlined above with respect to FIGS. 11, 12, and 13. In the test cell results reported in Table 7 (FIG. 14), a mixture of Si—C nanocomposite particles and graphite particles (the mixture contained about 50 wt. % of Si—C nanocomposite particles and about 50 wt. % of graphite particles) was the active material in the anode coating. In the test cell examples reported in Table 7, the anode coating comprised the binder composition (e.g., one particular PAMAA copolymer of a certain viscosity or combination of different PAMAA copolymers of different viscosities) at a mass fraction in a range of about 5.0 to about 8.0 wt. %. In the test cell examples of Table 7 (in which the anode active material comprised a mixture of about 50 wt. % of Si—C nanocomposite particles and about 50 wt. % of graphite particles), the anode coating comprised conductive additives (e.g., carbon black, SWCNT) at a mass fraction of less than about 0.1 wt. %. In these test cells for the examples in Table 7, the areal capacity loading of the anode was about 5.45 mAh/cm². In the examples shown, the anode coating comprises anode active material, binder composition or binder mixture, and conductive additives.

For the test cells reported in Table 7, the cathode coating included high-voltage NMC811 (with an approximate composition of LiNi_{0.8}Co_{0.1}Mn_{0.1}O₂) active material (with specific reversible capacity of ~200 mAh/g when normalized by the weight of active materials in the cathode) cast on Al current collector foil from an organic solvent suspension including a polyvinylidene fluoride (PVDF)-based binder and a carbon black conductive additive. The anode:cathode areal capacity ratio (N:P ratio) was in a range of about 1.05:1 to about 1.14:1 and the charge voltage was about 4.2 V. A polymer-ceramic separator was interposed between the anode coating and the cathode coating. An electrolyte was infiltrated in between the anode coating, separator, and the cathode coating. In the test cell examples shown in Table 7 (in which the anode active material comprised a mixture of about 50 wt. % of Si—C nanocomposite particles and about 50 wt. % of graphite particles), the electrolyte that was employed for the examples of FIGS. 11, 12, and 13 was used. In the test cell examples reported in Table 7, the median cathode thickness was about 75 μm, and the median cathode loading was about 24.3 mg/cm². In the test cell examples of Table 7 (in which the anode active material comprised a mixture of about 50 wt. % of Si—C nanocomposite particles and about 50 wt. % of graphite particles), the median anode loading was about 6.0 mg/cm², and the anode coating thickness was in a range of about 40 to 60 μm.

Table 7 (FIG. 14) shows selected performance data of lithium-ion battery test cells comprising respective PAMAA copolymers: counting from the left, the first column shows data for test cells comprising 2VK 84-1 (copolymer comprising acrylamide, acrylate (acrylic acid, butyl acrylate)) (in Na salt form), the second column shows data for test cells comprising 2VK 91-2 (copolymer comprising acrylamide, acrylate (acrylic acid, butyl acrylate)) (in Na salt form), the third column shows data for test cells comprising 2VK 95-2 (copolymer comprising acrylamide, acrylate (acrylic acid), OEGMA 950) (in Na salt form), and the fourth column shows data for test cells comprising commercially available PAA (comparative example).

Table 7 shows formation efficiency data. Formation efficiency is defined as cycling start discharge capacity (discharge capacity upon completion of cycle 3) divided by the first cycle charge capacity. The test cells comprising example PAMAA copolymers generally exhibit high formation efficiencies in a range of about 87.85-87.91%, compared to the comparative example which exhibits a formation efficiency of 87.93%. A high formation efficiency indicates reduced losses during formation, which can maximize the reversible energy that can be extracted from a cell of this cell design.

Table 7 (FIG. 14) shows performance data relating to metrics of anode dimensional changes, including: (1) cycling start swell ratio (unitless), (2) normalized coating thickness change (sometimes abbreviated as Δt/Li) (μm·cm²/mAh), (3) simplified volumetric energy density (VED) (Wh/L), and (4) cycling start anode volumetric charge capacity (VQD) (mAh/cm³). These quantities have been defined above with respect to FIG. 11. In the examples shown in Table 7, the cycling start swell ratios were in a range of about 1.44 to about 1.5, comparable to the value of 1.498 for the control sample of commercially available PAA. Such relatively low swell ratios show that these PAMAA copolymers may be used effectively as binder polymers in anode electrodes comprising Si—C composite particles and graphite particles. The normalized coating thickness change is greater in lithium-ion battery test cells comprising 2VK 95-2 (about 4.165 μm·cm²/mAh) than in lithium-ion battery test cells comprising 2VK 84-1 (about 3.73 μm·cm²/mAh) and 2VK 91-2 (about 3.71 μm·cm²/mAh), suggesting that additional “soft” unit incorporation (in this example an OEGMA-type unit) leads to greater thickness changes. The test cells (Table 7) exhibited relatively high simplified VEDs (simplified VEDs in a range of about 990 to about 1040 Wh/liter) and relatively high volumetric capacities (cycling start anode volumetric capacities in a range of about 690 to about 760 mAh/cm³).

Table 7 (FIG. 14) shows discharge voltage data and data for the number of cycles to reach 80% of cycling start capacity (N80), as estimated at 300 cycles. An average discharge voltage of a battery cell is defined as the discharge energy (Wh) divided by discharge capacity (Ah). The estimated number of cycles to reach 80% of cycling start capacity is also referred to as N80. N80 is a convenient metric of the cycle life of a battery cell. In the example shown, N80 is obtained by estimating at cycle 300, the number of cycles to reach 80% of cycling start capacity (during cycling at 25 °C). The cycling start capacity is defined as the capacity at cycling start (e.g., at cycle 3, after formation cycles up to cycle 2). In the examples shown, the lithium-ion battery test cells exhibited relatively high discharge voltages (e.g., in a range of about 3.4714-3.4721 V, as compared to 3.4721 V for the comparative example comprising commercially available PAA) and N80 values (e.g. in a range of about 325 to about 436 cycles, as compared to 424 cycles for the comparative example).

Table 7 (FIG. 14) shows selected DC resistance (DCR) data of lithium-ion battery cells comprising respective PAMAA copolymers. DCR is determined as follows: A series of high-rate current pulses are applied to the cell at a predetermined state-of-charge (e.g., 10% state-of-charge, 50% state-of-charge, etc.), and the resulting voltages are measured. An average voltage is determined by averaging over the respective voltages that are measured for each of the current pulses. The DCR is the average voltage divided by the normalized applied current where the latter is expressed as the applied current (expressed in A) divided by the cell's capacity (the capacity is expressed in Ah). The DCR is typically normalized to allow for a comparison that eliminates factors such as cell size, capacity, or energy. In the example shown, the DCR is normalized by capacity of the cell. When DCR is normalized by capacity, it is expressed in Ω·Ah. The internal direct-current (DC) resistance of a cell is sometimes referred to as DC resistance or DCR. In the examples shown in Table 7 (FIG. 14), DCR was measured at a state-of-charge of 50% at a discharge rate of 2.3C for 30 sec of total pulse time. In the examples shown, the lithium-ion battery test cells exhibited relatively low DCR values of less than about 0.100 Ω·Ah (e.g., in a range of about 0.07-0.08 Ω·Ah for the lithium-ion battery test cells comprising 2VK 84-1, 2VK 91-2, and 2VK 95-2 copolymers, as compared to 0.071 Ω·Ah for the comparative example comprising commercially available PAA).

Table 7 shows z-swell data during cycling, which refers to the change in coating thickness in the z-direction (the z-direction is perpendicular to the plane of the electrode). Table 7 reports two types of z-swell parameters: lifetime swell and total swell. The z-swell metric “lifetime swell” is calculated by normalizing the coating thickness change of the anode in the charged state at the end of a given cycle (in the case of Table 7, at cycle 250 and cycle 480) from its corresponding value at charged state in cycle 3. “Total swell” is measured by normalizing the change in anode coating thickness in charged state for a given cycle (in the case of Table 7, at cycle 250 and cycle 480) to its value measured before cell assembly and before being subjected to any deliberate electrochemical testing/lithiation. The coating thickness is measured, using a high-accuracy digital contact sensor (with approximately 0.1 μm resolution), on test cells after undergoing over 250 and 480 charge/discharge cycles. The z-swell values for the example binders (PAMAA copolymers) are in a range of about 61-66% for total swell and in a range of about 7.8-11.2% lifetime swell, compared to comparative example values of 65% and 10%, respectively, at the 250th cycle. The z-swell values for the example binders (PAMAA copolymers) are in a range of about 75.5-80.7% total swell and in a range of about 17.6-21.7% lifetime swell, compared to comparative example values of 79.5% and 19.4%, respectively, at the 480th cycle. The increasing differential values over 480 charge/discharge cycles of z-swell indicate potential long term benefits with respect to anode z-swell; the example binders can be effective in controlling the swelling force of the electrode in the z-direction. The differential values of z-swells for different example binders also implies that the swelling force along the xy-plane (the plane of the electrode) can be also effectively modulated.

Table 7 shows data of a normalized capacity (also referred to as % of reference capacity, or referred to as discharge retention) for lithium-ion battery test cells (with NCM cathodes, as described above). The normalized capacity is defined as the charge capacity obtained for a given charge rate (expressed in mAh) normalized to discharge capacity that is extractable before the rate test (expressed in mAh) at a rate of 0.2C. The test cells comprising example binders 2VK 84-1, 2VK 91-2, and 2VK 95-1 exhibit comparable values of normalized capacity (discharge retention) at a rate of 2C, in a range of about 93.5-93.8%, compared to a normalized capacity of 94.1% for a comparative example comprising a commercially available PAA. The rate capability directly relates to the uniform distribution of active material and their electrical connectivity with each other through conductive additives (e.g., SWCNT) and can be improved with appropriate changes in mixing procedures. In an aspect, by changing the mixing procedures (longer mixing time, gentle mixing), a tendency of the conductive additives to agglomerate may be reduced or avoided, and a more homogenous electrode can be produced.

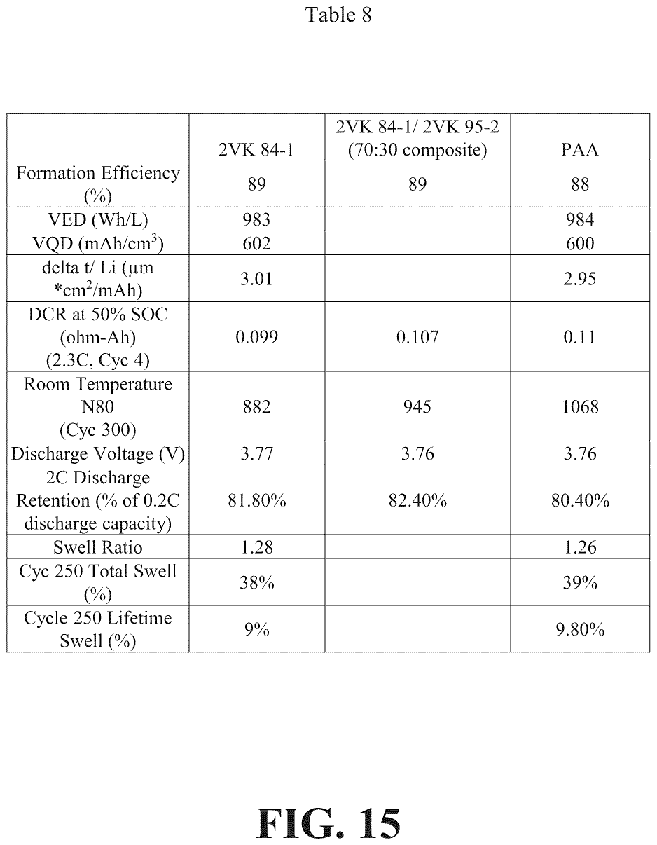

Test cells were fabricated for the battery test results reported in Table 8 (FIG. 15). Si—C nanocomposite particles (with specific reversible capacity of about 1600 mAh/g to about 1700 mAh/g, normalized by the weight of the respective Si—C nanocomposite particles) were employed in the anode coating. The anode coating was formed by processes outlined above with respect to FIGS. 11, 12, and 13. In the test cell results reported in Table 8 (FIG. 15), a mixture of Si—C nanocomposite particles and graphite particles (the mixture contained about 19 wt. % of Si—C nanocomposite particles and about 81 wt. % of graphite particles) was the active material in the anode coating. In the test cell examples reported in Table 8, the anode coating comprised the binder composition (e.g., one particular PAMAA copolymer of certain viscosity or combination of different PAMAA copolymers of different viscosities) at a mass fraction in a range of about 4.0 to about 6.0 wt. %. In the test cell examples of Table 8 (in which the anode active material comprised a mixture of about 19 wt. % of Si—C nanocomposite particles and about 81 wt. % of graphite particles), the anode coating comprised conductive additives (e.g., carbon black, SWCNT) at a mass fraction of less than about 0.1 wt. %. In these test cells, the areal capacity loading of the anode was about 3.77 mAh/cm². In the examples shown, the anode coating comprises anode active material, binder composition or binder mixture, and conductive additives.

For the test cells reported herein, the cathode coating included high-voltage LCO (with an approximate composition of LiCoO₂) active material (with specific reversible capacity of ~192 mAh/g when normalized by the weight of active materials in the cathode) cast on Al current collector foil from an organic solvent suspension including a polyvinylidene fluoride (PVDF)-based binder and a carbon black conductive additive. The anode:cathode areal capacity ratio (N:P ratio) was in a range of about 1.05:1 to about 1.14:1 and the charge voltage was about 4.45 V. A polymer-ceramic separator was interposed between the anode coating and the cathode coating. An electrolyte was infiltrated in between the anode coating and the cathode coating. In the test cell examples shown in Table 8 (in which the anode active material comprised a mixture of about 19 wt. % of Si—C nanocomposite particles and about 81 wt. % of graphite particles), an electrolyte of the following approximate composition was used: 15.2 wt. % LiPF₆, 1.0 wt. % LiDFOB (a lithium salt additive), 15.18 wt. % FEC (fluoroethylene carbonate, a fluorinated cyclic carbonate), 31.91 wt. % EP (ethyl propionate, a linear ester), 31.23 wt. % EI (ethyl isobutyrate, a branched ester), 1.69 wt. % adiponitrile (a nitrile additive), 0.5 wt. % VC (vinylene carbonate, a cyclic carbonate), and 3.29 wt. % 1,3,6-hexanetricarbonitrile (a nitrile additive). In the test cell examples reported in Table 8, the median cathode thickness was about 55 μm, and the median cathode loading was about 18 mg/cm². In the test cell examples in which the anode active material comprised a mixture of about 19 wt. % of Si—C nanocomposite particles and about 81 wt. % of graphite particles, the median anode loading was about 6.4 mg/cm², and the anode coating thickness was in a range of about 40 to 90 μm.

Table 8 (FIG. 15) shows selected performance data of lithium-ion battery test cells comprising respective PAMAA copolymers: counting from the left, the first column shows data for test cells comprising 2VK 84-1 (copolymer with acrylamide, acrylate (acrylic acid, butyl acrylate)) (in Na salt form), the second column shows data for test cells comprising a mixture of 2VK 84-1 and 2VK 95-2 in a weight ratio of 7:3 (dry weight basis), and the third column shows data for comparative example test cells comprising commercially available PAA.

Table 8 shows formation efficiency data. Formation efficiency has been introduced with reference to Table 7. The test cells comprising example binders 2VK 84-1, and 2VK 84-1/2VK 95-1 blend (7:3 by dry weight) exhibit high formation efficiencies of 89%, compared a formation efficiency of 88% for a comparative example comprising commercial PAA. These results indicate more efficient formation and lower losses as compared to commercial PAA.

Table 8 (FIG. 15) shows performance data relating to metrics of anode dimensional changes, including: (1) cycling start swell ratio (unitless), (2) normalized coating thickness change (sometimes abbreviated as Δt/Li) (μm·cm²/mAh), (3) simplified volumetric energy density (VED) (Wh/L), and (4) cycling start anode volumetric charge capacity (VQD) (mAh/cm³). These quantities have been defined above with respect to FIG. 11. In the examples shown in Table 8, the cycling start swell ratios were quite small, of about 1.28. Such relatively low swell ratios show that these PAMAA copolymers may be used effectively as binder polymers in anode electrodes comprising Si—C composite particles and graphite particles. The test cells exhibited relatively high simplified VEDs (simplified VEDs of about 983 Wh/liter, comparable to 984 Wh/liter for the comparative example of commercially available PAA) and relatively high volumetric capacities (cycling start anode volumetric capacities in a range of about 600 to about 610 mAh/cm³).

Table 8 (FIG. 15) shows discharge voltage data and data for the number of cycles to reach 80% of cycling start capacity (N80), as estimated at 300 cycles. These parameters are introduced above with respect to Table 7. In the examples shown, the lithium-ion battery test cells exhibited relatively high discharge voltages (e.g., in a range of about 3.76 to about 3.77 V) and relatively high N80 values (e.g., in a range of about 882 to about 945 cycles for the lithium-ion battery test cells comprising 2VK 84-1, and 2VK 84-1/2VK 95-2 (7:3 dry weight basis) blend, compared to 1068 cycles for the comparative example comprising commercially available PAA).

Table 8 (FIG. 15) shows selected DC resistance (DCR) data of lithium-ion battery cells comprising respective PAMAA copolymers. DCR is introduced above with respect to Table 7. In the examples shown in Table 8 (FIG. 15), DCR was measured at a state-of-charge of 50% at a discharge rate of 2.3C for 30 sec of total pulse time. In the examples shown, the lithium-ion battery test cells exhibited relatively low DCR values of about 0.100 Ω·Ah (e.g., in a range of about 0.099-0.107 Ω·Ah for the lithium-ion battery test cells comprising 2VK 84-1, and 2VK 84-1/2VK 95-2 (7:3 dry weight basis) blend, compared to 0.11 Ω·Ah for the comparative example comprising commercially available PAA).

Table 8 shows z-swell data during cycling, including lifetime swell and total swell, measured at 250 cycles. These z-swell parameters are introduced above with respect to Table 7. The z-swell values for the example binder (PAMAA copolymer) 2VK 84-1 were 38% for total swell and 9% for lifetime swell, compared to comparative example (comprising commercially available PAA) values of 39% and 9.8%, respectively, at the 250th cycle.

Table 8 (FIG. 15) shows data of a normalized capacity (also referred to as % of reference capacity or referred to as discharge retention) for lithium-ion battery test cells (with LCO cathodes, as described above). The normalized capacity is introduced above with reference to Table 7. The test cells comprising the example binders exhibit normalized capacities (discharge retention) at a rate of 2C, in a range of about 81.8-82.4% compared to a normalized capacity of about 80.4% for a comparative example comprising commercially available PAA.

Battery cell modules or battery cell packs may advantageously comprise cells with anode electrodes, cathode electrodes, separators and/or electrolyte compositions provided in this disclosure. Such cell modules or packs may offer improved performance characteristics, simplified designs, better safety features, and/or lower cost.

By way of example, the disclosed herein batteries can be advantageously used in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, air taxi, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500 batteries of the present disclosure. Batteries in multi-cell batteries may be arranged in parallel or in series.

In the detailed description above, it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause is not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of making a copolymer, the method comprising: (A1) carrying out polymerization of a polymerizable composition dissolved in a solvent composition and in the presence of a free-radical initiator under reflux conditions to form a precipitate; (A2) obtaining the copolymer in acid form from the precipitate; and (A3) neutralizing the copolymer using a metal hydroxide to obtain the copolymer in neutralized form, wherein: the metal hydroxide is sodium hydroxide, potassium hydroxide, or calcium hydroxide; the polymerizable composition comprises acrylamide and a (meth)acrylic acid; the solvent composition comprises a water-miscible solvent, the precipitate being insoluble in the water-miscible solvent; a polydispersity of the copolymer in acid form is in a range of about 1.0 to about 5.0; a mass fraction of the acrylamide in the polymerizable composition is in a range of about 50 to about 90 wt. %; and a mass fraction of the (meth)acrylic acid in the polymerizable composition is in a range of about 5 to about 50 wt. %.

Clause 2. The method of clause 1, wherein: the mass fraction of the acrylamide in the polymerizable composition is in a range of about 60 to about 90 wt. %.

Clause 3. The method of clause 2, wherein: the mass fraction of the acrylamide in the polymerizable composition is in a range of about 70 to about 90 wt. %.

Clause 4. The method of any of clauses 1 to 3, wherein: the mass fraction of the (meth)acrylic acid in the polymerizable composition is in a range of about 5 to about 25 wt. %.

Clause 5. The method of any of clauses 1 to 4, wherein: a flexural modulus of the copolymer in neutralized form is in a range of about 7 to about 16 GPa.

Clause 6. The method of clause 5, wherein: the flexural modulus is in a range of about 9 to about 16 GPa.

Clause 7. The method of any of clauses 1 to 6, wherein: a flexural stress at break of the copolymer in neutralized form is in a range of about 90 to about 230 MPa.

Clause 8. The method of clause 7, wherein: the flexural stress at break is in a range of about 100 to about 230 MPa.

Clause 9. The method of any of clauses 1 to 8, wherein: a flexural strain at break of the copolymer in neutralized form is in a range of about 0.4 to about 2.2%.

Clause 10. The method of clause 9, wherein: the flexural strain at break is in a range of about 1.2 to about 1.9%.

Clause 11. The method of any of clauses 1 to 10, wherein: the polydispersity is in a range of about 1.0 to about 4.0.

Clause 12. The method of clause 11, wherein: the polydispersity is in a range of about 1.0 to about 2.0.

Clause 13. The method of clause 12, wherein: the polydispersity is in a range of about 1.0 to about 1.8.

Clause 14. The method of any of clauses 1 to 13, wherein: a weight-average molecular weight of the copolymer in acid form is in a range of about 600 to about 3000 kg/mol; and a number-average molecular weight of the copolymer in acid form is in a range of about 400 to about 1800 kg/mol.

Clause 15. The method of any of clauses 1 to 14, wherein: a kinematic viscosity of a solution of the copolymer in neutralized form at about 1 wt. % in water is in a range of about 3 to about 300 cSt.

Clause 16. The method of clause 15, wherein: the kinematic viscosity is in a range of about 3 to about 150 cSt.

Clause 17. The method of clause 16, wherein: the kinematic viscosity is in a range of about 3 to about 30 cSt.

Clause 18. The method of any of clauses 1 to 17, wherein: a glass transition temperature of the copolymer in neutralized form is in a range of about 100 °C to about 170 °C.

Clause 19. The method of any of clauses 1 to 18, wherein: the water-miscible solvent comprises a ketone selected from acetone and methyl ethyl ketone.

Clause 20. The method of any of clauses 1 to 19, wherein: the water-miscible solvent comprises an alcohol selected from ethanol, n-propanol, and isopropanol.

Clause 21. The method of any of clauses 1 to 20, wherein: the solvent composition comprises water.

Clause 22. The method of clause 21, wherein: the water-miscible solvent comprises acetone; and a mass ratio of the water to the acetone in the solvent composition is in a range of about 25:100 to about 1:100.

Clause 23. The method of any of clauses 1 to 22, wherein: the polymerizable composition comprises a (meth)acrylic ester; a mass fraction of the (meth)acrylic ester in the polymerizable composition is in a range of about 1 to about 40 wt. %; and the (meth)acrylic ester is selected from C₁₋₈ alkyl (meth)acrylate and oligo(ethylene glycol) alkyl ether (meth)acrylate.

Clause 24. The method of clause 23, wherein: the (meth)acrylic ester is the C₁₋₈ alkyl (meth)acrylate; and the C₁₋₈ alkyl (meth)acrylate comprises butyl (meth)acrylate.

Clause 25. The method of any of clauses 23 to 24, wherein: the (meth)acrylic ester is the oligo(ethylene glycol) alkyl ether (meth)acrylate; and the oligo(ethylene glycol) alkyl ether (meth)acrylate comprises oligo(ethylene glycol) methyl ether (meth)acrylate.

Clause 26. The method of any of clauses 1 to 25, wherein: the free-radical initiator is selected from an azonitrile initiator and a peroxide initiator.

Clause 27. The method of clause 26, wherein: the free-radical initiator is the azonitrile initiator; and the azonitrile initiator comprises azobisisobutyronitrile.

Clause 28. The method of any of clauses 1 to 27, wherein: the polymerizable composition does not comprise fluorine.

Clause 29. The method of any of clauses 1 to 28, wherein: the polymerizable composition does not comprise any nitrile group.

Clause 30. A method of making a battery electrode, comprising: (B1) carrying out at least one instantiation of the method of making the copolymer of claim 1; (B2) forming a slurry comprising a binder material and composite particles that each comprise carbon and silicon; and (B3) casting the slurry on a current collector to form an electrode coating on the current collector, wherein: the binder material comprises the copolymer in neutralized form.

Clause 31. The method of clause 30, wherein: the at least one instantiation comprises a first instantiation and a second instantiation; the copolymer of the first instantiation is a first copolymer; the copolymer of the second instantiation is a second copolymer; the first copolymer in neutralized form, in an about 1 wt. % solution in water, exhibits a first kinematic viscosity in a range of about 5 to about 50 cSt at about 25 °C; the second copolymer in neutralized form, in an about 1 wt. % solution in water, exhibits a second kinematic viscosity in a range of about 50 to about 150 cSt at about 25 °C; the binder material comprises (1) a first portion comprising the first copolymer in neutralized form in a first solution and (2) a second portion comprising the second copolymer in neutralized form in a second solution; and (B2) comprises (B2-1) kneading a first dough comprising the first portion and the composite particles, and (B2-2) mixing the first dough and the second portion to form the slurry, or (B2-3) kneading a second dough comprising the second portion and the composite particles, and (B2-4) mixing the second dough and the first portion to form the slurry.

Clause 32. The method of any of clauses 30 to 31, wherein: the slurry additionally comprises graphite particles.

Clause 33. The method of any of clauses 30 to 32, further comprising: (B4) assembling a battery cell from an anode and a cathode, with an electrolyte ionically coupling the anode and the cathode, wherein: the electrode coating on the current collector is configured as the anode.

Clause 34. A binder material, comprising: a copolymer of acrylamide and (meth)acrylate; wherein: the copolymer comprises sodium, potassium, or calcium; a polydispersity of the copolymer, excluding the sodium, the potassium, and the calcium, is in a range of about 1.0 to about 5.0; a mass fraction of the acrylamide in the copolymer, excluding the sodium, the potassium, and the calcium, is in a range of about 50 to about 96 wt. %; and a mass fraction of the (meth)acrylate in the copolymer, excluding the sodium, the potassium, and the calcium, is in a range of about 2 to about 50 wt. %.

Clause 35. The binder material of clause 34, wherein: the mass fraction of the acrylamide in the copolymer, excluding the sodium, the potassium, and the calcium, is in a range of about 60 to about 96 wt. %.

Clause 36. The binder material of clause 35, wherein: the mass fraction of the acrylamide in the copolymer, excluding the sodium, the potassium, and the calcium, is in a range of about 70 to about 96 wt. %.

Clause 37. The binder material of any of clauses 34 to 36, wherein: the mass fraction of the (meth)acrylate in the copolymer, excluding the sodium, the potassium, and the calcium, is in a range of about 2 to about 20 wt. %.

Clause 38. The binder material of any of clauses 34 to 37, wherein: a flexural modulus of the copolymer is in a range of about 7 to about 16 GPa.

Clause 39. The binder material of clause 38, wherein: the flexural modulus of the copolymer is in a range of about 9 to about 16 GPa.

Clause 40. The binder material of any of clauses 34 to 39, wherein: a flexural stress at break of the copolymer is in a range of about 90 to about 230 MPa.

Clause 41. The binder material of clause 40, wherein: the flexural stress at break of the copolymer is in a range of about 100 to about 230 MPa.

Clause 42. The binder material of any of clauses 34 to 41, wherein: a flexural strain at break of the copolymer is in a range of about 0.4 to about 2.2%.

Clause 43. The binder material of clause 42, wherein: the flexural strain at break of the copolymer is in a range of about 1.2 to about 1.9%.

Clause 44. The binder material of any of clauses 34 to 43, wherein: the polydispersity of the copolymer, excluding the sodium, the potassium, and the calcium, is in a range of about 1.0 to about 4.0.

Clause 45. The binder material of clause 44, wherein: the polydispersity of the copolymer, excluding the sodium, the potassium, and the calcium, is in a range of about 1.0 to about 2.0.

Clause 46. The binder material of clause 45, wherein: the polydispersity of the copolymer, excluding the sodium, the potassium, and the calcium, is in a range of about 1.0 to about 1.8.

Clause 47. The binder material of any of clauses 34 to 46, wherein: a weight-average molecular weight of the copolymer, excluding the sodium, the potassium, and the calcium, is in a range of about 600 to about 3000 kg/mol; and a number-average molecular weight of the copolymer, excluding the sodium, the potassium, and the calcium, is in a range of about 400 to about 1800 kg/mol.

Clause 48. The binder material of any of clauses 34 to 47, wherein: a kinematic viscosity of a solution of the copolymer at about 1 wt. % in water is in a range of about 3 to about 300 cSt.

Clause 49. The binder material of clause 48, wherein: the kinematic viscosity is in a range of about 3 to about 150 cSt.

Clause 50. The binder material of clause 49, wherein: the kinematic viscosity is in a range of about 3 to about 30 cSt.

Clause 51. The binder material of any of clauses 34 to 50, wherein: a glass transition temperature of the copolymer is in a range of about 100 °C to about 170 °C.

Clause 52. The binder material of any of clauses 34 to 51, wherein: the copolymer comprises (meth)acrylic ester; a mass fraction of the (meth)acrylic ester in the copolymer excluding the sodium, the potassium, and the calcium, is in a range of about 1 to about 30 wt. %; and the (meth)acrylic ester is selected from C₁₋₈ alkyl (meth)acrylate and oligo(ethylene glycol) alkyl ether (meth)acrylate.

Clause 53. The binder material of clause 52, wherein: the (meth)acrylic ester is the C₁₋₈ alkyl (meth)acrylate; and the C₁₋₈ alkyl (meth)acrylate comprises butyl (meth)acrylate.

Clause 54. The binder material of any of clauses 52 to 53, wherein: the (meth)acrylic ester is the oligo(ethylene glycol) alkyl ether (meth)acrylate; and the oligo(ethylene glycol) alkyl ether (meth)acrylate comprises oligo(ethylene glycol) methyl ether (meth)acrylate.

Clause 55. The binder material of any of clauses 34 to 54, wherein: the copolymer does not comprise fluorine.

Clause 56. The binder material of any of clauses 34 to 55, wherein: the copolymer does not comprise any nitrile group.

Clause 57. An electrode coating, comprising: a binder and composite particles comprising carbon and silicon, wherein: the binder comprises at least one instantiation of the binder material of claim 34.

Clause 58. The electrode coating of clause 57, wherein: the at least one instantiation comprises a first instantiation and a second instantiation; the copolymer of the first instantiation is a first copolymer; the copolymer of the second instantiation is a second copolymer the first copolymer, in a first 1 wt. % solution in water, exhibits a first viscosity in a range of about 5 to about 50 cSt at 25 °C; the second copolymer, in a second 1 wt. % solution in water, exhibits a second viscosity in a range of about 50 to about 150 cSt at 25 °C; and the first copolymer and the second copolymer are present in the electrode coating in a mixed state.

Clause 59. The electrode coating of any of clauses 57 to 58, wherein: the electrode coating comprises graphite particles.

Clause 60. A battery cell, comprising: an anode comprising the electrode coating of claim 57 disposed on and/or in an anode current collector; a cathode comprising a cathode coating on and/or in a cathode current collector; and an electrolyte ionically coupling the anode and the cathode.

Additional implementation examples are described in the following numbered additional clauses:

Additional Clause 1: A method of making a copolymer, the method comprising: (A1) carrying out polymerization of a polymerizable composition dissolved in a solvent composition and in the presence of a free-radical initiator under reflux conditions to form a precipitate; (A2) obtaining the copolymer in acid form from the precipitate; and (A3) neutralizing the copolymer using a metal hydroxide to obtain the copolymer in neutralized form, wherein: the metal hydroxide is sodium hydroxide, potassium hydroxide, or calcium hydroxide; the polymerizable composition comprises acrylamide and a (meth)acrylic acid; the solvent composition comprises a water-miscible solvent, the precipitate being insoluble in the water-miscible solvent; a polydispersity of the copolymer in acid form is in a range of about 1.0 to about 5.0; a mass fraction of the acrylamide in the polymerizable composition is in a range of about 50 to about 90 wt. %; and a mass fraction of the (meth)acrylic acid in the polymerizable composition is in a range of about 5 to about 50 wt. %.

Additional Clause 2: The method of Additional Clause 1, wherein: the mass fraction of the acrylamide in the polymerizable composition is in a range of about 60 to about 90 wt. %.

Additional Clause 3: The method of any of Additional Clauses 1 to 2, wherein: the mass fraction of the (meth)acrylic acid in the polymerizable composition is in a range of about 5 to about 25 wt. %.

Additional Clause 4: The method of any of Additional Clauses 1 to 3, wherein: the polydispersity is in a range of about 1.0 to about 4.0.

Additional Clause 5: The method of any of Additional Clauses 1 to 4, wherein: a weight-average molecular weight of the copolymer in acid form is in a range of about 600 to about 16500 kg/mol; and a number-average molecular weight of the copolymer in acid form is in a range of about 400 to about 6200 kg/mol.

Additional Clause 6: The method of any of Additional Clauses 1 to 5, wherein: the water-miscible solvent comprises a ketone selected from acetone and methyl ethyl ketone.

Additional Clause 7: The method of any of Additional Clauses 1 to 6, wherein: the water-miscible solvent comprises an alcohol selected from ethanol, n-propanol, and isopropanol.

Additional Clause 8: The method of any of Additional Clauses 1 to 7, wherein: the solvent composition comprises water.

Additional Clause 9: The method of any of Additional Clauses 1 to 8, wherein: the water-miscible solvent comprises acetone; and a mass ratio of the water to the acetone in the solvent composition is in a range of about 25:100 to about 1:100.

Additional Clause 10: The method of any of Additional Clauses 1 to 9, wherein: the polymerizable composition comprises a (meth)acrylic ester; a mass fraction of the (meth)acrylic ester in the polymerizable composition is in a range of about 1 to about 40 wt. %; and the (meth)acrylic ester is selected from C1-8 alkyl (meth)acrylate and oligo(ethylene glycol) alkyl ether (meth)acrylate.

Additional Clause 11: The method of any of Additional Clauses 1 to 10, wherein: the (meth)acrylic ester is the C₁₋₈ alkyl (meth)acrylate; and the C₁₋₈ alkyl (meth)acrylate comprises butyl (meth)acrylate.

Additional Clause 12: The method of any of Additional Clauses 1 to 11, wherein: the (meth)acrylic ester is the oligo(ethylene glycol) alkyl ether (meth)acrylate; and the oligo(ethylene glycol) alkyl ether (meth)acrylate comprises oligo(ethylene glycol) methyl ether (meth)acrylate.

Additional Clause 13: The method of any of Additional Clauses 1 to 12, wherein: the free-radical initiator is selected from an azonitrile initiator and a peroxide initiator.

Additional Clause 14: The method of any of Additional Clauses 1 to 13, wherein: the free-radical initiator is the azonitrile initiator; and the azonitrile initiator comprises azobisisobutyronitrile.

Additional Clause 15: The method of any of Additional Clauses 1 to 14, wherein: the polymerizable composition does not comprise fluorine and/or does not comprise any nitrile group.

Additional Clause 16: A method of making a battery electrode, comprising: (B1) carrying out at least one instantiation of the method of making the copolymer of any of Additional Clauses 1 to 15; (B2) forming a slurry comprising a binder material and composite particles that each comprise carbon and silicon; and (B3) casting the slurry on a current collector to form an electrode coating on the current collector, wherein: the binder material comprises the copolymer in neutralized form.

Additional Clause 17: The method of any of Additional Clauses 1 to 16, wherein: the at least one instantiation comprises a first instantiation and a second instantiation; the copolymer of the first instantiation is a first copolymer; the copolymer of the second instantiation is a second copolymer; the first copolymer in neutralized form, in an about 1 wt. % solution in water, exhibits a first kinematic viscosity in a range of about 5 to about 50 cSt at about 25 °C; the second copolymer in neutralized form, in an about 1 wt. % solution in water, exhibits a second kinematic viscosity in a range of about 50 to about 450 cSt at about 25 °C; the binder material comprises (1) a first portion comprising the first copolymer in neutralized form in a first solution and (2) a second portion comprising the second copolymer in neutralized form in a second solution; and (B2) comprises (B2-1) kneading a first dough comprising the first portion and the composite particles, and (B2-2) mixing the first dough and the second portion to form the slurry, or (B2-3) kneading a second dough comprising the second portion and the composite particles, and (B2-4) mixing the second dough and the first portion to form the slurry.

Additional Clause 18: The method of any of Additional Clauses 1 to 17, wherein: the slurry additionally comprises graphite particles.

Additional Clause 19: The method of any of Additional Clauses 1 to 18, further comprising: (B4) assembling a battery cell from an anode and a cathode, with an electrolyte ionically coupling the anode and the cathode, wherein: the electrode coating on the current collector is configured as the anode.

Additional Clause 20: A binder material, comprising: a copolymer of acrylamide and (meth)acrylate; wherein: the copolymer comprises sodium, potassium, or calcium; a polydispersity of the copolymer, excluding the sodium, the potassium, and the calcium, is in a range of about 1.0 to about 5.0; a mass fraction of the acrylamide in the copolymer, excluding the sodium, the potassium, and the calcium, is in a range of about 50 to about 96 wt. %; and a mass fraction of the (meth)acrylate in the copolymer, excluding the sodium, the potassium, and the calcium, is in a range of about 2 to about 50 wt. %.

Additional Clause 21: The binder material of Additional Clause 20, wherein: the mass fraction of the acrylamide in the copolymer, excluding the sodium, the potassium, and the calcium, is in a range of about 60 to about 96 wt. %.

Additional Clause 22: The binder material of any of Additional Clauses 20 to 21, wherein: the mass fraction of the (meth)acrylate in the copolymer, excluding the sodium, the potassium, and the calcium, is in a range of about 2 to about 20 wt. %.

Additional Clause 23: The binder material of any of Additional Clauses 20 to 22, wherein: the polydispersity of the copolymer, excluding the sodium, the potassium, and the calcium, is in a range of about 1.0 to about 4.0.

Additional Clause 24: The binder material of any of Additional Clauses 20 to 23, wherein: a weight-average molecular weight of the copolymer, excluding the sodium, the potassium, and the calcium, is in a range of about 600 to about 16500 kg/mol; and a number-average molecular weight of the copolymer, excluding the sodium, the potassium, and the calcium, is in a range of about 400 to about 6200 kg/mol.

Additional Clause 25: The binder material of any of Additional Clauses 20 to 24, wherein: the copolymer comprises (meth)acrylic ester; a mass fraction of the (meth)acrylic ester in the copolymer excluding the sodium, the potassium, and the calcium, is in a range of about 1 to about 30 wt. %; and the (meth)acrylic ester is selected from C1-8 alkyl (meth)acrylate and oligo(ethylene glycol) alkyl ether (meth)acrylate.

Additional Clause 26: The binder material of any of Additional Clauses 20 to 25, wherein: the (meth)acrylic ester is the C₁₋₈ alkyl (meth)acrylate; and the C₁₋₈ alkyl (meth)acrylate comprises butyl (meth)acrylate.

Additional Clause 27: The binder material of any of Additional Clauses 20 to 26, wherein: the (meth)acrylic ester is the oligo(ethylene glycol) alkyl ether (meth)acrylate; and the oligo(ethylene glycol) alkyl ether (meth)acrylate comprises oligo(ethylene glycol) methyl ether (meth)acrylate.

Additional Clause 28: The binder material of any of Additional Clauses 20 to 27, wherein: the copolymer does not comprise fluorine and/or does not comprise any nitrile group.

Additional Clause 29: An electrode coating, comprising: a binder and composite particles comprising carbon and silicon, wherein: the binder comprises at least one instantiation of the binder material of any of Additional Clauses 20 to 28.

Additional Clause 30: The electrode coating of any of Additional Clauses 20 to 29, wherein: the at least one instantiation comprises a first instantiation and a second instantiation; the copolymer of the first instantiation is a first copolymer; the copolymer of the second instantiation is a second copolymer the first copolymer, in a first 1 wt. % solution in water, exhibits a first viscosity in a range of about 5 to about 50 cSt at 25 °C; the second copolymer, in a second 1 wt. % solution in water, exhibits a second viscosity in a range of about 50 to about 450 cSt at 25 °C; and the first copolymer and the second copolymer are present in the electrode coating in a mixed state.

Additional Clause 31: The electrode coating of any of Additional Clauses 20 to 30, wherein: the electrode coating comprises graphite particles.

Additional Clause 32: A battery cell, comprising: an anode comprising the electrode coating of any of Additional Clauses 20 to 31 disposed on and/or in an anode current collector; a cathode comprising a cathode coating on and/or in a cathode current collector; and an electrolyte ionically coupling the anode and the cathode.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A method of making a copolymer, the method comprising:
(A1) carrying out polymerization of a polymerizable composition dissolved in a solvent composition and in the presence of a free-radical initiator under reflux conditions to form a precipitate;
(A2) obtaining the copolymer in acid form from the precipitate; and
(A3) neutralizing the copolymer using a metal hydroxide to obtain the copolymer in neutralized form,
wherein:
the metal hydroxide is sodium hydroxide, potassium hydroxide, or calcium hydroxide;
the polymerizable composition comprises acrylamide and a (meth)acrylic acid;
the solvent composition comprises a water-miscible solvent, the precipitate being insoluble in the water-miscible solvent;
a polydispersity of the copolymer in acid form is in a range of about 1.0 to about 5.0;
a mass fraction of the acrylamide in the polymerizable composition is in a range of about 50 to about 90 wt. %; and
a mass fraction of the (meth)acrylic acid in the polymerizable composition is in a range of about 5 to about 50 wt. %.

2. The method of claim 1, wherein:
the mass fraction of the acrylamide in the polymerizable composition is in a range of about 60 to about 90 wt. %.

3. The method of claim 1, wherein:
the mass fraction of the (meth)acrylic acid in the polymerizable composition is in a range of about 5 to about 25 wt. %.

4. The method of claim 1, wherein:
the polydispersity is in a range of about 1.0 to about 4.0.

5. The method of claim 1, wherein:
a weight-average molecular weight of the copolymer in acid form is in a range of about 600 to about 16500 kg/mol; and
a number-average molecular weight of the copolymer in acid form is in a range of about 400 to about 6200 kg/mol.

6. The method of claim 1, wherein:
the water-miscible solvent comprises a ketone selected from acetone and methyl ethyl ketone.

7. The method of claim 1, wherein:
the water-miscible solvent comprises an alcohol selected from ethanol, n-propanol, and isopropanol.

8. The method of claim 1, wherein:
the solvent composition comprises water.

9. The method of claim 8, wherein:
the water-miscible solvent comprises acetone; and
a mass ratio of the water to the acetone in the solvent composition is in a range of about 25:100 to about 1:100.

10. The method of claim 1, wherein:
the polymerizable composition comprises a (meth)acrylic ester;
a mass fraction of the (meth)acrylic ester in the polymerizable composition is in a range of about 1 to about 40 wt. %; and
the (meth)acrylic ester is selected from C₁₋₈ alkyl (meth)acrylate and oligo(ethylene glycol) alkyl ether (meth)acrylate.

11. The method of claim 10, wherein:
the (meth)acrylic ester is the C₁₋₈ alkyl (meth)acrylate; and
the C₁₋₈ alkyl (meth)acrylate comprises butyl (meth)acrylate.

12. The method of claim 10, wherein:
the (meth)acrylic ester is the oligo(ethylene glycol) alkyl ether (meth)acrylate; and
the oligo(ethylene glycol) alkyl ether (meth)acrylate comprises oligo(ethylene glycol) methyl ether (meth)acrylate.

13. The method of claim 1, wherein:
the free-radical initiator is selected from an azonitrile initiator and a peroxide initiator.

14. The method of claim 13, wherein:
the free-radical initiator is the azonitrile initiator; and
the azonitrile initiator comprises azobisisobutyronitrile.

15. The method of claim 1, wherein:
the polymerizable composition does not comprise fluorine and/or does not comprise any nitrile group.

16. A method of making a battery electrode, comprising:
(B1) carrying out at least one instantiation of the method of making the copolymer of claim 1;
(B2) forming a slurry comprising a binder material and composite particles that each comprise carbon and silicon; and
(B3) casting the slurry on a current collector to form an electrode coating on the current collector,
wherein:
the binder material comprises the copolymer in neutralized form.

17. The method of claim 16, wherein:
the at least one instantiation comprises a first instantiation and a second instantiation;
the copolymer of the first instantiation is a first copolymer;
the copolymer of the second instantiation is a second copolymer;
the first copolymer in neutralized form, in an about 1 wt. % solution in water, exhibits a first kinematic viscosity in a range of about 5 to about 50 cSt at about 25 °C;
the second copolymer in neutralized form, in an about 1 wt. % solution in water, exhibits a second kinematic viscosity in a range of about 50 to about 450 cSt at about 25 °C;
the binder material comprises (1) a first portion comprising the first copolymer in neutralized form in a first solution and (2) a second portion comprising the second copolymer in neutralized form in a second solution; and
(B2) comprises (B2-1) kneading a first dough comprising the first portion and the composite particles, and (B2-2) mixing the first dough and the second portion to form the slurry, or (B2-3) kneading a second dough comprising the second portion and the composite particles, and (B2-4) mixing the second dough and the first portion to form the slurry.

18. The method of claim 16, wherein:
the slurry additionally comprises graphite particles.

19. The method of claim 16, further comprising:
(B4) assembling a battery cell from an anode and a cathode, with an electrolyte ionically coupling the anode and the cathode,
wherein:
the electrode coating on the current collector is configured as the anode.

20. A binder material, comprising:
a copolymer of acrylamide and (meth)acrylate;
wherein:
the copolymer comprises sodium, potassium, or calcium;
a polydispersity of the copolymer, excluding the sodium, the potassium, and the calcium, is in a range of about 1.0 to about 5.0;
a mass fraction of the acrylamide in the copolymer, excluding the sodium, the potassium, and the calcium, is in a range of about 50 to about 96 wt. %; and
a mass fraction of the (meth)acrylate in the copolymer, excluding the sodium, the potassium, and the calcium, is in a range of about 2 to about 50 wt. %.

21. The binder material of claim 20, wherein:
the mass fraction of the acrylamide in the copolymer, excluding the sodium, the potassium, and the calcium, is in a range of about 60 to about 96 wt. %.

22. The binder material of claim 20, wherein:
the mass fraction of the (meth)acrylate in the copolymer, excluding the sodium, the potassium, and the calcium, is in a range of about 2 to about 20 wt. %.

23. The binder material of claim 20, wherein:
the polydispersity of the copolymer, excluding the sodium, the potassium, and the calcium, is in a range of about 1.0 to about 4.0.

24. The binder material of claim 20, wherein:
a weight-average molecular weight of the copolymer, excluding the sodium, the potassium, and the calcium, is in a range of about 600 to about 16500 kg/mol; and
a number-average molecular weight of the copolymer, excluding the sodium, the potassium, and the calcium, is in a range of about 400 to about 6200 kg/mol.

25. The binder material of claim 20, wherein:
the copolymer comprises (meth)acrylic ester;
a mass fraction of the (meth)acrylic ester in the copolymer excluding the sodium, the potassium, and the calcium, is in a range of about 1 to about 30 wt. %; and
the (meth)acrylic ester is selected from C₁₋₈ alkyl (meth)acrylate and oligo(ethylene glycol) alkyl ether (meth)acrylate.

26. The binder material of claim 25, wherein:
the (meth)acrylic ester is the C₁₋₈ alkyl (meth)acrylate; and
the C₁₋₈ alkyl (meth)acrylate comprises butyl (meth)acrylate.

27. The binder material of claim 25, wherein:
the (meth)acrylic ester is the oligo(ethylene glycol) alkyl ether (meth)acrylate; and
the oligo(ethylene glycol) alkyl ether (meth)acrylate comprises oligo(ethylene glycol) methyl ether (meth)acrylate.

28. The binder material of claim 20, wherein:
the copolymer does not comprise fluorine and/or does not comprise any nitrile group.

29. An electrode coating, comprising:
a binder and composite particles comprising carbon and silicon,
wherein:
the binder comprises at least one instantiation of the binder material of claim 20.

30. The electrode coating of claim 29, wherein:
the at least one instantiation comprises a first instantiation and a second instantiation;
the copolymer of the first instantiation is a first copolymer;
the copolymer of the second instantiation is a second copolymer
the first copolymer, in a first 1 wt. % solution in water, exhibits a first viscosity in a range of about 5 to about 50 cSt at 25 °C;
the second copolymer, in a second 1 wt. % solution in water, exhibits a second viscosity in a range of about 50 to about 450 cSt at 25 °C; and
the first copolymer and the second copolymer are present in the electrode coating in a mixed state.

31. The electrode coating of claim 29, wherein:
the electrode coating comprises graphite particles.

32. A battery cell, comprising:
an anode comprising the electrode coating of claim 29 disposed on and/or in an anode current collector;
a cathode comprising a cathode coating on and/or in a cathode current collector; and
an electrolyte ionically coupling the anode and the cathode.
